(19) United States
(12) Patent Application Publication
(10) Pub. No.: US 2013/0338003 A1
(43) Pub. Date: Dec. 19, 2013

(54) RHIZOBIUM TROPICI PRODUCED BIOPOLYMER SALT

(71) Applicants: Steven Larson, Vicksburg, MS (US); Gary Nijak, JR., Tempe, AZ (US); Christopher Griggs, Vicksburg, MS (US); Jeffrey Talley, Mesa, AZ (US)

(72) Inventors: Steven Larson, Vicksburg, MS (US); Gary Nijak, JR., Tempe, AZ (US); Christopher Griggs, Vicksburg, MS (US); Jeffrey Talley, Mesa, AZ (US)

(73) Assignee: United States As Represented By The Secretary Of The Army, Champaign, IL (US)

(21) Appl. No.: 13/823,640

(22) PCT Filed: Dec. 5, 2011
(86) PCT No.: PCT/US11/63296

§ 371 Date: Sep. 5, 2013

Related U.S. Application Data
(60) Provisional application No. 61/420,312, filed on Dec. 6, 2010.

(51) Int. Cl. C08B 37/00; E02D 3/00; A01N 43/16

(52) U.S. Cl. CPC C08B 37/00; A01N 43/16; E02D 3/005
USPC 504/117; 536/123.1; 435/101; 405/263; 405/128.5

(57) ABSTRACT

The disclosure concerns methods and compositions for prevention of soil erosion, soil contamination and increased seed germination for agricultural products. Certain methods relate to coating seeds to withstand drought conditions. Other methods relate to soil compositions containing a biopolymer to withstand drought conditions or to prevent erosion, to control dust or to prevent contaminated soil erosion.

### CROSS-REFERENCES TO RELATED APPLICATIONS

This application claims benefit under 35 U.S.C. § 119(e) to U.S. Provisional Patent Application Ser. No. 61/420,312 filed on Dec. 6, 2010 and is hereby incorporated by reference in entirety.

### STATEMENT REGARDING FEDERALLY SPONSORED RESEARCH OR DEVELOPMENT

This invention was made partially with U.S. government support under ER-0920 awarded by Environmental Security Technology Certification Program (ESTCP). The U.S. government has certain rights in the invention.

### BACKGROUND

1. Field

The field of this invention relates generally to Rhizobium tropici produced biopolymer salts. Further the field of this invention relates to methods of preparing and using Rhizobium tropici produced biopolymer salts.

2. Description of the Related Art

Drought not only affects more people in the United States than any other natural hazard, it is also one of the most costly and difficult problems to deal with. This is due to the nature of drought itself. It is a slow onset phenomenon where the severity is determined using multiple metrics. Unlike a tornado or hurricane, for instance, the impact of drought is non-structural and can be very widespread, crossing state and country boundaries, which makes assessment and mitigation efforts more difficult. Agricultural drought-related losses in the United States average between six and eight billion dollars each year. And there are warnings that longer and more severe droughts may be a part of the climate-change models. Urban areas consume extensive water resources for non-agricultural use such as lawn and garden maintenance. Municipalities with limited water resources often reduce or curtail lawn watering during low water situations. While developed countries have more resources to commit to drought mitigation than less developed countries, proactive preparations to deal with drought are similarly delayed and result in profound social and economic damage. Smaller agricultural operations cannot weather the economic damage from a natural disaster such as drought and ultimately leave the agricultural business or face increasing debt that is nearly possible to escape.

One critical soil health issue is erosion. Soil erosion is most important in two land types: steep or hilly terrain and sandy soils. Growth of urban centers consumes large areas of prime agricultural land. With increasing rural populations, agriculture is moving upslope onto steep landscapes with all the negative consequences of erosion, or invading wetlands with concomitant impacts on hydrology. It is the sandy and marginal soils that most often present problems beyond the capacity of poorly resourced farmers to address. Intensity of use of such systems was low to negligible in the past, but this situation is changing rapidly. Exploitation of stressed ecosystems for arable cropping will increase with increasing population and the concomitant demand for food. From this perspective, it is important that marginal and sandy soils be viewed as the next frontier for agriculture and research be developed to use the soils in a sustainable manner. Economic viability of agriculture on these soils is the challenge that research and development must address if these are to become the next frontier for agriculture development.

In many countries, there are sandy soils, which are of inferior quality in comparison to lands that are currently cultivated, but they probably are a much better alternative to steep lands or wetlands. Stress factors on these lands include nutrient deficiencies, a high susceptibility to erosion, low water-holding capacity, and decreased soil compaction. The ability to correct these stressors at minimal cost is the primary driving factor to improve these marginal soils. Water for irrigation is also a limiting resource in many countries. Over time, the situation will worsen due to soil degradation which, in turn, reduces soil performance. Countries which have opted for large scale irrigation programs to enhance their food producing capacity are generally at risk due to salinization and/or alkalization which accompanies irrigation in arid and semi-arid environments. In the drier countries of the world, the supply of water may become a limiting factor even before the inability of the land to produce food is encountered. Reducing the use of water for irrigation will improve the health and sustainability of agricultural practices. Additionally, improving soil health will increase the range of crops that can be grown on marginal soils, including those for bioenergy.

One of the key recommendations in the United Nations Millennium Project is, “a massive replenishment of soil nutrients for smallholder farmers on lands with nutrient-depleted soils, through free or subsidized distribution of chemical fertilizers and agroforestry.” In developed nations, the use of synthetic fertilizers is widespread in agriculture and agroforestry. The two primary components of agriculture fertilizers are nitrogen and phosphorus. Typically, nitrogen is applied into the soil by liquid spreaders, in excess amounts of what is required. Similarly for phosphorous, it is applied by spreaders although in a solid mineral form, in great excess as well. Any excess is available for solubilization and transport in surface water runoff to receiving waters, having profound ecological impacts on local and national ecosystems. The use of synthetic fertilizers has increased steadily in the last 50 years, rising almost 20-fold to the current rate of 22 million tons of fertilizer per year. Soils continue to remain in a positive nutrient balance through yearly fertilizer additions. The increase in nitrogen and phosphorus in receiving waters from excessive fertilizer usage can result in eutrophication and algal blooms that release toxins and deprive waters of oxygen that sustain local biota. While highly effective at increasing crop yield, this has resulted in excess amounts of agricultural runoff that can create large hypoxic zones such as the one in the Gulf of Mexico. These hypoxic zones devastate all native wildlife and render affected areas dead to all but a select few species capable of survival in extreme conditions. What is needed is an environmentally sustainable approach to soil erosion and agricultural practices that can improve soil quality, increase productivity, and have a sustainable long term footprint on the environment. Current practices cannot address these issues in an appropriate manner, even with appropriate application and procedures.

One approach to combating drought is through the use of water retaining polymers. Both synthetic and biopolymers are made of repetitive monomeric units. The term primary structure is used to describe the chemical composition and the sequence of the repeated units. Many synthetic polymers prepared using petroleum based monomers have a simple, non-varied structure and are typically random copolymers where the repeated unit sequence is statistically controlled. In contrast, many biopolymers can fold into functionally compact shapes through crosslinking (via hydrogen bonding, hydrophobic associations, multivalent ion coordination, and the like). This changes not only their shape, but their chemical properties. In addition, biopolymers often have complex pendant moieties that display highly specific functionalities. The mono-dispersity and specific structure available in biopolymers provide distinct advantages over the poly-dispersity and random structure encountered in many synthetic polymers.

Rhizobium tropici ATCC 49672 is a catalogued symbiotic nodulator of leguminous plants. Rhizobium tropici is also known for its production of a gel-like, extracellular polymeric substance (EPS). Many of the Rhizobium-produced EPS are polysaccharides containing glucuronic acid. Some exceptions to this structure have been reported. The functions of the EPS include surface adhesion, self-adhesion of cells into biofilms, formation of protective barriers, water retention around roots, and nutrient accumulation.

The EPS, or biopolymer, is similar to synthetic polymers, in that it is a chain-like molecule composed of repeating monomers. However, the biopolymer produced by R. tropici (Rhizobium tropici biopolymer [RTBP] or Rhizobium tropici exopolysaccarhide (or extracellular polymeric substance) [RTEPS]) has a variety of chemical and physical characteristics that make it advantageous over synthetically derived petroleum based polymers. Synthetic polymer synthesis traditionally follows one of two methods: chain-growth polymerization, in which monomers are added to the polymer chain one at a time; and step-growth polymerization, in which chains of monomers combine directly. Such polymerization results in common petrochemical products like polyvinyl chloride (PVC), polyamide 6,6 (Nylon), and polytetrafluoroethylene (Teflon). Synthetic polymerization requires large amounts of energy and costly raw materials, involves caustic chemical processing, and throughputs a significant amount of greenhouse gases. As much as 8% of the world's oil production goes into synthesis of polymers as either a raw material or combusted to supply energy for polymer manufacturing. The EPS can be manufactured in an environmentally friendly fashion requiring significantly less energy. Additionally, the biopolymer is biodegradable. In contrast to synthetic polymers, the biopolymer displays a more complex, diverse structure than traditional polymers. The RTEPS has been investigated for its advantages over synthetic polymers for use in construction, in particular dust suppression, heavy metal leachate control and soil stabilization.

In addition to being a soil stabilizer and dust suppressant, the biopolymer has practical applications as a soil amendment for agriculture and significantly improved vegetative growth. The biopolymer drastically increases root structure, results in higher node densities, increases fruit yields, and results in significantly increased biomass. Chemical fertilizers traditionally have been used to increase crop production and have been widely used in agricultural practice since the 19^{th} century. However, widespread agricultural application of phosphorus, nitrogen and potassium has led to contamination the rivers, lakes and oceans due to runoff. Ecosystem degradation has erupted in the forms of huge algae blooms and notorious dead-zones, such as the current disaster in the Gulf of Mexico. In addition, increasing fertilizer usage has not corresponded to similar increases in agricultural productivity. In fact, agricultural yields per acre have consistently fallen over the past decade. Increasing cost of conventional fertilizers and increased pollution from excess utilization of these materials will likely only worsen the problem in the foreseeable future. Increase nutrient run-off and increased cost associated with using these fertilizers serve only to further devastate the agricultural community and the environment.

EPS from Rhizobium tropici has unique adhesive and protective biofilm formation qualities. The adhesion and water retention characteristics of ex situ “grown” EPS may be useful for dust and erosion control in situations where traditional techniques are not viable and where there is a growing necessity for environmentally friendly and sustainable chemical usage. Traditional chemicals used in dust and erosion control that have proven most effective are derived from byproducts of the paint industry. These byproducts, while purified and further processed, are still highly toxic and result in accumulation in the environment. While their toxicity is not immediately apparent when first utilized, over time the accumulation results in ecological damage. Additionally, the time frames required for biodegredation are well beyond several generations of end users. These time frames render the material for all practical purposes persistent in the environment.

EPS are being investigated for use in a wide range of commercial, medical, and industrial applications. Specific applications include adsorption of heavy metals from wastewater and natural water, bioremediation of polycylic aromatic hydrocarbons in oil-contaminated beach sand, and treatment of activated sludge.

The ability to use the R. tropici biopolymer to produce a modified soil that is resistant to erosion would greatly enhance the crop yield of both optimal and nominal agricultural lands. The surface water quality would also improve in those areas that received surface water runoff from treated agricultural land.

### SUMMARY

The methods and compositions of the present disclosure relate to biopolymer salts and their manufacture for use in decreasing erosion, increasing seed germination and increasing agricultural production.

Certain embodiments relate to a method of manufacturing a salt comprising a biopolymer of at least an extracellular polymeric substance (EPS) biogenically produced by Rhizobium tropici as well as to the salts produced therefrom.

According to some embodiments, the method can comprise: placing a culture of Rhizobium tropici in a container comprising water and a first set of nutrients, the first set of nutrients comprising at least one yeast, at least one sugar, at least one potassium phosphate, and at least one calcium chloride; maintaining said culture in a homogenous mixed reactor at a temperature of from 65° F. to 105° F. in aerobic conditions, wherein the aerobic conditions comprise a dissolved oxygen level of at least 0.1 mg/L; cultivating the water-nutrient mixture for a cultivation period of 4-8 weeks and adding at least one additional part nutrients comprising at least a flavanoid and a sugar during the cultivation period; ensuring that the concentration of the EPS in the cultivated material is at least 4 g/L before removal from the container; generating a dehydrated mixture by one selected from the group consisting of flash evaporation, freeze drying, rotary evaporation, vacuum distillation, steam evaporation, contact drying, boiling, solvent precipitation, and combinations thereof; adding an alkai agent to the mixture until said mixture reaches a pH of about 9.5-13 to recover a dry salt.

According to other embodiments, the method can comprise cultivating a composition wherein the composition comprises a culture of Rhizobium tropici, water, at least one yeast, at least one sugar, at least one potassium phosphate, and at least one calcium chloride, wherein the cultivating is carried out at a temperature of from 65 to 105° F., wherein the cultivating is carried out in aerobic conditions, wherein the aerobic conditions comprise a dissolved oxygen level of at least 0.1 mg/L, wherein the cultivating is carried out for a cultivation period of 4-8 weeks; adding at least one additional part nutrients to the composition during the cultivation period, wherein the at least one additional part nutrients comprises at least a flavonoid and a sugar; recovering a cultivated composition from the composition when the concentration of EPS in the composition is at least 4 g/L; dehydrating the cultivated composition by one selected from the group consisting of flash evaporation, freeze drying, rotary evaporation, vacuum distillation, steam evaporation, contact drying, boiling, solvent precipitation, and combinations thereof; adding an alkali agent to the cultivated composition to achieve a pH of about 9.5-13; and recovering a salt from the cultivated composition.

Other embodiments relate to methods of using the salts so produced.

Certain embodiments of the disclosure concern a salt of a biopolymer of at least an extracellular polymeric substance (EPS) biogenically produced by Rhizobium tropici, said dry salt made by: placing a culture of Rhizobium tropici in at least one container of water and nutrients; maintaining said culture and water-nutrient mixture until said the culture and water-nutrient mixture reaches a pH in the range of 9.5-13; and dehydrating the mixture to generate a dehydrated mixture.

In specific embodiments, the dehydrated mixture is at least 10% by weight of the culture and water nutrient mixture.

In specific embodiments, the nutrient used in the creation of the salt includes one or more flavonoids. In still further embodiments, the flavonoids include: butin; eriodictyol; hesperetin; hesperidin; homoeriodictyol; isosakuranetin; naringenin; naringin; pinocembrin; poncirin; sakuranetin; sakuranin; sterubin or a combination thereof. In specific embodiments the one or more flavonoid is naringenin.

Certain embodiments contemplate the manufacture of the salt of a biopolymer.

Certain embodiments of the disclosure concern a method of increasing seed germination comprising coating a seed with a biopolymer salt as a primer and incorporating into a pelletization material.

Certain embodiments of the disclosure concern a method of increasing seed germination comprising adding a biopolymer salt to a soil to create a soil mixture comprising between about 0.2% salt by weight to about 10% salt by weight of soil.

Certain other embodiments of the disclosure concern a method of preventing soil erosion by adding a biopolymer salt to a soil to create a soil mixture comprising between about 0.2% salt by weight to about 10% salt by weight of soil.

Still further, certain embodiments of the invention pertaining to soil erosion pertain to the prevention of heavy metal contamination comprising mixing the soil with between about 0.2% salt by weight to about 10% salt by weight of soil.

Other embodiments of the invention concern a method of increasing agriculture production by adding a biopolymer salt to a soil to create a soil mixture comprising between about 0.2% salt by weight to about 10% salt by weight of soil. In certain embodiments, the biopolymer salt is a metal chelator. In specific embodiments, the metal which is chelated is aluminum. In other embodiments, the biopolymer salt is added to the soils at rates of 0.1 kg/acre to 20 kg/acre.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

These and other features, aspects, and advantages of the present invention will become better understood with reference to the following description and appended claims, and accompanying drawings where:

FIG. 1 is a photograph, illustrating that with small additions of biopolymers to soils, there is an increase in the percentage of more water in saturated soils than without;

FIG. 2 is a chart plotting water loss to air versus time, and illustrating moisture loss to air of a biopolymer treated soil is decreased relative to an untreated soil sample;

FIG. 3 is a chart plotting the retention time versus the molecular weight of biopolymers produced with different feedstock, and illustrating that the properties of the biopolymer changed based on feedstock supplied to the Rhizobium tropici;

FIG. 4 is a chart showing the infra-red spectra of corn syrup, molasses and maltose based biopolymers;

FIG. 5 is a chart, illustrating that the moisture gained from air in an 85% relative humidity atmosphere with the various biopolymer fractions with a 0.2% biopolymer addition to the soil by weight;

FIG. 6 is a schematic illustration of a mesoscale rainfall lysimeter;

FIG. 7 is a photograph of a live-fire test system;

FIG. 8 provides two photographs a live fire test system (LFL) showing the LFL unfilled and filled with the experimental soil;

FIG. 9 is a photograph, showing a live fire test system with rainfall events simulating the annual rainfall of a Northeastern US site in 10 weeks by adding 10 L of water weekly for 10 weeks;

FIG. 10 is a series of photographs of a static lysimeter used to analyze the effect of rainfall on contaminated soil by determining the concentrations of metals and other contaminants in the leachate and runoff water;

FIG. 11 is a chart illustrating the mass of total lead (Pb) detected in the lower leachate and runoff water from control (untreated) and biopolymer-amended soil after one year of simulated weathering;

FIG. 12 is a chart illustrating the mass of total lead (Pb) detected in the upper leachate and runoff water from control (untreated) and biopolymer-amended soil after one year of simulated weathering;

FIG. 13 is a photograph showing slope stability boxes-unamended control cells on left, 0.2% biopolymer cells on right;

FIG. 14 is a series of photographs showing silt soil type (Loess) showing the decrease in the “slump” of the soil (indicated by red line) and the increase in stability with increased biopolymer loading rates;

FIG. 15 is a chart showing mass lost by soil type and biopolymer loading rate;

FIG. 16 is a photographic comparison of the surface durability and resistance to erosion of biopolymer amended soil over the untreated control;

FIG. 17 is a chart providing a comparison of TSS in leachate and runoff water from control and biopolymer-amended APG soil (Silty Clay);

FIG. 18 is a chart illustrating soil loss in untreated berms as a percentage of weight versus untreated controls;

FIG. 19 is a chart demonstrating the total suspended solids (TSS) in control berms versus biopolymer treated berms;

FIG. 20 is a chart demonstrating the weight remaining in berms of different soils which were untreated or treated with biopolymers as a function of time;

FIG. 21 is a chart demonstrating the reduction in sediment loss as measured by total suspended solids in runoff and leachate of a berm with a simulated weathering time of 2.5 years;

FIG. 22 is a chart demonstrating mass loss from Silty Sand soil treated with biopolymer at three loading rates and three relative humidities;

FIG. 23 is a photograph showing the appearance of surface runoff water from soil treated at increasing loading rates of biopolymer;

FIG. 24 provides two charts comparing soil mass retained on a #50 sieve (particles larger than 0.297 mm) for biopolymer-treated and untreated soil;

FIG. 25 is a chart showing a slope stability soil mass lost over 6 weekly rain events (equivalent 3.5 months from two soil types with varying biopolymer loading rates;

FIG. 26 is a chart showing dry compressive yield stress of silty sand soil modified with various loadings of biopolymer salt at 0% moisture content;

FIG. 27 is a chart showing a wet compressive yield stress of silty sand soil modified with various loadings of biopolymer salt at 8% moisture content;

FIG. 28 is a chart showing a plant survival rate of biopolymer coated and uncoated under simulated drought conditions;

FIG. 29 is a series of photographs showing plants grown from biopolymer (left) and uncoated (right) under drought conditions;

FIG. 30 is a chart showing a comparison of germination rate (%) between seeds coated with biopolymer and uncoated seeds (control), showing the effect of biopolymer coating on seed germination rate and drought resistance (A is Germination Rate and B is Survivability);

FIG. 31 is a chart showing the presence of the biopolymer coating increased plant survivability by 42%, however survivability was not affected by the amount of biopolymer coating;

FIG. 32 is a chart showing a graph showing that once the plants had reached maturity and were producing fruit, they were deprived of water for a 1.5 weeks;

FIG. 33 is a chart showing that root mass of plants by weight is also increased in biopolymer amended soil over an un-amended control;

FIG. 34 is a series of photographs showing untreated control (top two photographs) versus biopolymer treated (bottom two photographs) vegetation growth at one week after planting and three weeks after planting;

FIG. 35 shows a schematic block diagram of a Biopolymer Synthesis Work Flow;

FIG. 36 shows schematic diagram of approximate locations of randomly selected plants in a sweet jalapeno pepper field test;

FIG. 37 is a chart showing the biopolymer treated sweet jalapeno peppers had a yield per acre of 1233.3 pounds while the control had a yield per acre of 1042.6 pounds, an 18.30% increase;

FIG. 38 is a chart showing a second harvest of sweet jalapeno peppers resulted in a yield in the control of 625.1 lbs/acre and 744.3 lbs/acre for the biopolymer treated plants;

FIG. 39 is a chart showing a comparison of control and biopolymer treated root masses in sweet jalapeno peppers;

FIG. 40 shows a histogram of binned weights of Roma tomato fruit produced in two test plots, one control and one treated with biopolymer;

FIG. 41 is a chart showing the fruit per Roma tomato plant recorded during the lifecycle of the plants;

FIG. 42 is a chart showing the Roma tomato mass per fruit recorded and showed a 10.9% increase in biopolymer treated plants;

FIG. 43 is a chart showing physical tomato plant measurements in treated compared to control plants in Week 6 of plant growth;

FIG. 44 is a chart showing a comparison between biopolymer treated and control Roma tomato plant characteristics demonstrating improved plant vitality in the treated plants;

FIG. 45 is a chart showing tomato plant yield between treated and control during two commercial harvest periods;

FIG. 46 is a chart showing tomato plant average fruit count between treated and control plants during two commercial harvest periods;

FIG. 47 is a chart showing Romaine lettuce yields between control and treated plants in showing a 363% increase in treated plants;

FIG. 48 is a side-by-side comparison of lettuce roots produced according to the control and inventive treated lettuce roots demonstrating significantly increased fine structure in the treated plants;

FIG. 49 shows two plots on day 1 of a Bermuda grass experiment;

FIG. 50 shows photographs taken from two distances of the plots for the Bermuda grass experiment on Day 8;

FIG. 51 shows photographs taken from two distances of the plots for the Bermuda grass experiment on Day 13;

FIG. 52 shows photographs taken from two distances of the plots for the Bermuda grass experiment on Day 16;

FIG. 53 shows photographs taken from two distances of the plots for the Bermuda grass experiment on Day 2;

FIG. 54 shows photographs of core samples of the Bermuda grass experiment on day 20;

FIG. 55 is a chart showing the average biomass per core sample taken from random areas of a Bermuda grass test test area after twenty days in both a control and a treated area;

FIG. 56 shows photographs of the plots for the Bermuda grass experiment on Day 29;

FIG. 57 is a chart showing the average biomass per core sample taken from random areas of the Bermuda grass test area after twenty-nine days;

FIG. 58 shows photographs of an untreated Bermuda grass root and a treated Bermuda grass root on Day 29;

FIG. 59 shows photographs of an untreated Bermuda grass root and a treated Bermuda grass root on Day 39;

FIG. 60 is a chart showing the average biomass per core sample of the Bermuda grass on day 39;

FIG. 61 is a chart showing the average biomass per core sample of the Bermuda grass on day 57;

FIG. 62 is a chart showing the percentage of seeds germinated after 24 hours and after 48 hours for treated and untreated lettuce seed;

FIG. 63 is a chart showing the mass of fruit produced by treated and untreated tomato plants and zucchini plants in a simulated drought;

FIG. 64 is a chart showing the aluminum concentration in treated and untreated tomato plant roots;

FIG. 65 is a chart showing the aluminum concentration in treated and untreated soy bean roots;

FIG. 66 is a chart showing the aluminum concentration in treated and untreated lettuce roots;

FIG. 67 is a chart showing a comparison of the percent germination after ten days for various control seeds and biopolymer treated seeds, including Swiss chard, Kentucky beans, cotton, squash, pumpkin, and cucumber;

FIG. 68 is a series of photographs showing increased root mass and fine structure in eight treated sweet jalapeno pepper samples versus eight untreated sweet jalapeno pepper control samples;

FIG. 69 is a photograph taken after 6 weeks of growth, showing an untreated soy bean plot on the left and a treated soy bean plot on the right to demonstrate the significant improvement and response in the early stages of the plant growth cycle; and

FIG. 70 is a chart showing the results of soy bean field testing showing the average yield per plot (averaged over three plots) of the treated and non-treated plots.

Some figures illustrate diagrams of the functional blocks of various embodiments. The functional blocks are not necessarily indicative of the division between physical components. It should be understood that the various embodiments are not limited to the arrangements and instrumentality shown in the drawings.

### DETAILED DESCRIPTION

The present invention may be understood more readily by reference to the following detailed description of preferred embodiments of the invention as well as to the examples included therein. All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

Various embodiments relate to a salt comprising a biopolymer of at least an extracellular polymeric substance (EPS) biogenically produced by Rhizobium tropici. The salt can comprise EPS in an amount within a range having a lower limit and/or an upper limit. The range can include or exclude the lower limit and/or the upper limit. The lower limit and/or upper limit can be selected from 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, and 10 percent by weight of the salt. For example, according to certain preferred embodiments, the salt comprises from 0.8% to 8% by weight of the EPS.

Other embodiments relate to methods of producing the salt and to salts produced by the inventive methods. According to one embodiment, the salt can be produced by a process comprising cultivating a composition, wherein the composition comprises a culture of Rhizobium tropici, water, at least one yeast, at least one sugar, at least one potassium phosphate, and at least one calcium chloride.

The composition can comprise an amount of water within a range having a lower limit and/or an upper limit. The range can include or exclude the lower limit and/or the upper limit. The lower limit and/or upper limit can be selected from 90, 91, 92, 93, 94, 95, 96, 97, 98, and 99 percent by weight. For example, according to certain preferred embodiments, the composition can comprise from 94 to 99 percent by weight water.

The composition can comprise an amount of at least one yeast within a range having a lower limit and/or an upper limit. The range can include or exclude the lower limit and/or the upper limit. The lower limit and/or upper limit can be selected from 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, and 0.3 percent by weight. For example, according to certain preferred embodiments, the composition can comprise from 0.05 to 0.2 percent by weight of the at least one yeast.

The composition can comprise an amount of at least one sugar within a range having a lower limit and/or an upper limit. The range can include or exclude the lower limit and/or the upper limit. The lower limit and/or upper limit can be selected from 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, and 2 percent by weight. For example, according to certain preferred embodiments, the composition can comprise from 0.10 to 1 percent by weight of the at least one sugar.

The composition can comprise an amount of at least one potassium phosphate within a range having a lower limit and/or an upper limit. The range can include or exclude the lower limit and/or the upper limit. The lower limit and/or upper limit can be selected from 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, and 5 percent by weight. For example, according to certain preferred embodiments, the composition can comprise from 0.5 to 3 percent by weight of the at least one potassium phosphate.

The composition can comprise an amount of at least one calcium chloride within a range having a lower limit and/or an upper limit. The range can include or exclude the lower limit and/or the upper limit. The lower limit and/or upper limit can be selected from 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, and 0.02 percent by weight. For example, according to certain preferred embodiments, the composition can comprise from 0.001 to 0.01 percent by weight of the at least one calcium chloride.

The cultivating can be carried out at a temperature within a range having a lower limit and/or an upper limit. The range can include or exclude the lower limit and/or the upper limit. The lower limit and/or upper limit can be selected from 50, 55, 60, 65, 70, 75, 80, 85, 90, 95, 100, 105, 110, 115, 120, and 125 degrees Fahrenheit. For example, according to certain preferred embodiments, the cultivating can be carried out at a temperature of from 65 to 105° F.

The cultivating can be carried out in aerobic conditions. The aerobic conditions can comprise a dissolved oxygen level within a range having a lower limit and/or an upper limit. The range can include or exclude the lower limit and/or the upper limit. The lower limit and/or upper limit can be selected from 0.05, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, and 8 mg/L. For example, according to certain preferred embodiments, the aerobic conditions can comprise a dissolved oxygen level of at least 0.1 mg/L. According to certain embodiments, the aerobic conditions comprise a dissolved oxygen level of at least 0.1 mg/L to a saturation level at which the water is saturated with oxygen.

The cultivating can be carried out for a cultivation period having a duration within a range having a lower limit and/or an upper limit. The range can include or exclude the lower limit and/or the upper limit. The lower limit and/or upper limit can be selected from 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, and 80 days. For example, according to certain preferred embodiments, the cultivating can be carried out for a cultivation period of about 4-8 weeks. According to particularly preferred embodiments, the cultivating period can be about 6 weeks or about 42 days.

According to certain embodiments, during the cultivating step, EPS can be generated at a rate within a range having a lower limit and/or an upper limit. The range can include or exclude the lower limit and/or the upper limit. The lower limit and/or upper limit can be selected from 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, and 15 g/week. For example, according to certain preferred embodiments, during the cultivating step, EPS is generated at a rate of from 1 g/week to 10 g/week.

According to certain embodiments, the method further comprises adding at least one additional part nutrients to the composition during the cultivation period, wherein the at least one additional part nutrients comprises at least a flavonoid and at least one sugar. According to certain embodiments, the flavonoid is selected from the group consisting of butin, eriodictyol, hesperetin, hesperidin, homoeriodictyol, isosakuranetin, naringenin, naringin, pinocembrin, poncirin, sakuranetin, sakuranin, sterubin, and combinations thereof. A particularly preferred flavonoid is naringenin.

According to certain embodiments, the method further comprises recovering a cultivated composition from the composition when the concentration of EPS in the composition is within a range having a lower limit and/or an upper limit. The range can include or exclude the lower limit and/or the upper limit. The lower limit and/or upper limit can be selected from 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 30, 35, 40, 45, 50, 55, 60 g/L. For example, according to certain preferred embodiments, the method further comprises recovering a cultivated composition from the composition when the concentration of EPS in the composition is at least 4 g/L.

According to certain embodiments, the method further comprises dehydrating the cultivated composition by one selected from the group consisting of flash evaporation, freeze drying, rotary evaporation, vacuum distillation, steam evaporation, contact drying, boiling, solvent precipitation, and combinations thereof. Contact drying is particularly preferred. According to certain embodiments, the cultivated composition has a weight relative to the weight of the composition, wherein the weight of the cultivated composition is within a range having a lower limit and/or an upper limit. The range can include or exclude the lower limit and/or the upper limit. The lower limit and/or upper limit can be selected from 5, 6, 7, 8, 9, 10, 11, 12, 13, 14, 15, 16, 17, 18, 19, and 20 percent by weight of the weight of the original composition. For example, according to certain preferred embodiments, after the dehydrating step, the cultivated composition is at least 10% by weight of the composition.

According to certain embodiments, the method further comprises adding an alkali agent to the cultivated composition to achieve a pH within a range having a lower limit and/or an upper limit. The range can include or exclude the lower limit and/or the upper limit. The lower limit and/or upper limit can be selected from 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, and 14. For example, according to certain preferred embodiments, the method further comprises adding an alkali agent to the cultivated composition to achieve a pH of about 9.5-13.

According to certain embodiments, the alkali agent is selected from the group consisting of potassium hydroxide, sodium hydroxide, magnesium hydroxide, calcium hydroxide, lithium hydroxide, and combinations thereof. According to certain embodiments, the alkali agent is added prior to the generating step. According to certain embodiments, the alkali agent can be added in an amount within a range having a lower limit and/or an upper limit. The range can include or exclude the lower limit and/or the upper limit. The lower limit and/or upper limit can be selected from 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, and 7 percent by weight. For example, according to certain preferred embodiments, from 0.05% to 5% by weight of the salt of the alkali agent are added.

Finally, according to certain embodiments, the method further comprises recovering a salt from the cultivated composition. Other embodiments relate to methods of using the salt, as described below.

Another embodiment relates to a salt comprising a biopolymer of at least an extracellular polymeric substance (EPS) biogenically produced by Rhizobium tropici. The dry salt can comprise from 0.8% to 8% by weight of the EPS. Other embodiments relate to a method for producing the dry salt, as well as to salts produced by the method. For example a dry salt as described above can be produced by a process comprising adding a culture of Rhizobium tropici to a composition comprising water and a first set of nutrients, the first set of nutrients can comprise at least one yeast, at least one sugar, at least one potassium phosphate, and at least one calcium chloride. According to some embodiments, the composition can comprise from 94 to 99 percent by weight water; from 0.05 to 0.2 percent by weight of the at least one yeast, from 0.10 to 1 percent by weight of the at least one sugar, from 0.5 to 3 percent by weight of the at least one potassium phosphate, and from 0.001 to 0.01 percent by weight of the at least one calcium chloride.

The method can further include maintaining the composition in a homogenous mixed reactor at a temperature of from 65° F. to 105° F. in aerobic conditions, wherein the aerobic conditions comprise a dissolved oxygen level in the reactor of at least 0.1 mg/L. The aerobic conditions can comprise a dissolved oxygen level of at least 0.1 mg/L to a saturation level at which the water is saturated with oxygen.

Next, the method can include cultivating the water-nutrient mixture for a cultivation period of 4-8 weeks, preferably for a cultivation period of 6 weeks, and adding at least one additional part nutrients comprising at least a flavanoid and a sugar during the cultivation period. The flavonoid can be selected from the group consisting of butin, eriodictyol, hesperetin, hesperidin, homoeriodictyol, isosakuranetin, naringenin, naringin, pinocembrin, poncirin, sakuranetin, sakuranin, sterubin, and combinations thereof. Preferably, the flavanoid can be naringenin.

The method can also include ensuring that the concentration of the EPS in the cultivated material is at least 4 g/L before removal from the container.

Some embodiments of the method also include generating a dehydrated mixture by one selected from the group consisting of flash evaporation, freeze drying, rotary evaporation, vacuum distillation, steam evaporation, contact drying, boiling, solvent precipitation, and combinations thereof, preferably by contact drying. The EPS generating step can take place at a rate of from 1 g/week to 10 g/week. The dehydrated mixture can have at least 10% by weight of the culture and water nutrient mixture.

The method can further comprise adding an alkai agent to the mixture until said mixture reaches a pH of about 9.5-13 to recover a dry salt. The alkali agent can be added before or after the generating step. The alkali agent can be selected from the group consisting of potassium hydroxide, sodium hydroxide, magnesium hydroxide, calcium hydroxide, lithium hydroxide, and combinations thereof. According to some embodiments from 0.05% to 5% by weight of the salt of the alkali agent are added.

Currently there are numerous advantages of biopolymers over currently used petroleum based polymers in soil erosion and agricultural and vegetation applications. For example, the use of a biopolymer can eliminate leaching of hazardous products and byproducts such as un-polymerized monomers. Other advantages include the reduced dependence on foreign oil. Components of the biopolymers are naturally occurring in most soils and are considered environmentally benign.

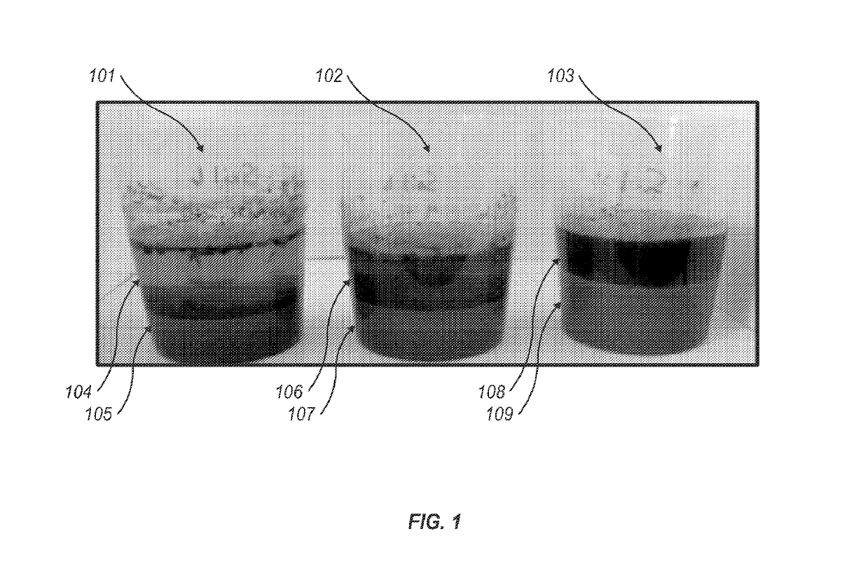

With small additions of the RTBP to soils, there is an increase in the percentage of more water trapped in saturated soils than without. FIG. 1 illustrates that with small additions of RTBP to soils, there is an increase in the percentage of more water in saturated soils than without. More specifically, FIG. 1 shows a first container 101 having no biopolymer, a second container 102 having 1% biopolymer by weight, and a third container 103 having 3% biopolymer by weight. First container 101 comprises a first water phase 104 and a first saturated soil phase 105. Second container 102 comprises a second water phase 106 and a second saturated soil phase 107. Third container 103 comprises a third water phase 108 and a third saturated soil phase 109. The second saturated soil phase 107 comprised 15.5% by weight more water than the first saturated soil phase 105. The third saturated soil phase 109 comprised 38.5% by weight more water than the first saturated soil phase 105. Therefore, in certain embodiments, wherein a 1% by weight biopolymer is added to a saturated soil, there is 15.5% more water in the saturated soil. In other embodiments, wherein a 3% by weight biopolymer is added to a soil, there is 38.5% more water in the saturated soil.

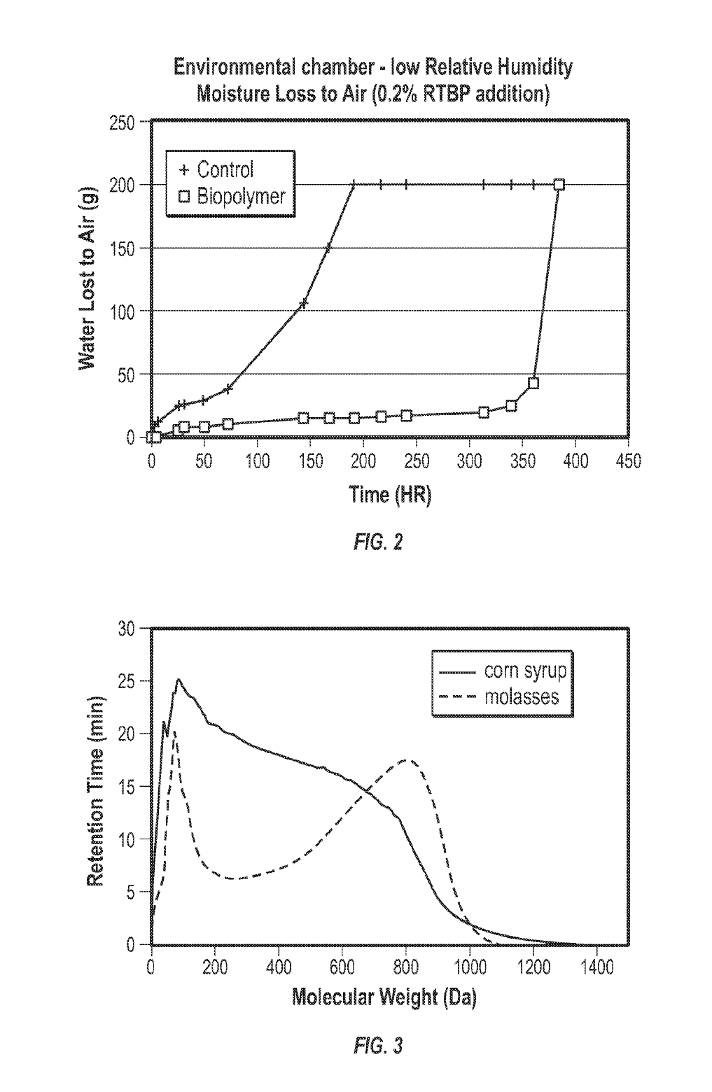

In certain embodiments of the present disclosure, when moisture retention is contemplated, the moisture loss to air of RTBP treated soil is decreased relative to an untreated soil sample as shown in FIG. 2. Briefly, trays of a sandy loam soil were prepared and weighed. Certain trays of soil were mixed with the inventive material at 0.2% weight by weight with the soil. To each tray, the same weight of water was added to achieve super saturation of the soils. Excess water was separated from the trays to achieve complete saturation. The trays were then placed in a controlled environmental chamber at 28° C. The mass for each tray was recorded for an extended period of time. The resultant weight from each recording was calculated as the remaining moisture content. FIG. 2 is the average of triplicate analysis. In drought conditions, increased moisture retention over extended periods of time can ensure that plants that otherwise may have died have increased survival rates. These increased survival rates can help mitigate the damage associated with a drought and still yield a marketable and potentially profitable crop. Without such a protective measure, an entire crop and year's profitability may be lost.

In select embodiments of the present invention, a bacteria, Rhizobium tropici, produces a biopolymer ex situ that, when recovered from a bacterial culture and added to a soil, improves the engineering properties. For example, with the addition of specific functional groups to the EPS it becomes a heavy metal chelator as well as erosion/dust control agent. Modifications made to Rhizobium tropici EPS allow production of a transportable product that can be reconstituted with water at the location of use. Further, when added to soil at 0.1% by dry weight, the extracellular polysaccharide (EPS) produced by Rhizobium tropici ATCC 49672 in select embodiments of the present invention decreases the hydraulic conductivity of the soil by three orders of magnitude.

In select embodiments of the present invention, modifications made to the EPS produced by Rhizobium tropici ATCC 49672 produce a dry salt that precipitates from solution and can be re-hydrated back to its original form. One result is a soil amendment that remains in place and creates additional covalent linkages as the soil is disturbed, e.g., agitated, undergoes wet/dry cycles, and the like. Further; addition of small quantities of biopolymer may result in amide-forming condensation reactions that increase soil strength to levels equal to or beyond that achieved from the original application of the amendment.

In select embodiments, a hydrated RTBP salt, when used to coat seeds, results in increased germination rates with decreased water application. In addition, when the seedlings are challenged by an artificial drought, the plants grown from the biopolymer-coated seeds are significantly more resistant to the drought conditions than the uncoated seeds. The biopolymer salt, when mixed with soil, results in a decrease in surface erosion as measured by a decrease in suspended solids in surface water runoff. Additionally, the use of the RTBP salt results in significant decreases in thermal dormancy, thus improving the ability of all seeds to germinate outside of natural temperature ranges.

In select embodiments Rhizobium tropici biopolymer salt may be manufactured by novel methods. In certain embodiments the salt may be manufactured through the use of a flavonoid. In certain embodiments, any flavonoid may be used. Examples of flavonoids include but are not limited to flavonoids, derived from a 2-phenylchromen-4-one (2-phenyl-1,4-benzopyrone) structure; flavonoids derived from a derived from 3-phenylchromen-4-one (3-phenyl-1,4-benzopyrone) structure or flavonoids derived from 4-phenylcoumarine (4-phenyl-1,2-benzopyrone) structure. Examples of specific flavonoids include: quercetin; epicatechin; hesperidin; rutin; naringenin; luteolin; apigenin; tangeritin; kaempferol; myricetin; fisetin; isorhamnetin; pachypodol; rhamnazin; eriodictyol; homoeriodictyol; taxifolin; dihydrokaempferol; genistein; daidzein; glycitein; catechin (C); gallocatechin (GC); catechin 3-gallate (Cg); gallocatechin 3-gallate (GCg)); epicatechin (EC); epigallocatechin (EGC); epicatechin 3-gallate (ECg); epigallocatechin 3-gallate (EGCg); cyanidin; delphinidin; malvidin; pelargonidin; peonidin or petunidin. In certain select embodiments, the flavonoids used in the production of the biopolymer salt may include one or more of the following: butin; eriodictyol; hesperetin; hesperidin; homoeriodictyol; isosakuranetin; naringenin; naringin; pinocembrin; poncirin; sakuranetin; sakuranin; or sterubin. In still further embodiments, the flavonoid is naringenin.

In such embodiments wherein the use of a flavonoid is contemplated, the production of a biopolymer salt may optionally do away with a step involving ethanol as described in U.S. Pat. No. 7,824,569, which is hereby incorporated by reference in its entirety. Still further, concentration of a biopolymer salt may be via dehydration. In certain embodiments, the biopolymer salt is dehydrated when removed from a reactor used to produce the biopolymer salt. In certain embodiments, the dehydration decreases the volume by about 5%, 10%, 15%, 20%, 25%, 30%, 35%, 40%, 45%, 50%, 55%, 60%, 65%, 70%, 75%, 80%, 85%, or 90% compared to the undehydrated solution containing the biopolymer salt removed from the bioreactor. For example, the dehydration can decrease the volume by about 75%.

Some embodiments of this disclosure include improvements to agricultural and vegetation growth by using the salts described above. Other embodiments of this disclosure include soil erosion and dust control by using the salts described above. Additional embodiments of this disclosure include metal chelation using the salts described above.

Some embodiments relate to methods of decreasing dormancy in one or more seeds by priming a seed with the salt. Some embodiments relate to methods of decreasing dormancy in one or more seeds by incorporating the salt into the coating or pellet of one or more seeds.

Some embodiments relate to methods of increasing seed germination comprising adding the salt to a soil to create a soil mixture comprising between about 0.2% salt by weight to about 10% salt by weight of soil. Some embodiments relate to methods of increasing seed germination comprising coating a seed with the salt. Select embodiments of the disclosure relate to methods of increased seed germination or increased food production by metal chelation via a biopolymer salt. Aluminum toxicity is a global agricultural problem severely limiting agricultural productivity in more than half of the world's arable land. The problem is especially severe in large parts of the developing world, where acid soils are predominant. One hypothesis regarding the presence of aluminum and decreased plant growth is that aluminum binds to several targets in the root system, blocking cell division, damaging DNA, and ultimately interrupting plant growth. Another hypothesis is that a factor in plant cells, called AtATR, that functions as a built-in DNA surveillance system for alerting the plant of damage from excess aluminum and shutting down growth.

Some embodiments relate to methods of preventing soil erosion by adding the salt to a soil to create a soil mixture comprising between about 0.2% salt by weight to about 10% salt by weight of soil. Prevention of the soil erosion can prevents heavy metal contamination. Select embodiments of the disclosure relate to methods of decreasing heavy metal contamination by prevention of soil erosion using a biopolymer salt. In certain embodiments, a biopolymer salt may be mixed with soil in an amount within a range having a lower limit and/or an upper limit. The range can include or exclude the lower limit and/or the upper limit. The lower limit and/or upper limit can be selected from 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, 5, 5.05, 5.1, 5.15, 5.2, 5.25, 5.3, 5.35, 5.4, 5.45, 5.5, 5.55, 5.6, 5.65, 5.7, 5.75, 5.8, 5.85, 5.9, 5.95, 6, 6.05, 6.1, 6.15, 6.2, 6.25, 6.3, 6.35, 6.4, 6.45, 6.5, 6.55, 6.6, 6.65, 6.7, 6.75, 6.8, 6.85, 6.9, 6.95, 7, 7.05, 7.1, 7.15, 7.2, 7.25, 7.3, 7.35, 7.4, 7.45, 7.5, 7.55, 7.6, 7.65, 7.7, 7.75, 7.8, 7.85, 7.9, 7.95, 8, 8.05, 8.1, 8.15, 8.2, 8.25, 8.3, 8.35, 8.4, 8.45, 8.5, 8.55, 8.6, 8.65, 8.7, 8.75, 8.8, 8.85, 8.9, 8.95, 9, 9.05, 9.1, 9.15, 9.2, 9.25, 9.3, 9.35, 9.4, 9.45, 9.5, 9.55, 9.6, 9.65, 9.7, 9.75, 9.8, 9.85, 9.9, 9.95, and 10 weight percent. For example, a biopolymer salt may be mixed with soil in an amount from about 0.01% biopolymer to about 10% biopolymer to prevent erosion of contaminated soils into watersheds. In specific embodiments, the biopolymer comprises about 0.2 to about 1% of the total weight of the soil.

Some embodiments relate to methods of mitigating drought conditions in agricultural crops and revegetation efforts by adding the salt to soils at 0.1% by weight of soil to 3% by weight of soil. Certain embodiments of the disclosure relate to increasing water retention in soil. In specific embodiments, a soil may comprise a biopolymer salt in an amount within a range having a lower limit and/or an upper limit. The range can include or exclude the lower limit and/or the upper limit. The lower limit and/or upper limit can be selected from 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, and 10 weight percent. For example, a soil may comprise about 0.5% to about 10% biopolymer salt by weight for use in retaining water in the soil. In other embodiments, the composition of biopolymer is between about 1% and about 4% by weight of soil. In certain embodiments, wherein water retention is desired in an arid environment, the soil may comprise about 0.2% biopolymer by weight.

Some embodiments relate to methods of mitigating drought conditions in agricultural crops and revegetation efforts by adding the salt to soils in an amount within a range having a lower limit and/or an upper limit. The range can include or exclude the lower limit and/or the upper limit. The lower limit and/or upper limit can be selected from 1, 2, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, and 200 kg/acre. For example, some preferred embodiments relate to methods of mitigating drought conditions in agricultural crops and revegetation efforts by adding the salt to soils at 2 kg/acre to 110 kg/acre.

Some embodiments relate to methods of increasing agriculture production by adding the salt to a soil to create a soil mixture comprising an amount of salt within a range having a lower limit and/or an upper limit. The range can include or exclude the lower limit and/or the upper limit. The lower limit and/or upper limit can be selected from 0.1, 0.2, 0.3, 0.4, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, and 15 percent by weight of the soil mixture. For example, some preferred embodiments relate to methods of increasing agriculture production by adding the salt to a soil to create a soil mixture comprising between about 0.2% salt by weight to about 10% salt by weight of soil.

Some embodiments relate to methods of increasing agriculture production by adding the salt to soils in an amount within a range having a lower limit and/or an upper limit. The range can include or exclude the lower limit and/or the upper limit. The lower limit and/or upper limit can be selected from 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, and 25 kg/acre. For example, some preferred embodiments relate to methods of increasing agriculture production by adding the salt to soils at 0.10 kg/acre to 20 kg/acre. The salt can be a metal chelator. The metal can be aluminum.

Some embodiments relate to methods of increasing nodulation in leguminous plants by adding the salt to soils in an amount within a range having a lower limit and/or an upper limit. The range can include or exclude the lower limit and/or the upper limit. The lower limit and/or upper limit can be selected from 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, and 25 kg/acre. For example, some preferred embodiments relate to methods of increasing nodulation in leguminous plants by adding the salt to soils at 0.1 kg/acre to 20 kg/acre.

Some embodiments relate to methods of improving metal impacted soils to reestablish vegetative growth by adding the salt to soils at 0.1% by weight of soil to 3% by weight of soil.

Some embodiments relate to methods of establishing grasses to prevent soil erosion by adding the salt to soils in an amount within a range having a lower limit and/or an upper limit. The range can include or exclude the lower limit and/or the upper limit. The lower limit and/or upper limit can be selected from 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, and 5 kg/acre. For example, some preferred embodiments relate to methods of establishing grasses to prevent soil erosion by adding the salt to soils at 0.1 kg/acre to 2 kg/acre.

In additional embodiments, the inventive amendment may be applied at a rate within a range having a lower limit and/or an upper limit. The range can include or exclude the lower limit and/or the upper limit. The lower limit and/or upper limit can be selected from 0.05, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20 kg/acre. For example, the inventive amendment may be applied at rates of 0.05 kg/acre to 20 kg/acre to promote agricultural growth.

### EXAMPLES

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit or scope of the invention. The following Examples are offered by way of illustration and not by way of limitation.

### Experiment 1: Biopolymer Production

Process modifications have been found that change the biopolymer structure and functionality. Four sugar sources have been tested as feedstock for the production of biopolymer by Rhizobium tropici: corn syrup, maltose, sorghum, and molasses. The use of varied sugar sources has been observed to produce biopolymers with varied chemical relativities and functional groups. Physical differences between the biopolymers produced from varied carbon sources included changes in color and texture. Chemical differences were investigated using Fourier transform infrared (FT-IR), and gel permeation chromatography (GPC). For the stabilization of heavy metals it is important that the biopolymer cross-links around the adsorbed metal and soil particle to reduce the mobility of the soil particle in water and the transport of the heavy metal. FIG. 3 demonstrates the properties of the biopolymer changed based on feedstock supplied to the Rhizobium tropici.

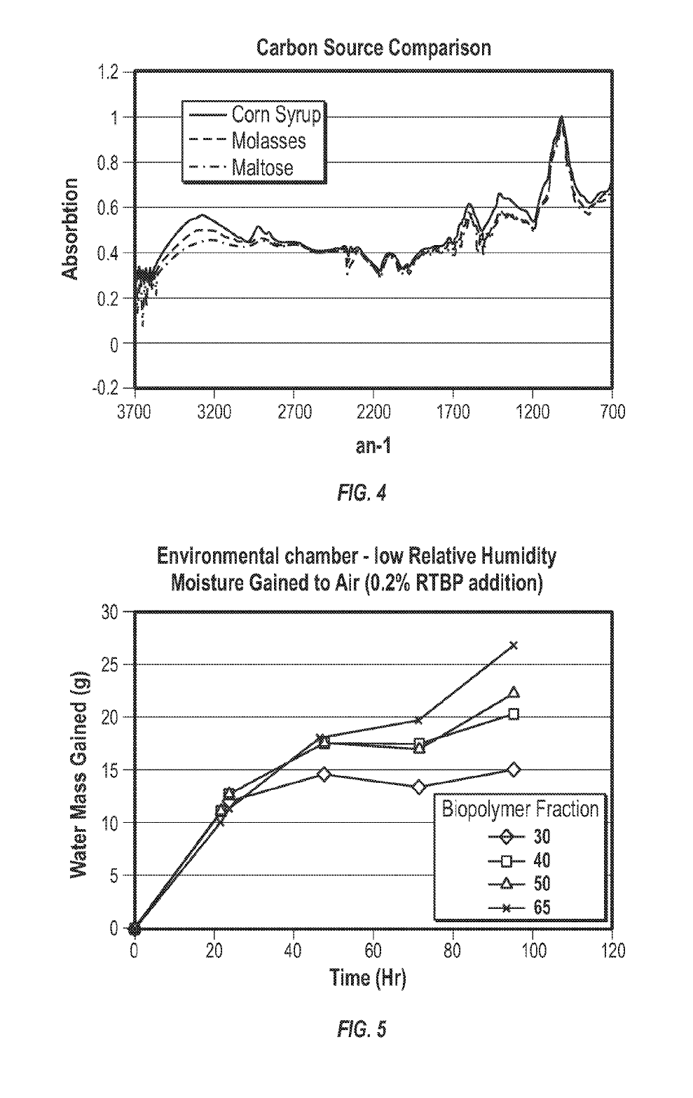

FT-IR with a total attenuated reflectance optical cell was used to evaluate the chemical functionality of three biopolymers, all produced using Rhizobium tropici and with three separate carbon sources. FIG. 4 displays the infra-red spectra of corn syrup, molasses and maltose based biopolymers.

Corn syrup produced similar carboxylic acid content as the maltose grown material with more alcohol functional groups than observed in the maltose polymer. Corn syrup contains primarily glucose units. Molasses produced more carboxylic acid groups than the maltose or the corn syrup-based material and approximately the same degree of alcohol functionalization as noted in the corn syrup feedstock biopolymer. The sugars in sugar cane molasses are a more complex combination, being composed of 4% glucose, 7% fructose, and 31% sucrose.

FT-IR data can show the ability of the biopolymer salt, once protonated to undergo cross linking with other biopolymer strands, to make larger and larger polymer units. The reaction between amine moieties and protonated carboxylic acid groups to form a covalent carbon-nitrogen bond is observed by comparing biopolymer samples as the biopolymer salt and the same biopolymer salt after pH reduction.

Because gel permeation chromatography separates individual molecules based on their respective size relative to the swelling polymer that is used as a stationary phase, a correlation can be made between the retention time and the molecular weight of the material. Gel permeation chromatography (GPC) on a size exclusion column was used to determine the distribution of molecular weight fractions of the biopolymer salt grown on corn syrup, and molasses sugar feedstocks. The results are shown in FIG. 3. Each of the RTBP demonstrated a different, and unique, molecular weight distribution of components. For example, the molasses-derived biopolymer exhibited components in both the very small molecular weight range (approximately 150 Da) and the much larger 800 Da range. Corn syrup-derived BP, on the other hand, showed a greater number of small molecular weight components (100-200 Da). These characteristics are also dependent upon batch time and feedstock inputs over the resonance time of the batch reactors.

One method of generating biopolymer is through the use of flavonoids such as naringenin. In this method a broth is developed for growth of the Rhizobium tropici. To generate the broth, into 20 L water the following ingredients are added: 1) 20 g yeast; 2) 50 g sugar such as mannitol; 3) 190.2 g KH₂PO₄; 4) 10 g K₂HPO₄; 5) 2.0 g MgSO₄; 6) 3 g CaCl₂ and 0.0013 g of the flavonoid naringenin.

Once the broth has been autoclaved and cooled to a temperature that is not steaming, it can be added to a reactor and the Rhizobium tropici can be immediately added. After the biopolymer reactor has been driven to a pH of approximately 11, where it can be as low as 9.5 and as high as 13, the material can then be dried to a slurry that is at most around 90% less volume than the starting volume. This step can be used to replace the ethanol extraction step from U.S. Pat. No. 7,824,569 which is herein incorporated by reference in its entirety.

### Experiment 2: RTBP Fractionation

It was observed during processing that different ratio of ethanol and water yielded biopolymer salts with different physical characteristics of texture and color. This was particularly evident in the molasses-produced biopolymer which also had the double peak in the GPC. This indicates the possibility of different size fractions of biopolymer which may also have varying chemical properties.

Separation processes are any set of operations that separate solutions of two or more components into two or more products that differ in composition. Fractionation is separation process in which a quantity of a mixture is divided into a number of smaller quantities (fractions) in which the composition changes according to a gradient. Fractions are collected based on differences in a specific property of the individual components. This process has been successfully exploited by the oil and gas industry in the fractionation of oil to form many different petroleum products. Solvent-based fractionation, developed in the 1950's, was used in the food industry to produce fats with varying melting properties. With the growing interest in biofuel development, the fractionation of cellulose and other biofuel stocks using an organic solvent-based fraction technique (organosolv process) has become widely accepted.

Fractionation of biopolymers, particularly flow field fractionation, is a new and expanding area technology. Flow field fractionation is a separation technique where a field is applied to a mixture perpendicular to the mixtures flow in order to cause separation due to differing mobilities of the various components in the mixture. The field can be gravitation, centrifugal, magnetic, thermal, or a cross-flow.

Because of the hydrophilic nature of the EPS biopolymer produced by R. tropici, a useful method to separate biopolymer from other compounds present in the clarified and dehydrated bioreactor product is to add ethanol to the solution and force the hydrophyllic biopolymer from the now less polar solvent mixture. This research has used the relative hydrophobicity and molecular weight of the biopolymer in the clarified and dehydrated bioreactor product, along with a low ethanol to water solvent-based fractionation scheme, to produce RTEPS fractions with varied properties and behaviors. When low ethanol to water ratio solutions are used to separate the biopolymer from the clarified and dehydrated bioreactor product, large molecular weight biopolymer with low water retention characteristics, compared to the RTEPS that is forced out of solution at higher ethanol to water ratios, is obtained.

### Experiment 2: Materials

A concentrated mixture of molasses-derived biopolymer dissolved in water was prepared to use as the bulk solution for the fractionation process. Ethanol was used in different amounts to separate the different fractions of biopolymer from the water. The fractionation was run at a small scale allowing the use of two gallon buckets set up on mixing plates as the reactors. The small scale design also allowed for a centrifuge to replace the slow gravity settling process to separate the solids from the solutions.

The bulk biopolymer solution was produced by first mixing 80 liters biopolymer in ethanol at a 60 percent ratio. The solids produced from this mixture settled overnight and were separated from the solution and dissolved in small amount of water at high pH (pH>12). This was mixed thoroughly to produce a concentrated solution of biopolymer water.

Three fractionation processes were conducted simultaneously using 2 liters each of the concentrated biopolymer bulk solution. Four fractions were created from this solution using 30, 40, 50, and 65 percent ratios of ethanol to biopolymer. The fractions were produced in order from lowest ethanol ratio to highest. The 30 percent ratio of ethanol was created by adding 0.85 liters of ethanol to the bulk biopolymer solution. This mixture was mixed thoroughly until no solids were present. The fraction of biopolymer released from the water by this ratio of ethanol was separated from the mixture using a centrifuge. All of the decanted liquid remaining was combined in back in the 2 gallon bucket where the next ratio of ethanol was added and the process was repeated.

Each following fraction was created by mixing the remaining decant from the settling stage of the previous fraction with increasing volumes of ethanol and repeating the settling process with the centrifuge. The volumes of ethanol added during each step are shown in Table 1.

TABLE 1
Ethanol ratios used to prepare the primary RTEPS size fractions

| Ethanol Ratio | Ethanol Volume Added (L) |
|---|---|
| 30% | 0.85 |
| 40% | 0.50 |
| 50% | 0.65 |
| 65% | 1.70 |

The resulting fraction from the 30 percent mixture was a much larger volume than expected while the 40, 50, and 65 percent mixtures produced very small volumes of biopolymer. This indicated that much of the biopolymer from the higher ratio fractions was trapped during the settling phase of the 30 percent fraction. To further separate these different fractions, the biopolymer solids from obtained from the 30 percent ethanol ratio were dissolved in 3 liters of water at pH>12 to produce a 3.8 liter biopolymer mixture. The fractionation steps were then repeated on this mixture using the same ratios of ethanol to produce the 30, 40, 50, and 65 percent fractions of biopolymer. This process was successful in further separating the different fractions and produced larger volumes of biopolymer from the higher ratio fractions. These additional amounts of biopolymer were each added to their volumes produced previously. Table 2 shows the ethanol volumes added to produce each fraction.

TABLE 2
Ethanol ratios used to prepare the secondary RTEPS size fractions

| Ethanol | Ethanol Volume Added |
|---|---|
| Ratio | (L) |
| 30% | 1.6 |
| 40% | 0.9 |
| 50% | 1.3 |
| 65% | 3.2 |

This process of fractioning the solids from the 30 percent mixture was repeated once more to ensure that the biopolymer fractions were completely separated. For this phase, the biopolymer solids recovered from the previous 30 percent mixture were dissolved in water at pH>12 to produce a 2.5 liter biopolymer mixture. Table 3 shows the ethanol volumes added to this mixture to produce each fraction.

TABLE 3
Ethanol ratios used to prepare the tertiary RTEPS size fractions

| Ethanol | Ethanol Volume Added |
|---|---|
| Ratio | (L) |
| 30% | 1.1 |
| 40% | 0.6 |
| 50% | 0.8 |
| 65% | 2.1 |

The resulting biopolymer fractions were each dried through several stages of mixing with pure ethanol and decanting the liquids. The ethanol causes the water to be released from the biopolymer allowing the excess to be poured off the solids. The solids were placed in an oven at 55 ° C. to complete the drying process. Once completely dried, a planetary mill was used to grind and homogenize the samples for the final product.

Total suspended solids (TSS) and turbidity were measured for leachate and runoff water in both the static and live-fire lysimeters. A Hach DR/200 spectrophotometer was used to analyze samples for TSS and turbidity. The samples were read at 810 nm for suspended solids, and at 450 nm for turbidity.

Total (digested) metals were determined on aqueous samples (leachates and runoff waters) after digestion according to US EPA SW-846 Method 3015 (1999). Dissolved metals were determined after filtering samples through a 0.45 micron filter (Method 3010, American Public Health Association (APHA) 1998). Analysis was performed using Inductively-Coupled Plasma (ICP) on either a Perkins Elmer Optima 3000 (SW-846 Method 6010) or a Perkins Elmer Sciex 6000 (SW-846 Method 6020).

FIG. 5 demonstrates the moisture gained from air in an 85% relative humidity atmosphere with the various biopolymer fractions with a 0.2% biopolymer addition to the soil by weight.

### Experiment 3: Bermed Small Arms Firing Ranges

Heavy metal transport off ranges is a concern with both water and air erosion of soil and requires extensive range maintenance to control, the cost of which has been known to equal $7 billion. Metals-contaminated dust is also potential health concern for troops. The ability to manage military installations in a sustainable, yet environmentally sound, manner that maximizes the time available for training and testing is a critical aspect of maintaining a fully operational and well trained fighting force. Munitions metals of concern include lead, antimony, chromium, copper, iron and zinc, as well as others. The presence of these metals in soil generates a number of environmental concerns associated with water quality and migration of the metals off-site.

Small arms ammunition is typically a Pb²⁺ alloy, primarily consisting of Pb²⁺ with smaller amounts of antimony (Sb-a hardening agent) and other metals, encased in a copper (Cu) and zinc (Zn) shell casings/jacket. The United States Environmental Protection Agency (USEPA) estimated that approximately 160 million pounds of the 2 million tons of all lead produced in the U.S. in the late 1990s was made into bullets or lead shot. Some metals become associated with suspended solids in runoff and/or leachate water. The suspended solid materials are entrained in the soil pore structure as colloidal, and sometimes cationic or anionic, metals. Studies at over 20 small arms firing ranges have shown that the vast majority of lead leaving SAFRs is present as suspended solids in surface water runoff. This allows for vertical migration through the soil structure towards water in the subsurface, such as a shallow water table. Eventually these materials settle out of the water over an area significantly larger than the initial area of interest where the munitions metals were deposited. Heavy metal-laden dust is also a potential health concern for troops. Eliminating off-site migration of heavy metals and reducing transport of contaminated sediment off-range are an integral part of managing small arms firing ranges (SAFRs) facilities.

Long-term use of SAFRs results in lead contamination from spent ammunition deposited within and adjacent to the targets. Metals occur in the form of discrete particles (intact bullets or shot, and fragments), metal salts (weathering products), and dissolved metal or metallic complexes adsorbed to the soil matrix. It has been documented that more than 96 percent of the lead is present as intact or fragmented bullets or shot. Depending on the range configuration, lead bullets striking soil around a target or an impact berm at high speeds could vitrify on impact forming “melts” on individual soil particles. Metals can then interact with soil in several ways: 1) with the surface of particulate material in soils (adsorption); 2) with specific contaminants, a reaction sometimes referred to as chemisorptions; 3) with inorganic and organic ligands resulting in complexation; and 4) with inorganic soil constituents (e.g., carbonates, sulfates, hydroxides, sulfides) to form precipitates or ionic complexes.

Several investigators have demonstrated that lead ammunition exposed to the elements in surface soil will eventually oxidize to a soluble ionic form.

Best Management Practices (BMPs) have been suggested to control lead migration from active SAFRs. These include vegetative methods that control stormwater runoff, physical methods to management stormwater, changes in berm design, the use of geosynthetic materials, physical separation techniques to remove large bullet fragments from the soil, and soil amendments. Natural soil amendments involve the addition of lime, iron, or phosphate to the soil. These chemicals may mitigate the corrosion of lead in the soil, bind the lead ions in the soil pore water through adsorption, or promote the precipitation of lead ions and the formation of relatively insoluble lead species.

The ability to efficiently improve soil engineering properties is directly in-line with current military doctrine. Studies using the R. tropici biopolymer salt, demonstrated that, mixing the bioplymer with munitions constituent-contaminated (e.g. metals such as lead, antimony, etc.) firing range soil, resulted in a decrease in the mass of metals released in the leachate. The use of biopolymer stabilizing agents eliminates dependence on petroleum-based materials, leaves no lasting footprint. Biopolymers have been shown to be effective alternatives for the petrochemical-based polymer soil additives currently in use.

### Experiment 3: Materials and Methods:

Static mesoscale rainfall lysimeters were used to evaluate the ability of the biopolymer to reduce heavy metal transport in both surface runoff water and leachate under static conditions. The soils in the static lysimeter were amended with 0.2% biopolymer grown from a mixed carbon source feedstock. The control was unamended soil. Each lysimeter received weekly rainfall.

Dynamic live-fire lysimeters were used to evaluate the ability of the biopolymer to reduce heavy metal transport in surface water runoff and leachate following live-fire exercises. The soils in the live-fire lysimeters were amended with 0.2% (w:w) biopolymer grown on either corn syrup, molasses, or sorghum feed stock. Two controls were used: an unamended soil that did not receive live-fire and an unamended soil that received live-fire weekly. All lysimeters received weekly rainfall.

The leachate and runoff water from both experiments was analyzed for heavy metals and total suspended solids (TSS).

The biopolymer that proved most successful at immobilizing metals in soil in the live-fire lysimeter was fractionated using an organic solvent and centrifugation procedure that produced fractions of increasing molecular weight. The fractions were analyzed and the molecular weight distributions compared by size exclusion gel permeation chromatography. The fractions were compared in live-fire lysimeter studies for their ability to stabilize metal laden berm in soil. Leachate and runoff water were analyzed for heavy metals and TSS.

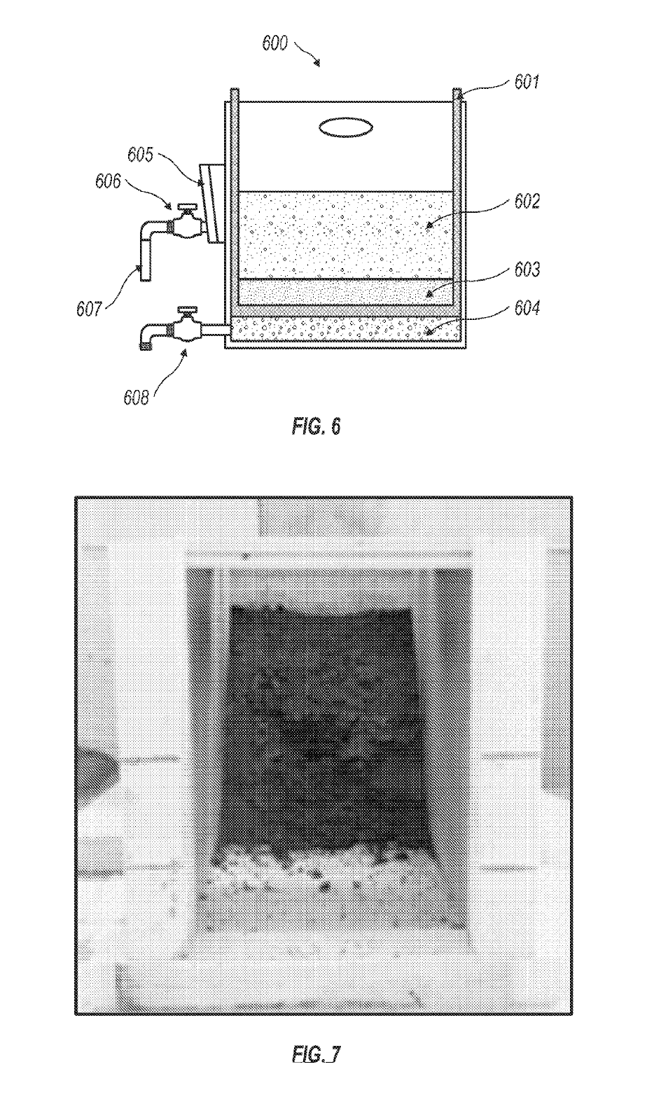

The static test system is based on the mesoscale rainfall lysimeter (FIG. 6). Static refers to the fact that the soil used in the lysimeter is contaminated with munition residues and aged. Each lysimeter receives rainfall weekly. A delivery system for the artificial rain is used with the lysimeters to simulate yearly rainfall and weathering. The lysimeters were designed to allow for the collection of leachate percolating through the soil as well as runoff from the soil surface. A simulated weathering time of approximately 2.5 years was evaluated based on average Southeast rainfall of 47-51 inches per year.

Soil from Aberdeen Proving Ground (APG) was evaluated in a static rainfall lysimeter as shown in FIG. 6, with 0.2% biopolymer (w:w) and compared to its untreated control after each rainfall event. The APG soil is classified as a Silty Clay (CL).

Rainfall was conducted weekly for 16 weeks, the equivalent of 1-year of rainfall in a temperate Northeastern area. Leachate and runoff water samples were collected weekly, 24-hr following the rain event. The volume of each was measured and recorded and the samples were split for analysis of TSS and metals.

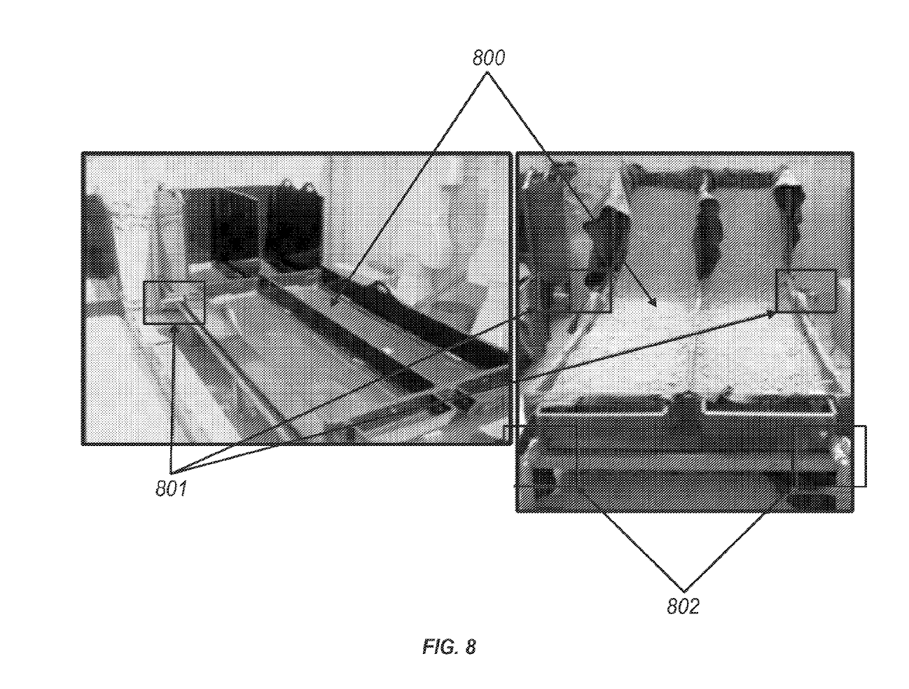

The live-fire test system differs from the static test in that the soil loaded into the lysimeter is augmented by live-fire ammunition. The LFL accounts for active bullet loading into a berm or impact on unbermed soil and it reflects the dynamic effects of the bullet loading on the total suspended solids. The LFL also accounts for the effects of bullet-to-bullet impacts and the general effects of the soil disturbance in the impact area. An example of a LFL cell is shown in FIG. 7. The cell is surrounded by SACON® blocks to prevent bullet ricochet. The top is covered with plywood to prevent soil ejecting from contaminating adjacent cells. For this treatability study, the toe area of the berm was extended outward to simulate target impact areas. The toe area had its own leachate collection system (Lower Leachate) distinct from the berm collection system (Upper Leachate). This system is illustrated in FIG. 8, showing the LFL unfilled and filled with the experimental soil. More specifically, FIG. 8 provides two photographs of a live fire test system 800. The live fire test system 800 is shown unfilled (left image) and filled with the experimental soil (right image). The live fire test system 800 can include an upper leachate collector 801 and a lower leachate collector 802, which can be used to collect leachate from the upper and lower portions of the live fire test system 800.

Three types of biopolymer were tested for their effectiveness at stabilization of heavy metals in soil. The biopolymer was produced using three different carbon sources: sorghum, molasses, and corn syrup.

Each cell contained soil amended with one of the three biopolymer types at a loading rate of 0.5% (w:w). Table 4 summarizes the contents of the lysimeter cells. The soil used in the live-fire lysimeters was from Fort Leonard Wood and is classified as a Sandy Silt with gravel (6.6% gravel, 42.7% sand, 50.7% fines).

TABLE 4

| Lysimeter | Amendment |
|---|---|
| 1 | Control - no amendment, no firing |
| 2 | Control - no amendment |
| 3 | Sorghum RTBP |
| 4 | Molasses RTBP |
| 5 | Corn syrup RTBP |

Note:
RTBP = Rhizobium tropici biopolymer

Two M16A2 weapons were used in this test. The cadence of test firing was 2-3 rounds per minute. The berms were fired into weekly for 10 weeks using 150 M-16 rounds of 5.56 mm bullets per event. A total of 1500 bullets were fired into each cell. The top and the toe area of the lysimeter were covered with plywood to prevent soil spattering into adjacent lysimeters.

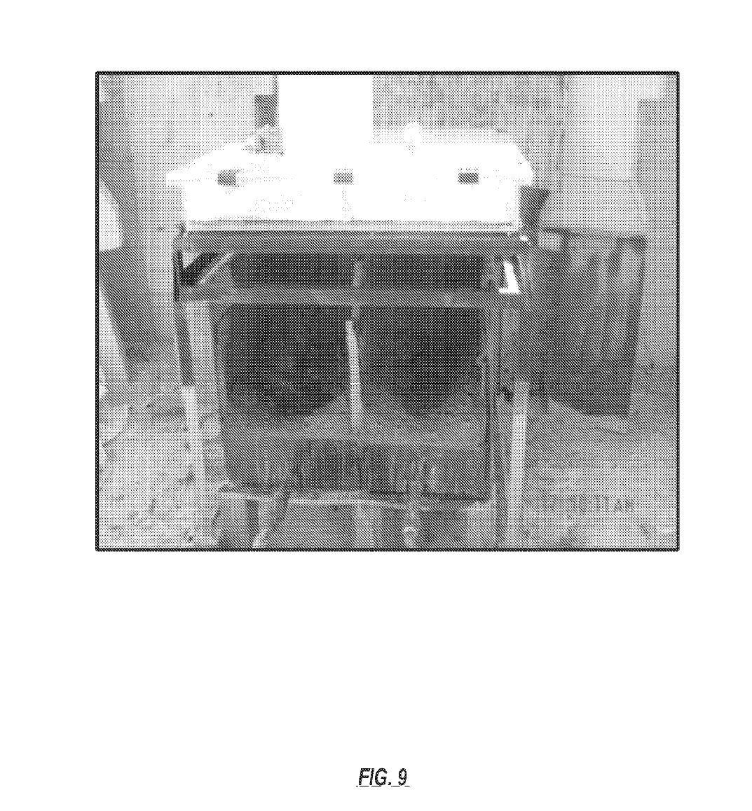

Rainfall events simulated the annual rainfall of a Northeastern US site in 10 weeks by adding 10 L of water weekly for 10 weeks. FIG. 9 is a photograph, showing a live fire test system with rainfall events simulating the annual rainfall of a Northeastern US site in 10 weeks by adding 10 L of water weekly for 10 weeks.

The runoff water and leachate were collected and transported to the laboratory where soluble metals (<0.45 micron) analysis was performed using inductively coupled plasma optical spectroscopy following filtration, total suspended solids were determined gravimetrically, and suspended solids containing waters were digested using microbe assisted acid digested and the filtered digests were analyzed using inductively coupled plasma optical spectroscopy. While lead is the heavy metal of greatest interest when discussing transport off-range, all munitions-derived metals were quantified for both dissolved and total concentrations: lead (Pb), chromium (Cr), copper (Cu), nickel (Ni), zinc (Zn), iron (Fe), manganese (Mn), molybdenum (Mo), vanadium (V), antimony (Sb), and arsenic (As).

### Experiment 3: Results

The static lysimeter, a mesoscale technology used to analyze the effect of rainfall on contaminated soil by determining the concentrations of metals and other contaminants in the leachate and runoff water is shown in FIG. 6.

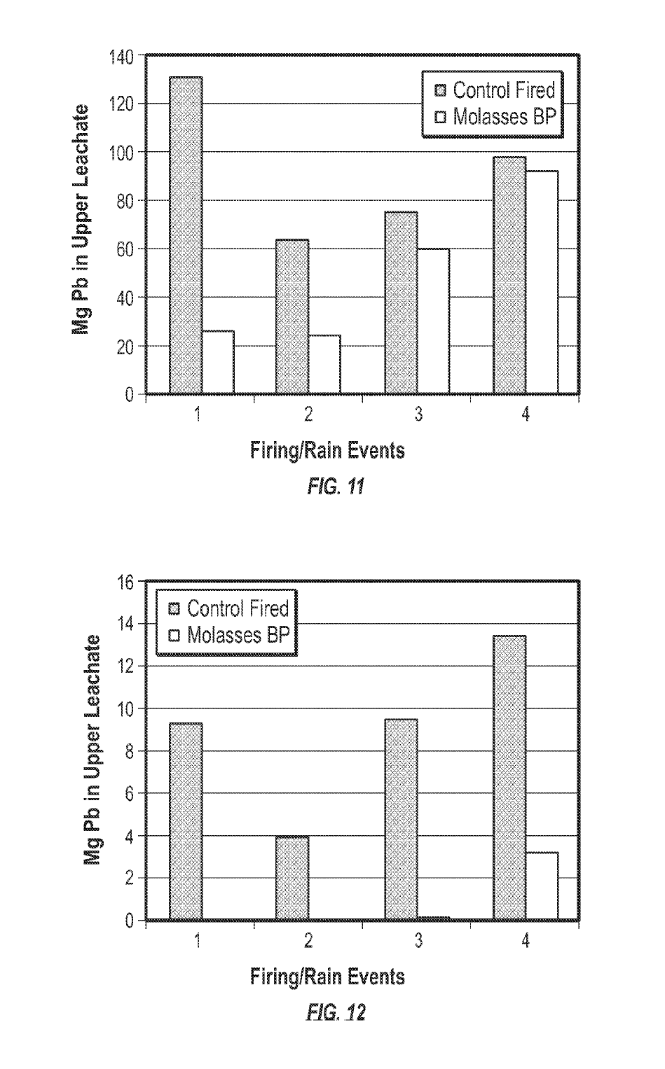

The mass of total lead (Pb) detected in the lower leachate and runoff water from control (untreated) and biopolymer-amended soil after one year of simulated weathering is shown in FIG. 11 and FIG. 12. More specifically, FIG. 11 illustrates the mass of total lead (Pb) detected in the lower leachate and runoff water from control (untreated) and biopolymer-amended soil after one year of simulated weathering. In FIG. 11, the values for dissolved lead were either below or close to the method detection limits for both treated and untreated soil. FIG. 12 illustrates the mass of total lead (Pb) detected in the upper leachate and runoff water from control (untreated) and biopolymer-amended soil after one year of simulated weathering. In FIG. 12, the values for dissolved lead were either below or close to the method detection limits for both treated and untreated soil.

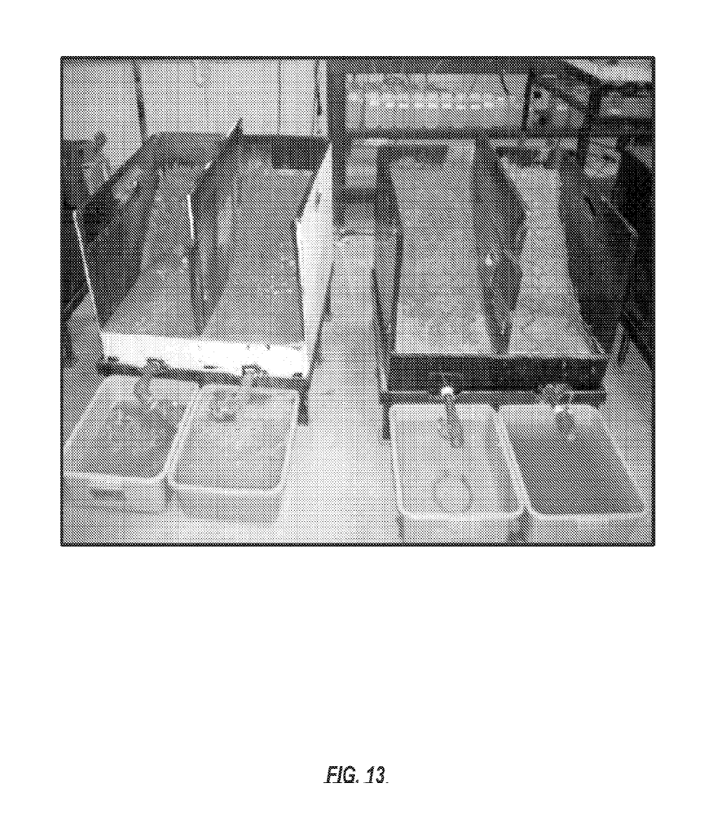

The values for dissolved lead were either below or close to the method detection limits for both treated and untreated soil. The mass of total lead (Pb) detected in the upper leachate and runoff water from control (untreated) and biopolymer-amended soil after one year of simulated weathering is shown in FIGS. 12 and 13. The values for dissolved lead were either below or close to the method detection limits for both treated and untreated soil.

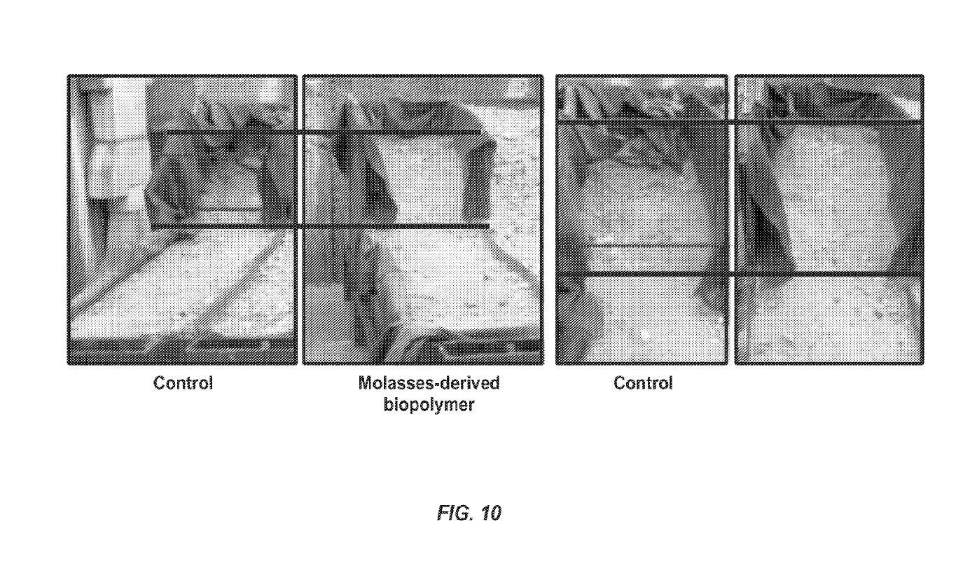

FIG. 10 illustrates the change in slope angle during weathering of the berm and the development of the “slump” on the berm as soil moves towards the berm toe.

Leachate was collected from both the upper and lower lysimeter collection systems of the LFL. Soil/amendment contact time was much greater for leachate collected at the foot of the toe area (lower leachate).

The concentration of total lead in the lower and upper leachate from the control and molasses-derived biopolymer-amended soil is shown in FIGS. 12 and 13, respectively. The molasses-based biopolymer was significantly better at immobilizing lead and also more consistent in its performance than either the corn syrup or sorghum-derived biopolymers. More specifically, the mass of dissolved Pb in the upper and lower leachate from the fired control and the biopolymer-amended soils is shown in Table 5. The mass of dissolved Pb was lowest in both the upper and lower leachate when the soil was amended with the molasses-derived biopolymer. The mass of dissolved lead in the upper and lower leachate from the control (fired) soil and biopolymer-amended lysimeters following 4 rain events (equivalent 4 months weathering).

TABLE 5

Mass of Dissolved Pb (mg)

| Soil treatment | Upper Leachate | Lower Leachate |
|---|---|---|
| Control (fired) | 0.03 | 6.91 |
| Sorghum RTBP | 0.97 | 23.33 |
| Molasses RTBP | 0.19 | 4.09 |
| Corn syrup RTBP | 1.34 | 19.65 |

### Experiment 4: Bermed Small Arms Firing Ranges

The ability to manage military installations in a sustainable, yet environmentally sound, manner that maximizes the time available for training and testing is a critical aspect of maintaining a fully operational and well trained fighting force. Eliminating off-site migration of heavy metals, reducing sediment transport off-range and reducing the impact of erosion on the range berm slopes are an integral part of managing small arms firing ranges (SAFRs) facilities. From the standpoint of field operations personnel, the ability to provide non-eroding soils for operational areas is a critical aspect of the modern and effective fighting force.

Studies at over 20 small arms firing ranges have shown that the vast majority of lead leaving bermed SAFRs is present as suspended solids in surface water runoff. The methods currently used to reduce migration of suspended solids are the placement of geotextiles or vegetated areas for erosion control. The selection and use of plants for erosion control in areas with elevated lead, copper and zinc requires an understanding of which species are tolerant of these metals as well as which species will not hyperaccumulate toxic metals. Accumulation of heavy metals in stems and leaves should be avoided in order to decrease the potential for trophic transfer of the metal or migration of the metal off-site with plant detritus. However, plants cannot survive in areas receiving direct small arms fire. Geotextiles and other fire retardant materials also cannot be used in areas that receive direct fire; once the integrity of the fabric is destroyed it no longer functions as designed and for the risk of fire.

### Experiment 4: Materials and Methods

Erosion and sediment transport were evaluated for both slope stability and surface soil durability. Two treatability studies were designed to evaluate erosion control through biopolymer amendment. Simulated laboratory berms were constructed to evaluate erosion at the angle of repose characteristic on earthen berms and were used to empirically measure soil loss mass. A Silty Sand (SM), and a Silt (S) soil type were treated at dosing rates of 0%, 0.2%, and 0.5% biopolymer (w:w) and compared to an untreated control of the same soil type.

In addition, mesoscale rainfall lysimeters were used to evaluate the ability of the biopolymer to reduce soil erosion and the transport of sediment in both surface runoff water and leachate.

Two soil types were examined at three biopolymer loading rates; 0%, (control), 0.2% w:w, and 0.5% w:w. The soil types were Silty Sand (SM), and Silt (S) (Table 6).

TABLE 6

| | | | | Gravel | Sand | Fines |
|---|---|---|---|---|---|---|
| Soil type | LL | PL | PI | (%) | (%) | (%) |
| Silty Sand (SM) | NP | NP | NP | 0.5 | 77.2 | 22.3 |
| Silt (S) | 27 | 23 | 4 | 0 | 1.1 | 98.9 |

LL—liquid limit
PL—plastic limit
PI—plastic index
NP—non-plastic

Slope stability boxes were constructed from 1.905-cm thick, high-density polyethylene. Each box measured 0.7874 m by 0.7874 m by 0.6096 m (inside length*width*height). Leachate and sediment flowing with the water, were collected in polyethylene pans. FIG. 13 illustrates slope stability boxes-unamended control cells on left, 0.2% biopolymer cells on right. In FIG. 13, the clarity of the leachate water from the biopolymer-amended soils on the right. The soil types from left to right are: Silty Sand control, Silt control, Silty Sand 02% BP, Silt 0.2% BP.

Soil from Aberdeen Proving Ground (APG) was evaluated in a standard rain lysimeter (FIG. 6) with 0.2% biopolymer (w:w) and compared to its untreated control after each rainfall event. APG soil is classified as a Silty Clay (CL).

A delivery system for the artificial rain is used with the lysimeters to simulate yearly rainfall and weathering. The lysimeters were designed to allow for the collection of leachate percolating through the soil as well as runoff from the soil surface. A simulated weathering time of approximately 2.5 years was evaluated based on average Southeast rainfall of 47-51 inches per year.

For the slope stability study, a rainfall event was conducted weekly over each slope stability box and the leachate and runoff water were collected. To evaluate soil movement and erosion potential, the slope angle of each simulated berm was measured spatially each week. Specifically, the increase in the amount of soil deposited in the range floor area of the slope stability box constituting lost soil mass in the simulated berm was recorded.

Using mesoscale laboratory rainfall lysimeters, total suspended solids (TSS) and turbidity in the leachate and runoff water were measured for APG soil amended with 0.2% biopolymer (w:w) and compared to its untreated control after each rainfall event. A Hach DR/200 spectrophotometer was used to analyze samples for TSS and turbidity. The samples were read at 810 nm for suspended solids, and at 450 nm for turbidity.

### Experiment 4: Results

FIG. 14 illustrates the increase in slope stability with increasing loading rates of biopolymer. The stability was measured by the increase in the mass of soil in the toe area of the stability box and the change in angle (breakpoint) of the berm slope (slump). An indication of decreased slope stability is when more sediment falls below the break point on the berm face and, as indicated in FIG. 14, the break point moves up the berm face.

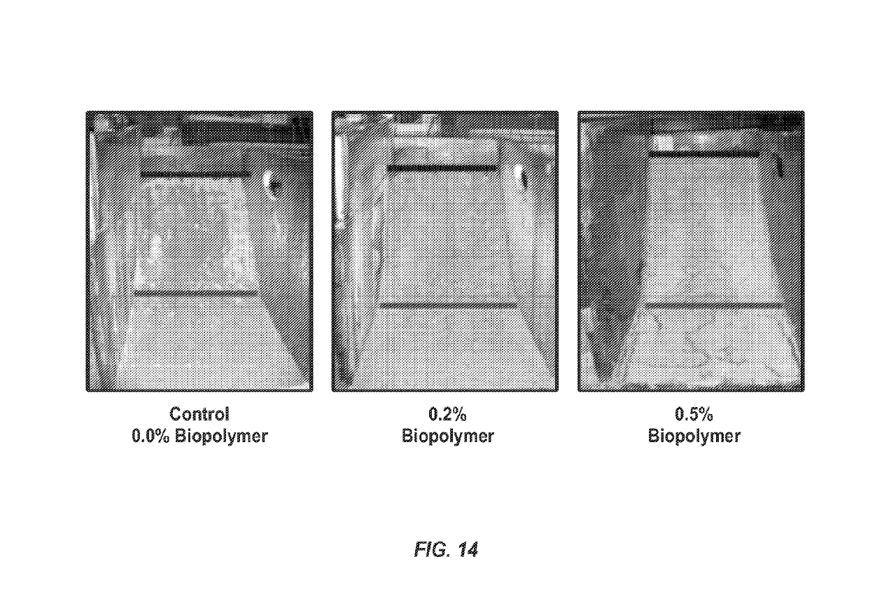

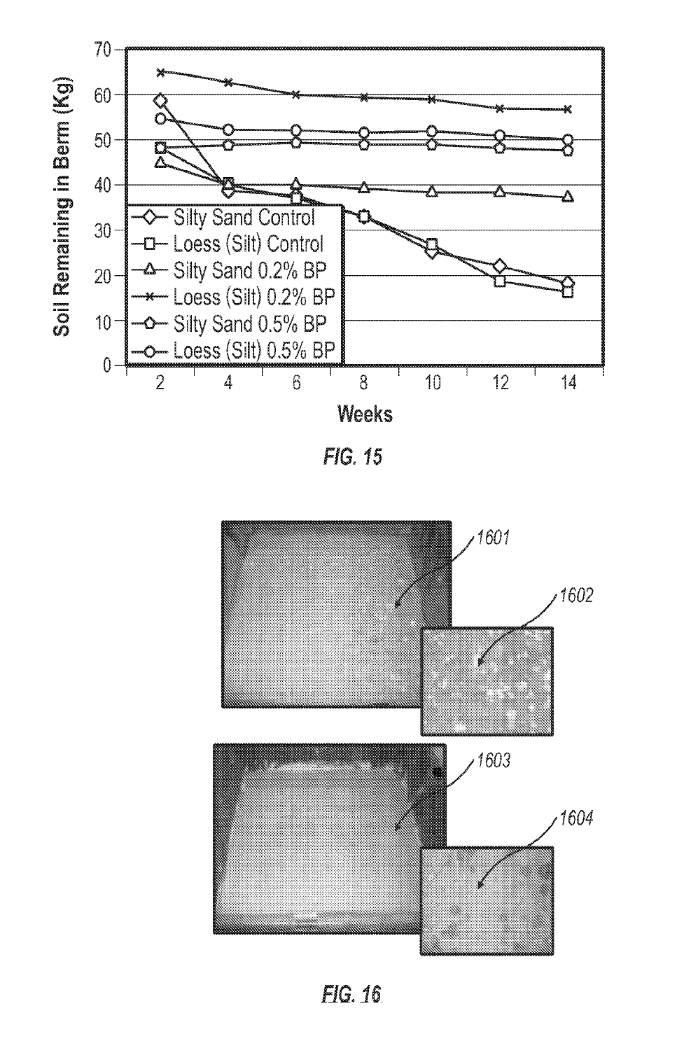

Following a series of rain events equivalent to one year rainfall, untreated Silty Sand soil had lost 40.0 kg of soil mass (69% of the total soil mass). Untreated Silt soil lost 32.0 kg, 66% of the total mass. In contrast, the same soils when treated with 0.2% biopolymer (w:w), lost 8.0 kg (approximately 17% of the total mass, silty sand) and 1.0 kg (approximately 1% of the total mass, Silt soil). The mass lost from each “berm” is shown in FIG. 15 for each soil type and each biopolymer loading rate. The untreated soils each lost the greatest soil mass, followed by the Silty Sand treated with 0.2% biopolymer (w:w). The Silt soil treated with either 0.2% or 0.5% biopolymer (w:w) and the Silty Sand treated with 0.5% biopolymer (w:w) each maintained a stable mass throughout a year of simulated weathering.

The biopolymer-treated soil continued to demonstrate surface durability and resistance to erosion after 20 rain events, the equivalent of more than 2.5 years of weathering. This is visible from examination of the soil surface, where the sub-surface gravel was exposed by weathering in the untreated soil. FIG. 16 is a photograph of the surface durability and resistance to erosion of biopolymer amended soil over the untreated control. Untreated soil 1601 and biopolymer treated soil 1603 were exposed surface water runoff. More specifically, untreated soil 1601 and biopolymer treated soil 1603 were exposed to 19 rain events that were the equivalent of over 2.5 years of rainfall. As can be seen by comparing enlarged view 1602 of untreated soil 1601 and enlarged view 1604 of biopolymer treated soil 1603, the biopolymer treated soil 1603 exhibited a greater resistance to erosion.

Sediment loads were measured in runoff water and leachate from treated and untreated APG soils. FIG. 17 is a chart providing a comparison of TSS in leachate and runoff water from control and biopolymer-amended APG soil (Silty Clay). Biopolymer amendment resulted in a 78% decrease in TSS in the runoff water. The reduction in TSS in the leachates was approximately 50%.

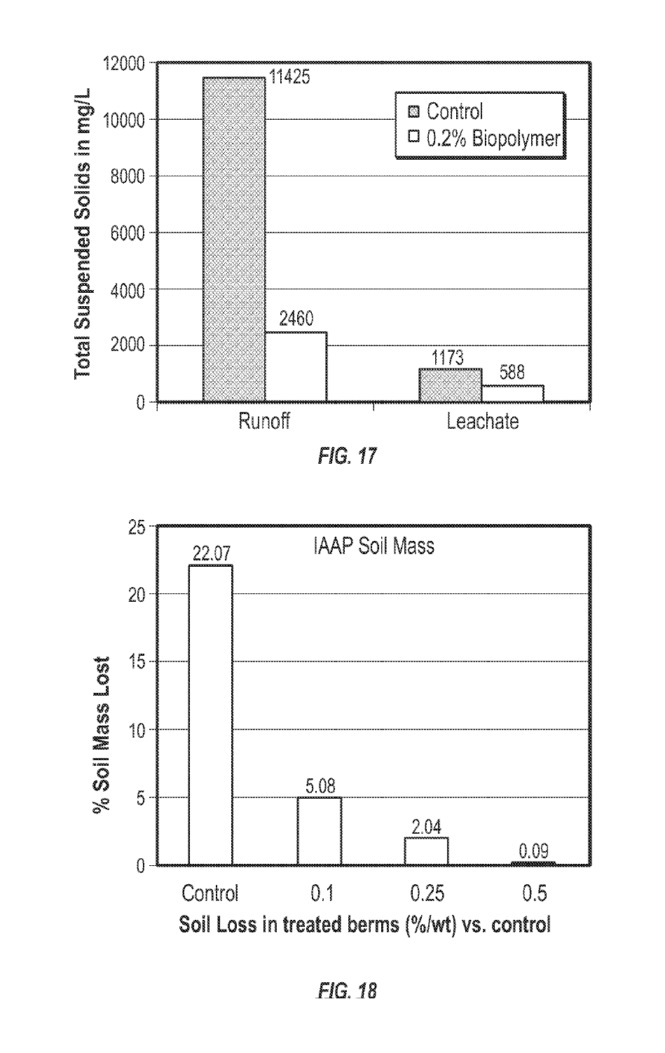

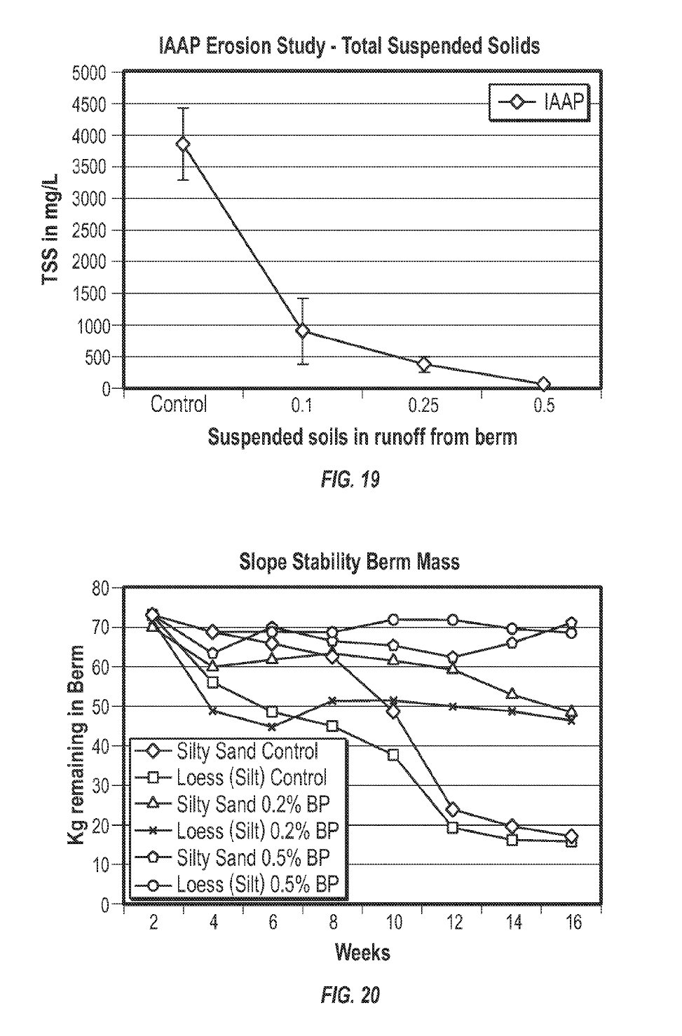

FIG. 18 demonstrates soil loss in untreated berms as a percentage of weight versus untreated controls. In FIG. 18, IAAP is soil at the Iowa Army Ammunition Plant. FIG. 19 demonstrates the total suspended solids (TSS) in control berms versus biopolymer treated berms. FIG. 20 demonstrates the weight remaining in berms of different soils which were untreated or treated with biopolymers as a function of time. FIG. 21 illustrates the reduction in sediment loss as measured by total suspended solids in runoff and leachate of a berm with a simulated weathering time of 2.5 years. Rainfall is based on an average Southeast United States rainfall of 47-51 inches per year.

When the biopolymer is added to the soil and wetted, either by rainfall or normal soil moisture, the soil acts as a buffer, neutralizing the ionic character of the biopolymer salt. The biopolymer can then begin reacting with itself and the constituents of the soil matrix. The reactive, cross-linked biopolymer has a larger molecular weight and a reduced water affinity. It links together the individual soil particles within the biopolymer matrix. The individual soil particles of the amended soil have greatly reduced mobility, significantly reduced hydraulic conductivity, and compressive strength equal to that produced by synthetic polymer amendments. This change in the physical form of the soil, on a particle level, results in increased soil strength and decreased soil erosion. The study of sediment transport demonstrated that the biopolymer soil amendment was able to significantly reduce surface water erosion and particulate transport in leachate.

### Experiment 5: Reduction in Fugitive Dust on Ranges

The National Ambient Air Quality Standards (NAAQS) are standards established by the United States Environmental Protection Agency (USEPA) under authority of the Clean Air Act (42 U.S.C. 7401 et seq.) that apply for outdoor air throughout the country. The Clean Air Act was passed in 1963 and significantly amended in 1970 and 1990. Primary standards are designed to protect human health, with an adequate margin of safety, including sensitive populations such as children, the elderly, and individuals suffering from respiratory disease. Secondary standards are designed to protect public welfare from any known or anticipated adverse effects of a pollutant (e.g. building facades, visibility, crops, and domestic animals).

NAAQS requires the EPA to set standards on six criteria air contaminants: 1) ozone (O₃); 2) particulate Matter (PM10, coarse particles: 2.5 micrometers (μm) to 10 μm in size and PM2.5, fine particles: 2.5 μm in size or less); 3) carbon monoxide (CO); 4) sulfur dioxide (SO₂); 5) nitrogen oxides (NOₓ) and 6) lead (Pb). The standards are listed in Title 40 of the Code of Federal Regulations and shown in Table 7.

TABLE 7

| Pollutant | Type | Standard | Averaging time |
|---|---|---|---|
| PM10 | Primary and secondary | 150 μg/m³ | 24-hr^{a} |
| PM2.5 | Primary and secondary | 35 μg/m³ | 24-hr^{b} |
| PM2.5 | Primary and secondary | 15 μg/m³ | annual^{c} |

^{a}40 CFR 50.6
^{b}40 CFR 50.7
^{c}40 CFR 50.7

The ability to manage military installations in a sustainable, yet environmentally sound, manner that maximizes the time available for training and testing is a critical aspect of maintaining a fully operational and well trained fighting force. Controlling the generation of dust around military installations has been a concern for the Corps of Engineers since 1946. Controlling dust on military operational areas involve unique challenges. The Army requires an effective, efficient means of suppressing dust on airfields, helipads, cantonment areas, roads, and tank trails where the presence of dust was detrimental to military operations. When helicopters operate in dusty environments, their rotary blades and engines must be replaced after only one-third to one-half of their normal life due to the erosion of surfaces caused by airborne soil particles. Dust clouds around military installations from vehicular maneuvers provide the enemy with easily recognizable signatures of strategic operations and impair visibility of both airborne and ground personnel. The dust itself is a safety hazard for ground troops and, when mixed with particulate heavy metals from range ordnance, becomes an additional hazard.

### Experiment 5: Materials and Methods

The soil used in the treatability study was classified as a Silty Sand (SM), non-plastic, composed of 0.5% gravel, 77.2% sand, and 22.3% fines. Dust suppression was measured at three biopolymer loading rates, 0.1%, 0.2% and 0.5% (w:w) and an untreated control (distilled water). The testing protocol was developed by Rushing, J. F. and Newman, J. K. 2010. Investigation of laboratory procedure for evaluating chemical dust palliative performance. Journal of Materials in Civil Engineering, 22(11), DOI: 10.1061/(ASCE)MT.1943-5533.0000122, which is hereby incorporated by reference in its entirety.

### Experiment 5: Results

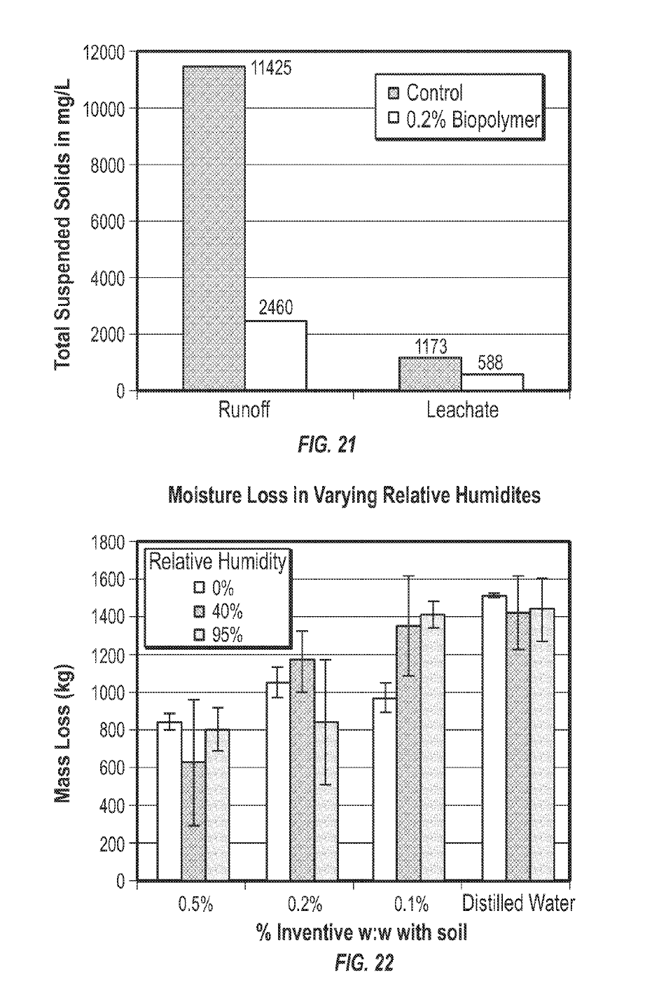

The mass loss from treated and untreated Silty Sand soil by biopolymer dose and relative humidity is shown in FIG. 22, which illustrates that biopolymer added to the soil at 0.5%/wt loading rate reduced dust production compared to the control at all relative humidities indicating that performance on both tropical and arid environments.

Within the replicate studies, there does not appear to be a statistically significant variation in dust production using the Rushing/Newman dust measurement system for varied relative humidities. Biopolymer added to the soil at 0.5% (w:w) loading rate reduced dust production compared to the control at all relative humidities, indicating it should perform well in both arid and tropical environments. A mass loading of 0.5% represents a range of application rates per acre for acre depending on the depth of soil treated. Table 8 below lists the mass of biopolymer per acre required to achieve reduced fugitive dust from this soil type.

TABLE 8
RTBP mass required for 0.5% mass loading by depth

| Treatment Depth (inches) | g RTBP/yd\hat{ }2 | kg RTBP/acre |
|---|---|---|
| 1 | 140 | 17.5 |
| 2 | 280 | 35 |
| 3 | 420 | 52.5 |

Depending on the depth of soil treated, low masses of biopolymer amendment could be used to reduce dust emissions from large areas of soil. The natural, biogenic nature of the biopolymer is expected to greatly reduce environmental impact associated with the use of biopolymer as a dust control technology. Additionally the tendency of RTBP-amended soils to promote vegetative cover might be expected to further reduce mass loss at the periphery of dust producing areas where plants can survive and stabilize topsoil.

Biopolymer was added to a Silty Sand soil with a high concentration of fines and prone to erosion and dust problems. The highest soil loading rate tested, 0.5% biopolymer (w:w), reduced the soil mass lost by wind over the control at all relative humidity tested.

### Experiment 6: Soil Stabilization

Re-vegetation is another means to control soil erosion around the perimeter of a construction area. Disadvantages are time and labor, as well as water, required to establish effective vegetative buffer zones. Enhanced plant growth, decreased maintenance time and decreased water usage would not only improve surface water quality, they would also decrease construction costs.

Experiments to evaluate the soil stabilizing properties of the biopolymer during a rainstorm were performed using an innovative mesoscale rainfall laboratory lysimeter (FIGS. 6, 7). Referring to FIG. 6, a lysimeter 600 can include a tank 609 lined with a nonwoven geotextile fabric 601 and containing a plurality of layers 602, 603, and 604. Layer 602 can be 5 inches of soil. Layer 603 can be 4 inches of sand. Layer 604 can be 3 inches of pea gravel. The lysimeter 600 can have a rainfall runoff trough 605 disposed on one side. The rainfall runoff trough 605 can include a shutoff valve 606, which can direct rainfall runoff through a 1-inch internal diameter tubing 607 to a surface runoff collection container (not shown).

The laboratory lysimeters can be filled with soil and exposed to a variety of treatment options. They are also designed to collect surface water runoff after a simulated rain event. This paper will document the biopolymer's capability to reduce soil erosion and transport of suspended solids in surface water runoff, increase soil strength, and increase the rate of establishment of vegetative cover under simulated drought conditions.

### Experiment 6: Materials and Methods

The mesoscale rainfall soil lysimeters are constructed from 1.91 cm (¾-in) thick, high-density polyethylene and measure 78.7-cm×78.7-cm×60.7-cm (inside length×width×height, 31-in×31-in×24-in). Lysimeter construction and use has been described elsewhere (See FIGS. 6, 7). The lysimeters are designed to separate the leachate and runoff water samples following a weekly rain event. Each experiment delivers the equivalent of one year of rainfall (average from a temperate Northeastern, USA, site) divided equally over 16 weeks.

Two soil types were used in these studies. The first is a Silty Sand (SM) composed of 0.5% gravel, 77.2% sand, 22.3% fines. The pH is 5.7, the specific gravity was 2.68 and the soil was non-plastic. The second was a Silt soil type (S), made up of 0% gravel, 1.1% sand and 98.9% fines. The pH was 8.7, specific gravity was 2.73 and the plastic index was 4. Both of these soil types are known to be prone to erosion.

The dry biopolymer salt was added to the Silty Sand soil at loading rates from 0% to 0.5% by mass and placed in the lysimeters. Runoff water was collected weekly, the volume measured, and each sample was analyzed for total suspended solids (TSS) and turbidity. TSS was determined using ASTM Method 2540B. Turbidity was measured by nephelometer.

Changes in slope stability were studied for a rainfall equivalent of 15 months using lysimeters that collected only the runoff water. Each lysimeter held 168.8 kg of soil. Two soil types were used, Silty Sand and Silt, each treated with 0%, 0.2%, or 0.5% of biopolymer by mass. Following each rain event, the runoff water was collected and analyzed for TSS and measurements to determine the mass of soil lost.

A different Silty Sand blend was tested for soil strength. This soil is a SM (sand-silt) (United States Geological Survey [USGS] Classification) comprised of 87% concrete sand and 13% silt. This soil was chosen due its weak strength when wet and high strength when dry. The test protocol is simple unconfined compressive stress in which the peak load response (yield stress) of a specimen is measured while subjected to a constant strain rate. Small, 1 inch by 2 inch, samples were prepared at densities ranging from 128-135 lbs/ft3 and subjected to a constant strain rate of 0.033 inch/min. Both wet and dry testing was performed. In the wet state, samples were prepared at 8% moisture content and tested immediately after removal from the molds. In the dry state, samples were prepared in the same manner but placed in an oven at 105° C. until constant weight was achieved and allowed to cool under ambient conditions for one hour before testing.

### Experiment 6: Results

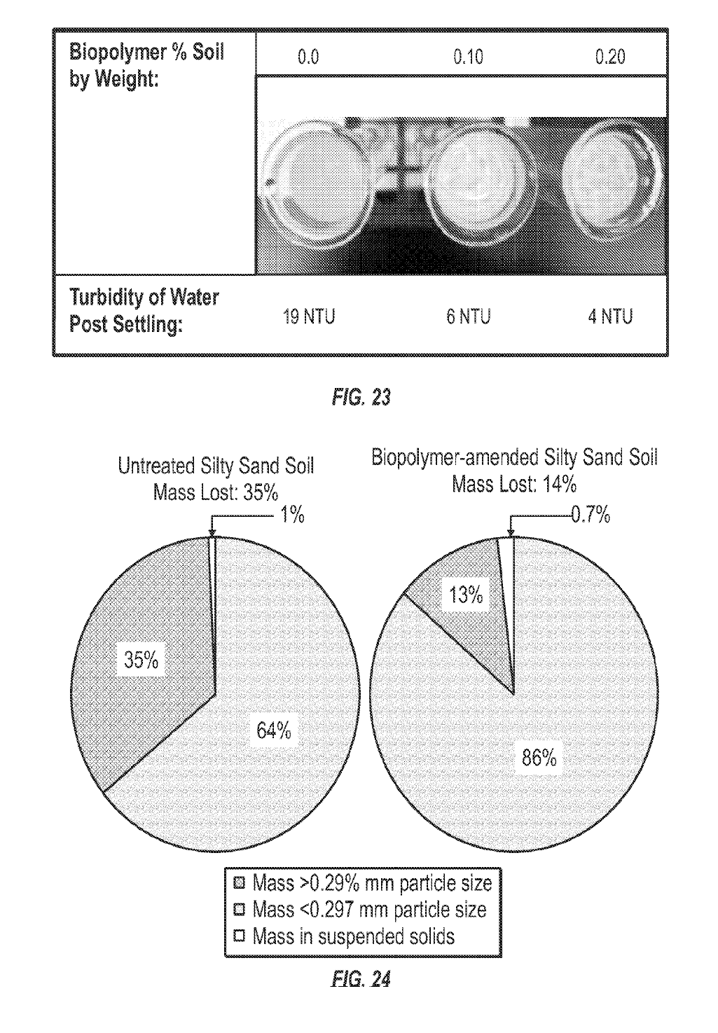

FIG. 23 compares the appearance of surface water runoff obtained from the rainfall lysimeters when the soil was treated with increasing loading rates of biopolymer. Higher loading rates demonstrate decreased turbidity. As shown in FIG. 23, turbidity, post-settling, was found to decrease with increasing mass loading of the biopolymer.

The surface of the soil in the lysimeters also showed the effects of erosion by a simulated years' rainfall. The surface of the untreated soil was washed away exposing the underlying gravel. The surface of the biopolymer-amended soil was intact.

The mass lost from the soil through surface water erosion is compared for the biopolymer-treated and untreated soils. FIG. 24 provides two charts comparing soil mass retained on a #50 sieve (particles larger than 0.297 mm) for biopolymer-treated and untreated soil. The treated soil (right) demonstrates an increased soil mass being retained on a #50 sieve (particles>0.297 mm) and, therefore, not being transported by surface water runoff. In addition, the mass of soil with a particle size<0.297 mm increased in the untreated soil, as did the mass of suspended solids.

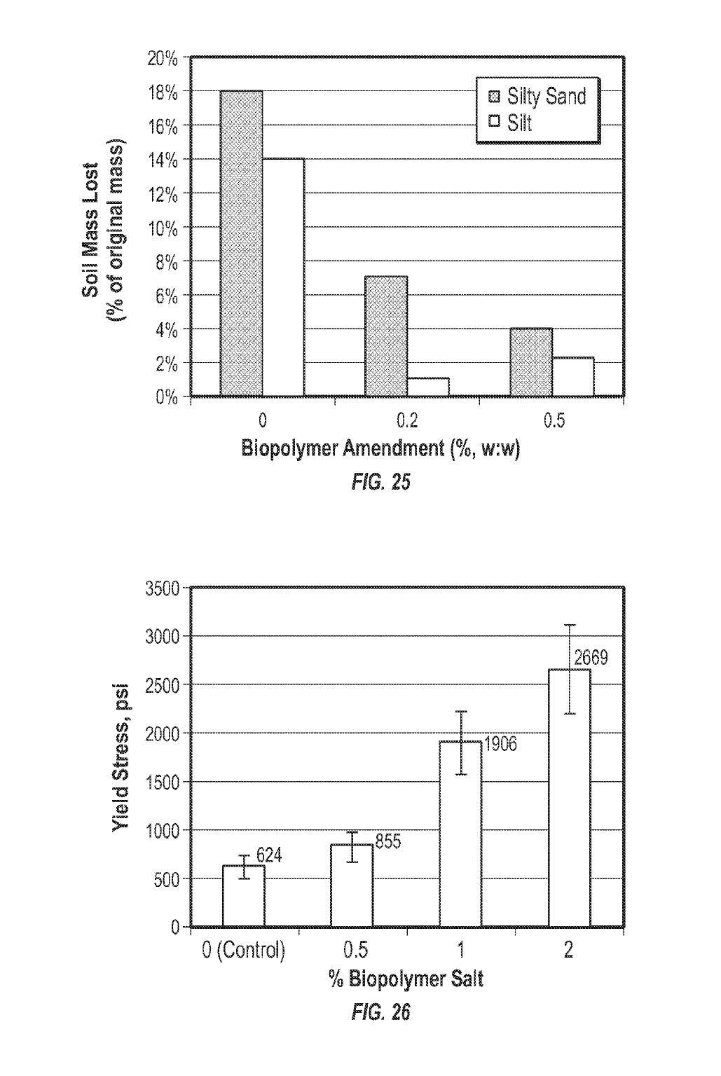

Erosion is also a function of slope stability. Lysimeters containing Silty Sand soil and Silt soil treated with biopolymer were studied following simulated rain events for an equivalent year for degradation of the front slope and soil mass lost in runoff water. FIG. 25 is a chart showing a slope stability soil mass lost over 6 weekly rain events (equivalent 3.5 months from two soil types with varying biopolymer loading rates. Calculations are based on an initial soil mass for all treatments of 168.8 kg.

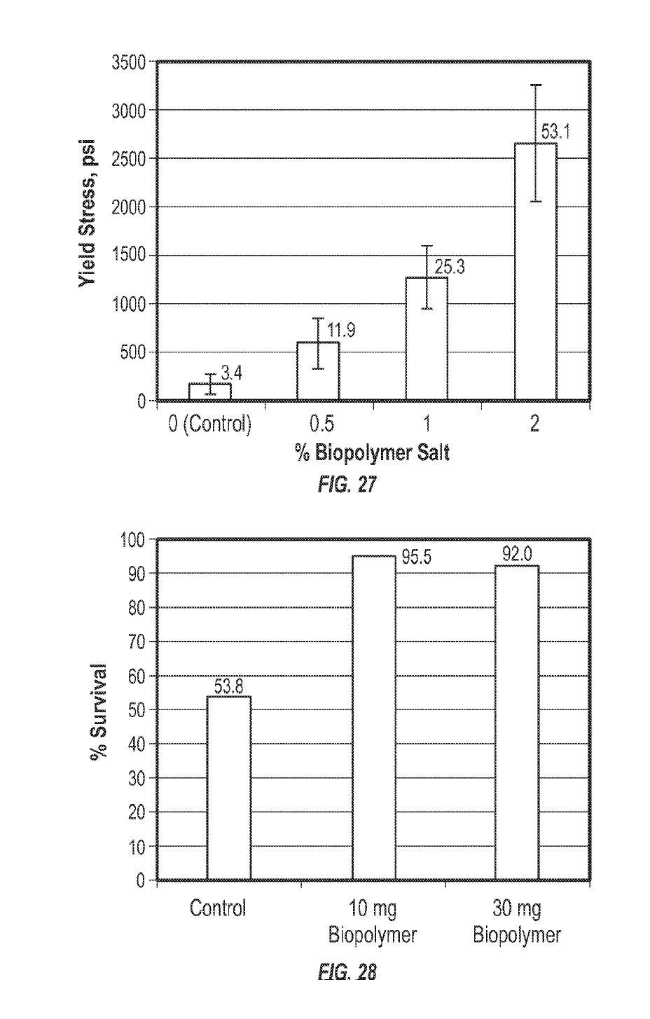

In FIG. 26, the strength of the dry SM soil with 0.5, 1, and 2% EPS biopolymer salt is compared to an unmodified control at 0% moisture content. The soil exhibits substantial strength in the dry state which is enhanced by the biopolymer at loadings of 1 and 2%. In the wet state (FIG. 27), the soil strength is very low, typical of silty sands with high sand fractions. The addition of the biopolymer increases the strength of the soil in the wet state and is consistent with the data trend observed in the slope stability mass loss.

The natural capacities of the R. tropici EPS include holding soil moisture and nutrients, increasing the organic matter in the soil, and self-adhesion. Addition of the R. tropici biopolymer to silty and sandy silt soil increases soil strength and decreases the loss of soil fines by water erosion. These changes both result in a decrease in soil loss from disturbed soils.

### Experiment 7: RTBP Salt to Increase Seed Germination Rate Under Drought Conditions

Drought not only affects more people in the United States than any other natural hazard, it is also one of the most costly and difficult problems to deal with. This is due to the nature of drought itself. It is a slow onset phenomenon where the severity is determined using multiple metrics. Unlike a tornado or hurricane, for instance, the impact of drought is non-structural and can be very widespread, crossing state and country boundaries, which makes assessment and mitigation efforts more difficult. The R. tropici biopolymer salt, when used to coat seeds, resulted in increased germination rates with decreased water application. In addition, when the seedlings were challenged by an artificial drought, the plants grown from the biopolymer-coated seeds were significantly more resistant to the drought conditions than the uncoated seeds.

### Experiment 7: Materials and Methods

The RTBP was used to coat seeds using either one coating (10 mg of biopolymer) or three coatings (30 mg) of biopolymer with drying time between each coating. The controls were uncoated seeds. Seeds were grown in identical individual soil pots according to methods described in ASTM Method E-1963-09 for seed germination studies. The pots were each watered after the seed was planted using 20-ml water per day per plant. The germination rates were calculated for each test condition (control, 10 mg, 30 mg). After three weeks of watered growth, watering was curtailed for 6 days, producing simulated drought conditions. All plants were then watered and recovery (defined as water entry into stems and leaves producing a less desiccated appearance and lifting the stem and leaves from the soil surface) was recorded for all test subjects.

Moisture retention was measured by augmenting soil samples with varying concentrations of the biopolymer. The initial dry mass of the soil was measured. Water amended with the biopolymer was added to each soil sample and weighed again. The biopolymer augmented waters were made by adding a known amount of biopolymer to a known amount of water. Approximately 10 mL of water were added to each soil sample. The samples were then stored at room temperature and allowed to evaporate over a given period of time. Throughout the drying period, samples were measured for their respective masses.

Established plants were transplanted into a simulated garden. Biopolymer was added in various concentrations to the plants and allowed to grow until fruit was produced. A simulated drought (no watering for a period of days) was performed. The plants were then re-watered and allowed to return to maximum growth. Fruit produced by the plants was then weighed.

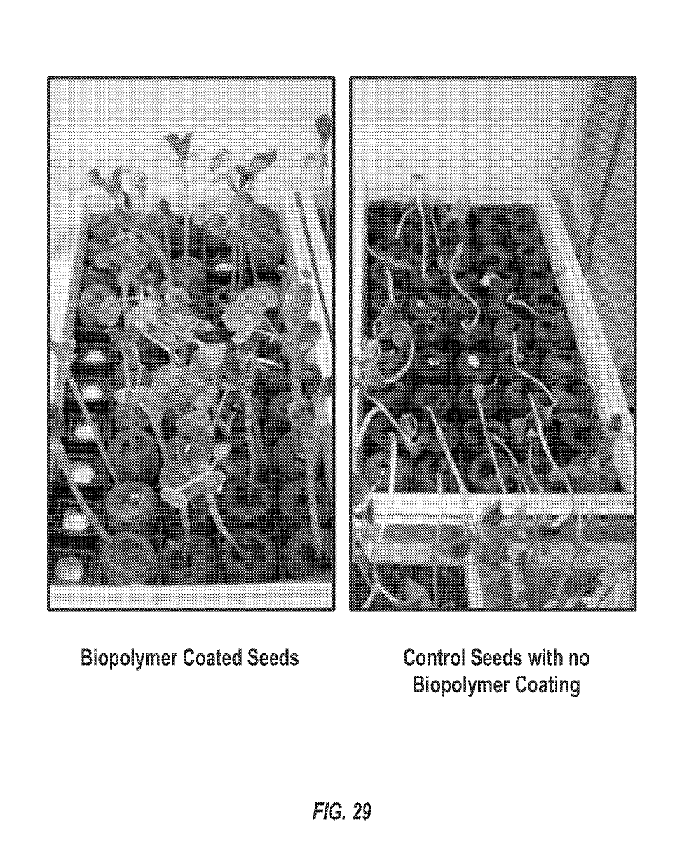

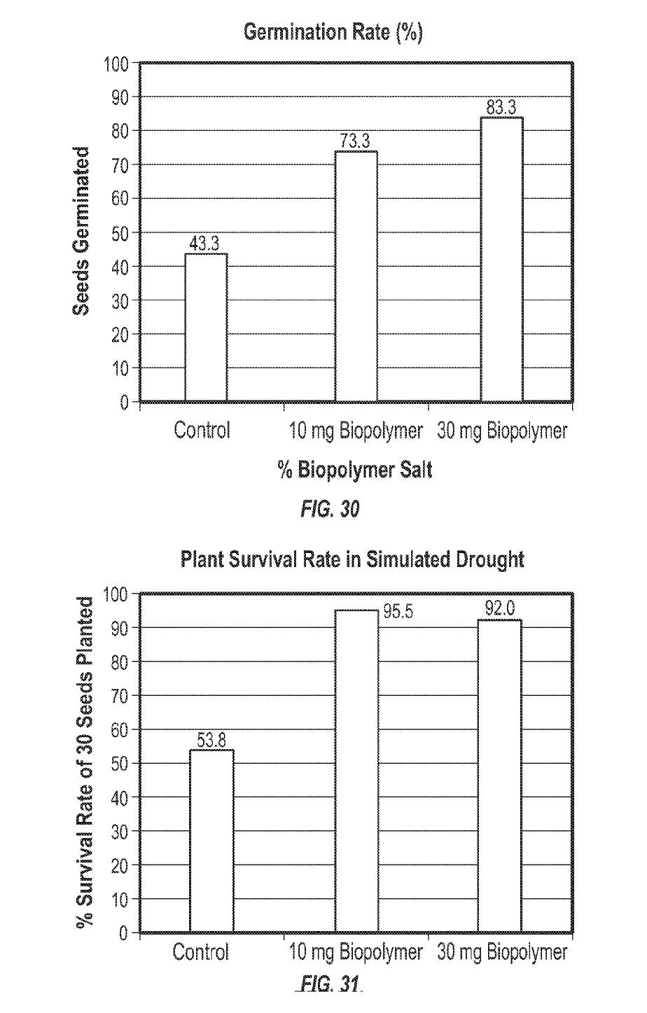

Seed germination pot studies were performed using ASTM Method E-1963-09. FIG. 29 is a series of photographs showing plants grown from biopolymer (left) and uncoated (right) under drought conditions; FIGS. 30 and 31 compare the rate of germination, and plant recovery after a simulated drought, of the biopolymer-coated and uncoated seeds as well as the degree of coating (10 mg vs. 30 mg biopolymer). More specifically, FIG. 30 is a chart showing a comparison of germination rate (%) between seeds coated with biopolymer and uncoated seeds (control), showing the effect of biopolymer coating on seed germination rate and drought resistance (A is Germination Rate and B is Survivability); and FIG. 31 is a chart showing the presence of the biopolymer coating increased plant survivability by 42%, however survivability was not affected by the amount of biopolymer coating. FIGS. 30 and 31 demonstrate that germination rate was increased with the thicker coating of biopolymer. Both the 10-mg and the 30-mg treated seeds showed significantly higher germination rates that the untreated seeds (43% untreated vs. 73%/83% for treated seeds). The presence of the biopolymer coating increased plant survivability by 42%, however survivability was not affected by the amount of biopolymer coating.

FIG. 23 compares the total suspended solids (TSS) lost from the biopolymer-treated vs. the untreated (control) soil in the proof-of-concept demonstration using the mesoscale rainfall lysimeter system. The changes in appearance of the soil surface after rainfall are compared for a treated and an untreated soil.

FIG. 29 demonstrates that plants grown from RTBP-coated seeds had increased growth rate compared to control uncoated seeds. The improved germination (reduced dormancy) can reduce the amount of seeds required to be planted and allow for germination in adverse planting conditions such as elevated or depressed temperatures and water limited situations.

FIG. 30 compares the rate of germination, and plant recovery after a simulated drought, of the biopolymer-coated and uncoated seeds as well as the degree of coating (10 mg vs. 30 mg biopolymer). Germination rate was increased with the thicker coating of biopolymer. Both the 10-mg and the 30-mg treated seeds showed significantly higher germination rates that the untreated seeds (43% untreated vs. 73%/83% for treated seeds). The presence of the biopolymer coating increased plant survivability by 42%, however survivability was not affected by the amount of biopolymer coating. FIG. 28 is a chart showing a plant survival rate of biopolymer coated and uncoated under simulated drought conditions.

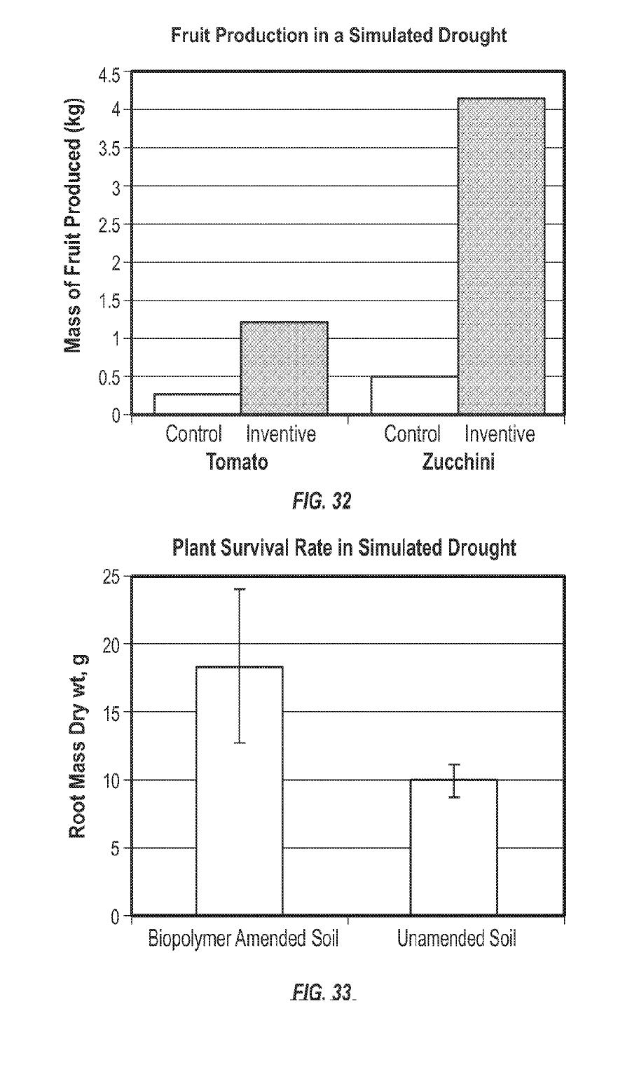

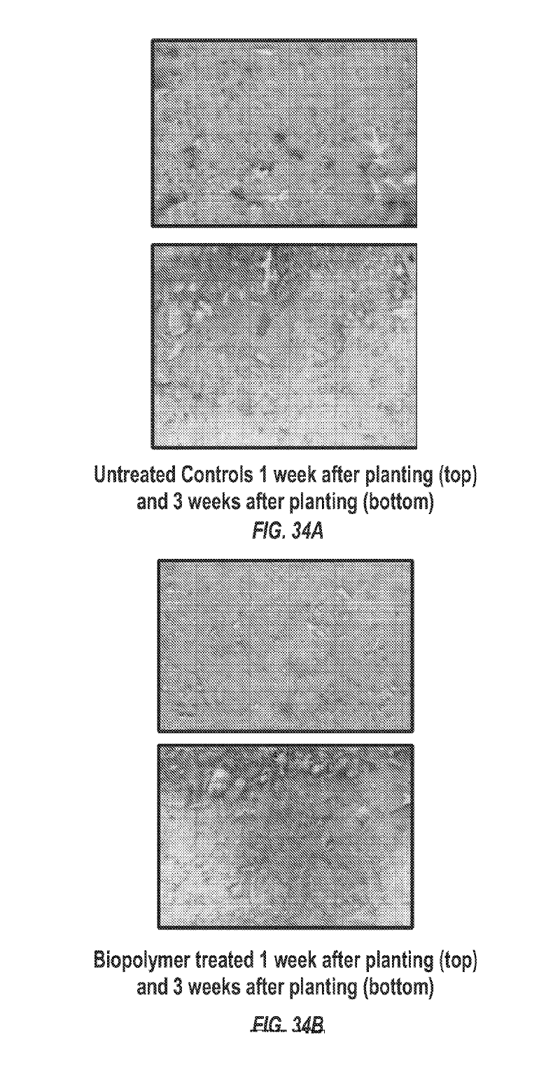

FIG. 32 is a graph showing that once the plants had reached maturity and were producing fruit, they were deprived of water for 1.5 weeks. After this simulated drought the plants were again re-watered on a routine basis until fruit production ceases. FIG. 32 demonstrates that crop yields are dramatically increased in drought conditions with the use of a biopolymer treated soil. Further higher water content results in greater effectiveness of crop yield. Root mass of plants by weight is also increased in biopolymer amended soil over an un-amended control as demonstrated in FIG. 33.

The ability to produce a seed that maintains its own water source within itself for both improved germination rate and growth under drought conditions can: 1) increase crop production in marginal agricultural areas of the world; 2) increase reliability of crop production in more developed agricultural areas; 3) reduce the number of seeds needed to produce an equivalent crop yield using untreated seeds; 4) reduce desertification and 5) reduce water use in urban environments (lawn care, golf courses).

### Experiment 8: RTBP for Control of Soil Erosion on Agricultural Lands

Approximately 40% of the agricultural land in the world is seriously degraded by soil loss through erosion. This affects not only surface water quality, but also the nutritional status of the agricultural land itself. Low quality farmland results in a decrease in crop yield which, in turn, causes a rise in food prices and a decrease in the abundance of food crops. In a domino-type effect, farmers turn to chemical-based fertilizers to improve the agricultural land which causes an increase in nitrates and phosphates in the surface water, increased eutrophication of receiving waters and an overall decrease in surface water quality. The biopolymer salt, when mixed with soil, results in a decrease in surface erosion as measured by a decrease in suspended solids in surface water runoff.

### Experiment 8: Materials and Methods

RTBP salt, when mixed with the soil at low levels (0.05 to 5% by mass) modifies soil behavior such that when rain falls and/or surface water passes over the treated soil, the soil particles are bound in the biopolymer matrix and resist transport in the water. The RTEPS can be mixed via surface application as a solid or water/gel mixture. The amendment can be introduced at greater depths by soil mixing coupled with wet or dry application.

Studies were performed using mesoscale rainfall lysimeters filled with RTBP-treated and untreated soil.

### Experiment 8: Results

FIG. 23 compares the total suspended solids (TSS) lost from the biopolymer-treated vs. the untreated (control) soil in the proof-of-concept demonstration using the mesoscale rainfall lysimeter system. The changes in appearance of the soil surface after rainfall are compared for a treated and an untreated soil.

FIG. 34 depicts untreated control versus biopolymer treated vegetation growth at one week after planting and 3 weeks after planting. Experiments 9-16: Materials and methods

### Experiments 9-16: Biopolymer Synthesis

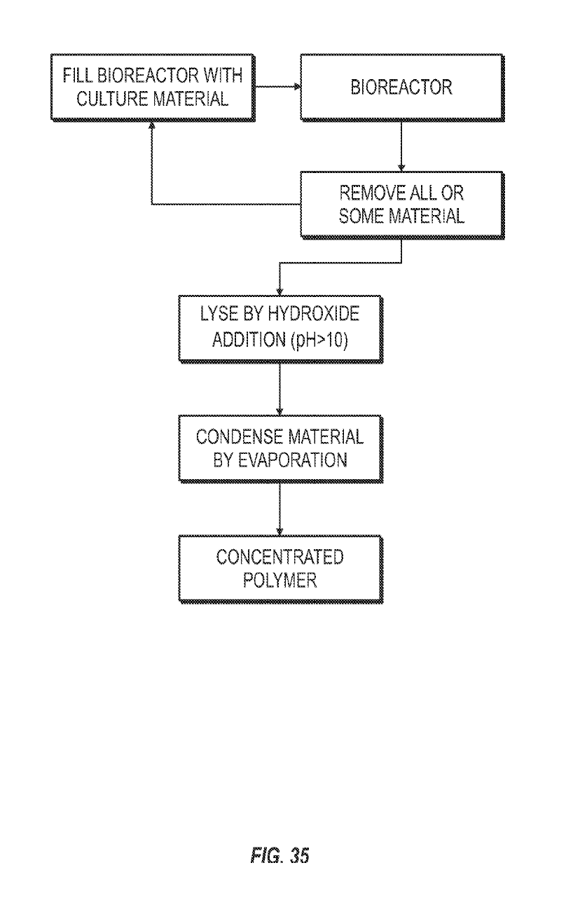

The biopolymer used was synthesized following a standardized production method and culturing of the R. tropici bacteria using a method modified from U.S. Pat. No. 7,824,569. Referring to FIG. 35 a schematic block diagram of a Biopolymer Synthesis Work Flow 3500 is shown. At box 3501 a bioreactor 3502 can be filled with a culture material. At box 3503 some or all of the material can be removed from the bioreactor 3502. Lysis can be induced by adding a hydroxide at box 3504. The pH at box 3504 can be greater than 10. Material recovered from box 3504 can be condensed by evaporation at box 3506 and a concentrated polymer can be recovered at box 3508.

For Experiments 9-16, R. tropici were cultured in small bioreactors (approximately 5 gallons [gal]) fitted with air diffuser systems attached to individual pumps providing air at a rate of 2.26 cubic feet per minute (CFM). The culture was composed of the bacteria and a proprietary broth mixture. Once a large enough quantity was achieved to split the cultures, the material was transferred into mesoscale bioreactors (approximately 55 gal) at approximately 10 CFM. From the mesoscale bioreactors, the bacteria were transferred at 25-55 CFM via peristaltic pumps to 3000 and 5000 gal bioreactor tanks for biopolymer synthesis. Large bioreactors were supplied with air from electric-powered ring compressors or positive displacement blowers. The larger bioreactors were also fitted with recirculating end-suction centrifugal pumps to maintain a consistent mixture.

R. tropici were grown in excess nutrient conditions. Cultures were increased in volume until the full reactor volume was achieved. Once a fully established and full volume culture was established, the bacteria were then nodulated through the introduction of Naringenin (4′,5,7-trihydroxyflavanone). (See: Poupot et al., Nodulation Factors from Rhizobium tropici Are Sulfated or Nonsulfated Chitopentasaccharides Containing an N-Methyl-N-acylglucosaminyl Terminus, Biochemistry, volume 32, 1993.) Once nodulated, the bacteria were supplied only sugar as all other nutrients were assumed to still be in excess. A non-crosslinking RTEPS was formed in situ by chemical addition of an alkaline salt, and the resulting biopolymer/bacteria mixture was harvested application and utilization.

### Experiments 9-16: Experimental

A series of agricultural experiments were conducted testing the effects of RTBP application on crop yields, root development, seed germination rates and drought resistance. A variety of plant species were tested: sweet jalapeno peppers, Roma tomatoes, zucchini, Romaine lettuce, soy beans, and Bermuda grass, as well as seeds from 8 different plant species. Field tests were performed across a diverse selection of agricultural regions in the United States.

### Experiment 9: Sweet Jalapeno Pepper Testing

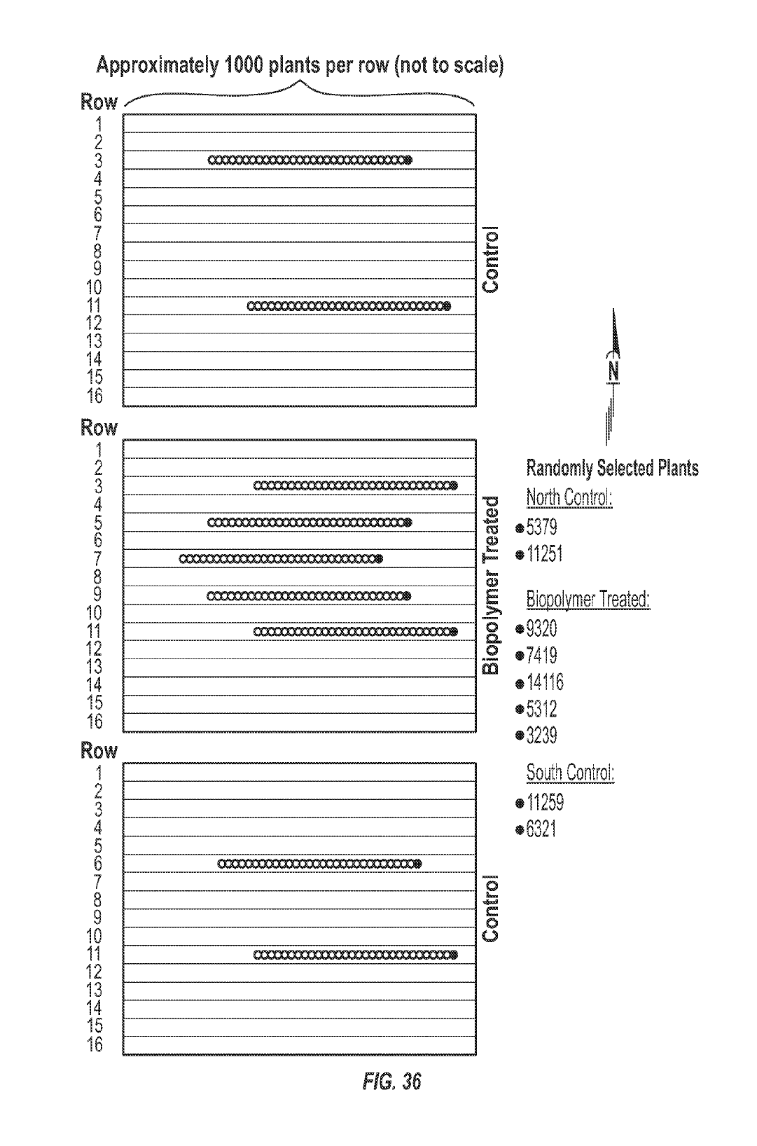

Testing on sweet jalapeno peppers was conducted in Maricopa, Ariz. All sweet jalapeno pepper plants were grown in a hot house from seed until the plants achieved a height of three inches. Upon reaching three inches, one acre's worth of peppers treated by dipping the root ball in a mixture of the biopolymer and fertilizer. Six gallons of biopolymer (approximately 125 g/acre) were added to 18 gallons of a fertilizer/water mixture, after which the hot house pepper starter plants were dipped and then planted in between two control acres. Control acres were dipped in a fertilizer mixture not containing the biopolymer. Plants in both the control and treated acres were watered through a subsurface drip irrigation system. A normal production cycle consisting of two harvests was performed. A plant count found that the plots averaged approximately 1025 plants per row and 16 rows per acre. Five numbers ranging from 1 to 16,000 were randomly generated for the treated acre, and two numbers ranging from 1 to 16,000 were randomly generated for each of the control acres. After fifteen weeks, green peppers of at least three inches in length were harvested from sets of 30 plants starting at the selected numbers, as shown in FIG. 36. More specifically, FIG. 36 shows schematic diagram of approximate locations of randomly selected plants in a sweet jalapeno pepper field test. After an additional four weeks, a second harvest was performed on the same plants in which all peppers over one inch in length were selected. Yields from each harvest were recorded and analyzed (see Table 10).

### Experiment 9: Sweet Jalapeno Pepper Results

The average numbers of plants per row was 1025. Each acre consisted of approximately sixteen rows of plants. The yield of control pepper test was 1042.6 lbs/acre. The treated acre had a yield of 1233.3 lbs/acre. Treating the peppers result in an 18.3% increase in production for the first harvest. The yield per acre was calculated using the average number of plants per acre and average yield per 30 plants. For example there was an average of 1696 plants/row in the northernmost acre with an average yield of 12.93 kg/30 plants.

Table 9 shows the average sweet jalapeno pepper plant count per row illustrated in FIG. 36, which provides the layout and location of the sweet jalapeno pepper test.

TABLE 9
Average Sweet Jalapeño Pepper Plant Count per Row.

| Plant Count Per Row | Control | Treated |
|---|---|---|
| Northernmost Acre* | 1696 | |
| Second North Acre | 994 | |
| Treated Acre | | 943 |
| Southernmost Acre | 1109 | |
| Second Southern Acre | 1056 | |

*The northernmost acre contained double planted rows

The pepper yield per 30 continuous plants was measured after the plants were selected by a random number generator. Table 10 reports the measurements obtained. As shown in Table 10, the percent increase in yield from treatment by the biopolymer was 18.3% for the first pepper harvest.

TABLE 10
First sweet chili pepper harvest-yield per 30 continuous plants
(selected by random number generator)

| | Yield Per 30 Plants | Average Yield | Yield Per Acre |
|---|---|---|---|
| | (kg) | (kg) | (lb) |
| North | 15.06* | 12.93 | 1042.6 |
| Control | 12.06 | | |
| South | 12.20 | | |
| Control | 12.38 | | |
| Treated | 16.50 | 15.29 | 1233.2 |
| | 14.82 | | |
| | 15.82 | | |
| | 16.24 | | |
| | 13.06 | | |

| | |
|---|---|
| Percent Increase Yield Per Acre | 18.30% |

*includes stems resulting in an increased weight-the other peppers were counted without stems

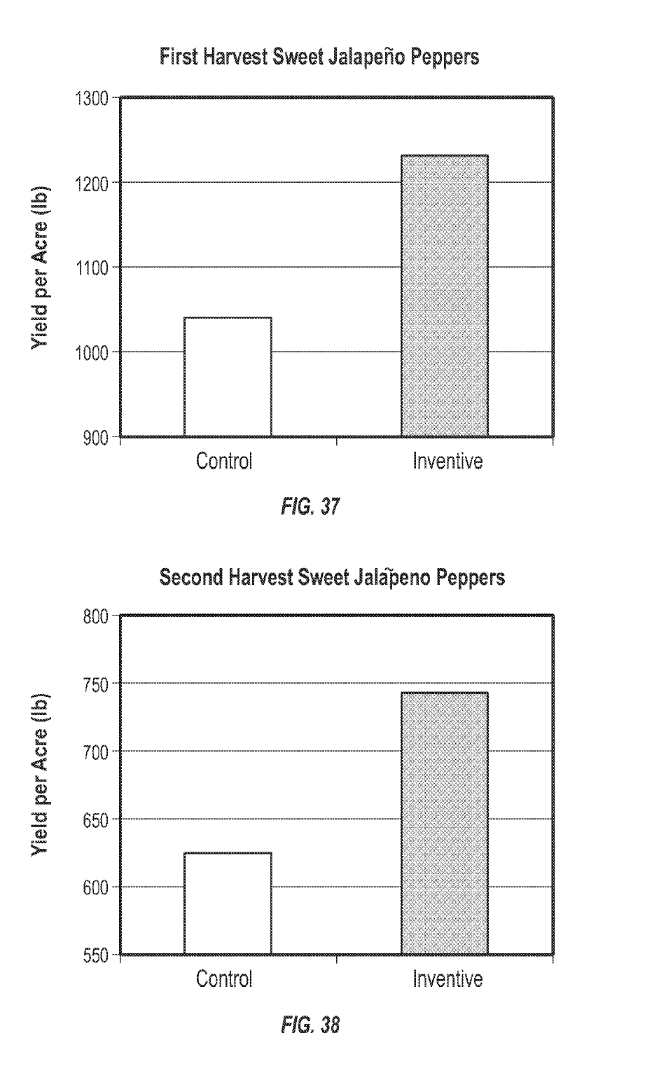

FIG. 37 is a chart showing the biopolymer treated sweet jalapeno peppers had a yield per acre of 1233.3 pounds while the control had a yield per acre of 1042.6 pounds, an 18.30% increase. The percent increase for the second harvest was 19.1% with 625.1 lbs/acre for the control and 744.3 lbs/acre for the treated.

Table 11 shows results of a second harvest of sweet jalapeno peppers. The average of thirty plants (selected by random number generator) was used to calculate the yield per acre calculated by using the average number of plants per acre for the field test. Increased yields of 19.1% were noted for the treated plants as compared to the control.

TABLE 11
Second harvest of sweet jalapeno peppers - measurements for
thirty plants (selected by random number generator)

| | Yield Per 30 Plants | Average Yield | Yield Per Acre |
|---|---|---|---|
| | (kg) | (kg) | (lb) |
| North | 7.26 | 7.75 | 625.17 |
| Control | 6.64 | | |
| South | 8.9 | | |
| Control | 8.2 | | |
| Treated | 11.26 | 9.23 | 744.28 |
| | 6.24 | | |
| | 11.38 | | |
| | 10.16 | | |
| | 10.14 | | |
| | 6.18 | | |

| | |
|---|---|
| Percent Increase Yield Per Acre | 19.1% |

FIG. 38 is a chart showing the second harvest of sweet jalapeno peppers resulted in a yield in the control of 625.1 lbs/acre and 744.3 lbs/acre for the biopolymer treated plants.

The root surface area, width, height, and wet root weight for sweet jalapeno pepper roots were collected by WinRhizo software and are reported in Table 12. There was a 33.5% increase in the total area of the sweet jalapeno pepper roots along with a 1.3% increase in the average width and a 9.0% in the height as compared to the sampled control plants. There was also a 33.3% increase in root wet weight and a 37.2% increase in yields obtained by treatment with the biopolymer. Overall the biopolymer treated sweet jalapeno pepper roots resulted in increased physical properties of the plants.

Table 12 summarizes data obtained after several Sweet jalapeno pepper plans were excavated and then analyzed for a variety of physical characteristics including area, width, height, and weight.

TABLE 12
Analysis of Excavated sweet jalapeño pepper plans

| Metric | Control | Treated | % Increase |
|---|---|---|---|
| Root Surface Area (sq in) | 1.9 | 2.6 | 33.5% |
| Width (in) | 2.2 | 2.2 | 1.3% |
| Height (in) | 3.1 | 3.3 | 9.0% |
| Root Wet Weight (g) | 22.5 | 30.0 | 33.3% |

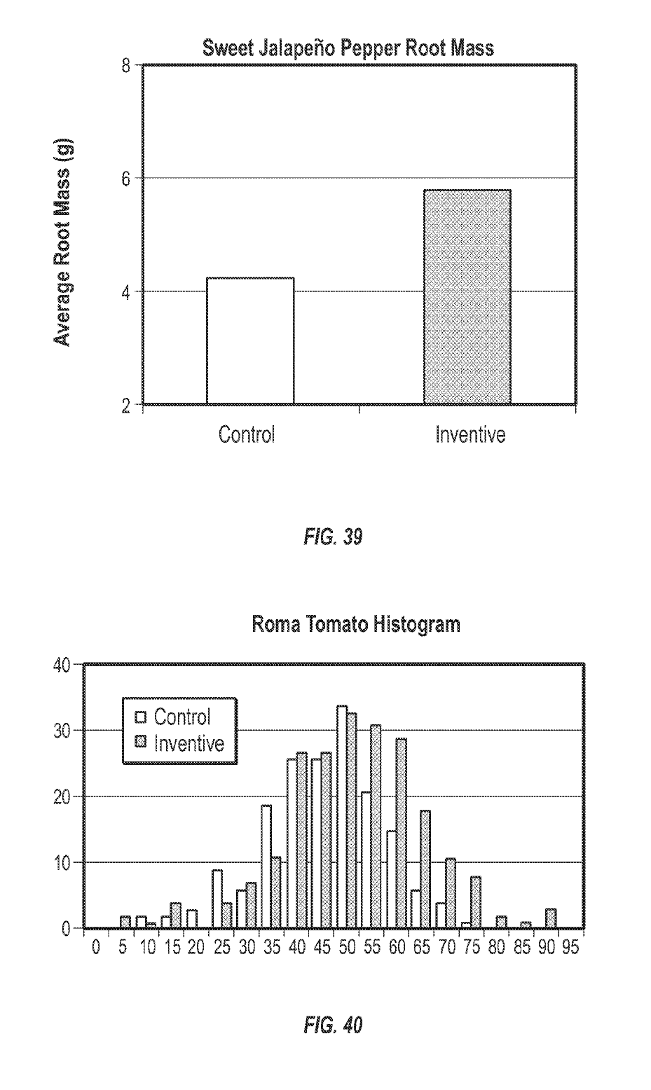

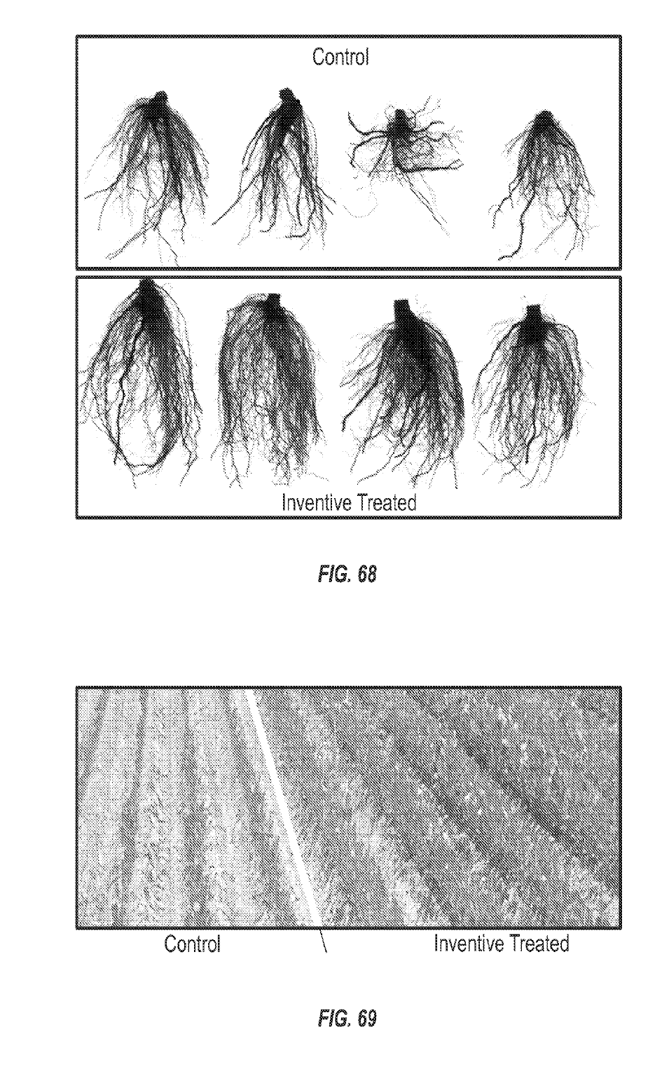

FIG. 39 is a chart showing a comparison of control and biopolymer treated root masses in sweet jalapeno peppers. As shown in FIG. 39, treated peppers resulted in significantly increased root masses as compared to controls. FIG. 68 is a series of photographs showing increased root mass and fine structure in eight treated sweet jalapeno pepper samples versus eight untreated sweet jalapeno pepper control samples;

### Experiment 10: Roma Tomato Test

Roma tomato testing was conducted in Arizona. Plants were grown from seed in peat pots in a hot house for two weeks, until seedlings were 5-10″ tall. At the start of week three, the seedlings were transplanted into two separate outdoor garden beds filled with a soil consisting of composted organics. A 12-10-5 fertilizer was broadcast onto both the treated and control areas. A regular watering schedule was established using an oscillating fan sprinkler. Biopolymer was initially applied by surface side dressing (non-injected) to the newly transplanted tomatoes in the treated garden at a rate of 3.5 g/plant (or 2.8 g/sq ft). After five weeks, a second fertilizer application was performed. After seven weeks, biopolymer was again applied at a rate of 4.0 g/plant (or 3.2 g/sq ft) to the previously side-dressed plants. Ripened fruit began appearing after ten weeks, and daily harvesting began after twelve. Data on crop yields, fruit mass, and number of fruit per plant were collected over a five week harvest period.

### Experiment 10: Roma Tomato Test Results

Biopolymer treated Roma tomato plants resulted in increases in all physical characteristics including fruit per plant, weight per fruit, and nodes per plant. Biopolymer treated plants averaged 46 fruit per plant whereas control plants averaged 31.1 fruit per plant, a 47.9% increase.

FIG. 40 shows a histogram of binned weights of Roma tomato fruit produced in two test plots, one control and one treated with biopolymer. The treated Roma tomato fruit resulted in larger and heavier fruit. The larger fruit experienced the same maturation period as the control plants lending itself to implementation in large scale commercial applications.

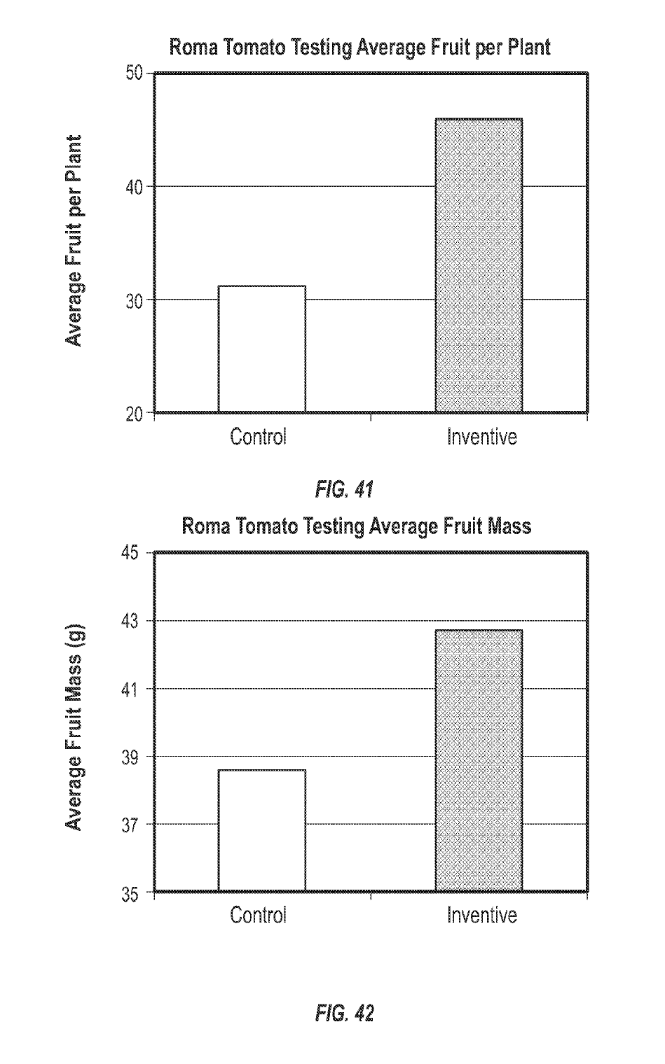

FIG. 41 is a chart showing the fruit per Roma tomato plant recorded during the lifecycle of the plants. Biopolymer treated Roma tomato plants showed an increase of 47.9% fruit per plant. The increase in fruit came from plants harvested during the same time period as in the inventive treated and the control plants. This indicates that there is no delay in maturation of fruit production and that the inventive material can be incorporated into current agricultural practices without modification of quality and timeframes required for harvest.

FIG. 42 is a chart showing the Roma tomato mass per fruit recorded and showed a 10.9% increase in biopolymer treated plants.

After Week 6, Roma Tomato plant length, number of limbs and leaves were analyzed. The results are summarized in Table 13. As shown in Table 13, treating the tomatoes resulted in increases of the average length of the plants, number of limbs, and the number of leaves of 45.5%, 52.5%, 31.9%, respectively, when compared to control tomatoes.

TABLE 13
Roma Tomato plant length, number of limbs and after Week 6
(totals for n = 18 ea)

| Metric | Control | Treated | % Increase |
|---|---|---|---|
| Length (in) | 139.5 | 184 | 45.5% |
| No. of Limbs | 158 | 241 | 52.5% |
| No. of Leaves | 1201 | 1748 | 31.9% |

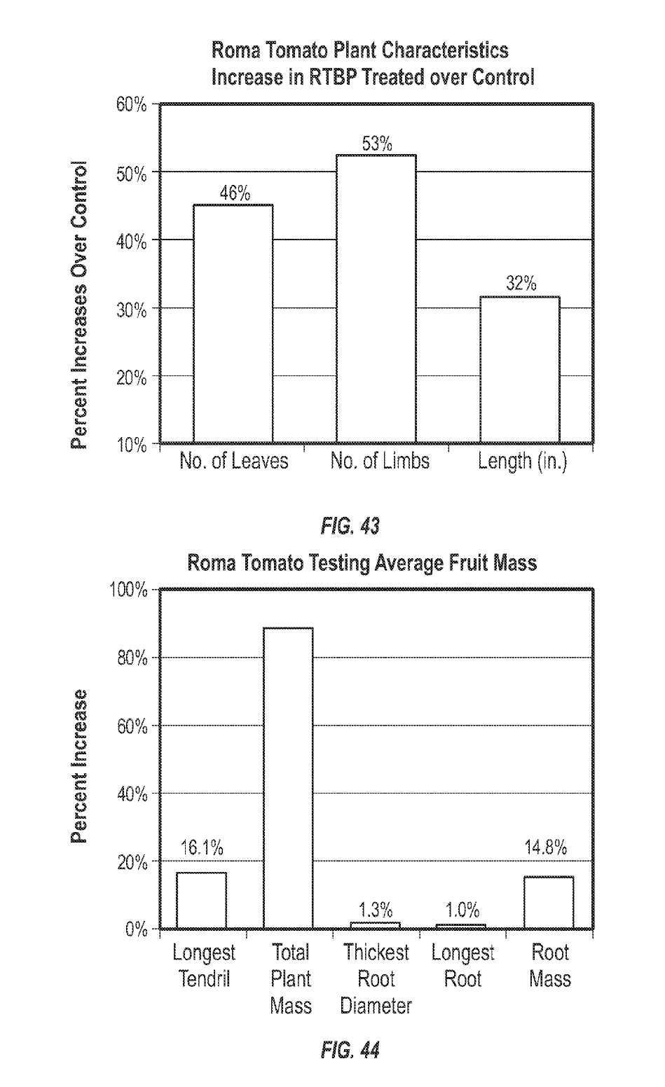

FIG. 43 is a chart showing physical tomato plant measurements in treated compared to control plants in Week 6 of plant growth. As shown in FIG. 43, overall the tomato plant health improves with the usage of the biopolymer. More rapid establishment early in the plants growth cycle results in increased resistance to environmental stresses, increased production of fruit, and increased vitality and health of the resulting fruit.

FIG. 44 is a chart showing a comparison between biopolymer treated and control Roma tomato plant characteristics demonstrating improved plant vitality in the treated plants. As shown in FIG. 44, total plant mass experienced significant increases in treated plants as compared to controls. This indicates that the treated plants exhibited a significant response to the inventive material throughout the lifespan of the plants, not just upon initial treatment. Improved plant mass allows for more effective uptake of nutrients and transport through the plant and into the fruit. Increased root mass in the treated versus the control shows a significant improvement.

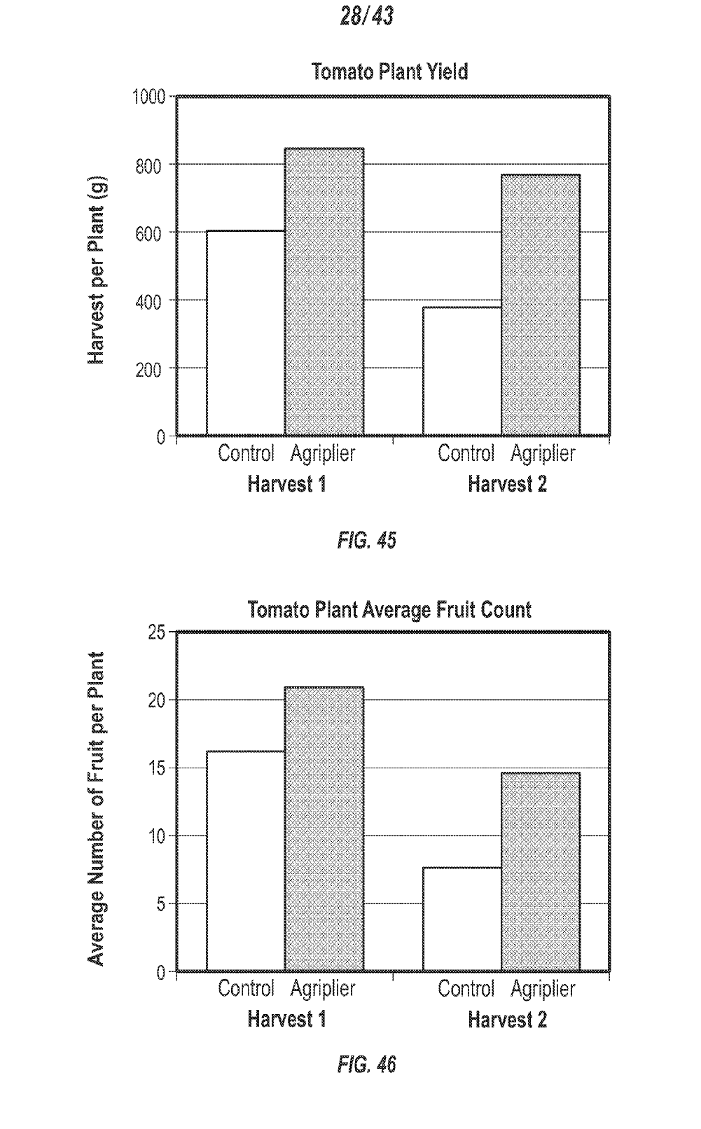

FIG. 45 is a chart showing Roma tomato plant yields in treated versus control plants for two commercial harvesting periods. Significant increases were noted in the plants. The first harvest noticed a significant increase in yield. The second harvest resulted in a larger yield increase, indicating that the plant produces a stronger, longer lasting plant that produces higher yields throughout the whole lifespan of the plant. Correspondingly, FIG. 46 is a chart showing tomato plant average fruit count in treated versus control plants for the same two commercial harvest periods. Fruit production was increased in both harvest in the treated plants.

### Experiment 11: Lettuce Test

Testing was conducted on Romaine lettuce in Arizona in a silt loam soil. Plants were grown from seed in peat pots in a hot house for two weeks, reaching a height of 3-5″. The seedlings were transplanted into two separate outdoor garden beds filled with a soil consisting of composted organics. A 12-10-5 fertilizer was broadcast onto both treated and control areas. A regular watering schedule was established using an oscillating fan sprinkler. RTBP was initially applied by surface side dressing (non-injected) to the newly transplanted lettuce plants in one of the test beds at a rate of 3.5 g/plant (or 2.8 g/sq ft). After five weeks, a second fertilizer application was performed. After seven weeks, biopolymer was again applied at a rate of 4.0 g/plant (or 3.2 g/sq ft) to the previously side-dressed plants. After 11 weeks, the plants were excavated, taking care to preserve root structure. Data was collected on plant mass, length and diameter, as well as root ball mass, length and diameter (see Table 14 A-B). The roots were then analyzed for metal content (see § 2.3.7).

### Experiment 11: Romaine Lettuce Test Results

Romaine lettuce was harvested in Week 8. In treated plants compared to the controls, there was an 82.0% increase in the average longest leaf height, 16.8% increase in the average longest root, 55.4% increase in the average root volume, and a 22.0% increase in the average diameter of the head of lettuce. Also, there was a 162.3% increase in the average weight of the roots and 363.6% in the total average Romaine lettuce weight per plant.

Mature lettuce was harvested and the leaf height, longest root, bulk root, and the diameter of the head of lettuce were recorded. The results are reproduced in Tables 14-A and 14-B. As shown in the tables, biopolymer treated lettuce showed percent increase in all of the physical metrics measured.

TABLE 14-A

| | Head Length (longest leaf) (in) | | | Longest Root (in) | | |
|---|---|---|---|---|---|---|
| Plant | | | Percent | | | Percent |
| Number | Control | Treated | Increase | Control | Treated | Increase |
| 1 | 4 | 7 | 82.0% | 5 | 6.5 | 16.8% |
| 2 | 6.5 | 10 | | 9.25 | 9 | |
| 3 | 5.5 | 9.5 | | 9.5 | 11.5 | |
| 4 | 4 | 11 | | 9.25 | 10.5 | |
| 5 | 6.5 | 12.5 | | 7.75 | 8 | |
| 6 | 7.25 | 11.5 | | 10.5 | 8.5 | |
| 7 | 6.25 | 10.5 | | 7.75 | 15.5 | |
| 8 | 7 | 13.5 | | 10.25 | 11 | |
| 9 | 8 | 12 | | 10.75 | 10.5 | |
| 10 | — | 10.5 | | | 9.5 | |

TABLE 14-B

| | Bulk Root (in) | | | Diameter Head (in) | | |
|---|---|---|---|---|---|---|
| Plant | | | Percent | | | Percent |
| Number | Control | Treated | Increase | Control | Treated | Increase |
| 1 | 2.25 | 2.5 | 55.4% | 6.5 | 7.5 | 22.0% |
| 2 | 2.5 | 3.5 | | 7.5 | 10.5 | |
| 3 | 2.5 | 6.5 | | 8 | 13 | |
| 4 | 3.5 | 4.5 | | 10.5 | 16.5 | |
| 5 | 3 | 4 | | 11 | 12 | |
| 6 | 3.25 | 4.5 | | 13.5 | 13.5 | |
| 7 | 3 | 6.5 | | 14 | 12.5 | |
| 8 | 4 | 5.5 | | 12 | 15 | |
| 9 | 4.5 | 6 | | 13 | 13 | |
| 10 | — | 6.5 | | — | 15 | |

After harvesting the roots weight along with the whole weigh of lettuce was recorded. The results are summarized in Table 15. As shown in the table, the biopolymer treated lettuce shows a substantial percent increase.

TABLE 15

| | | | Weight Fruit & | | |
|---|---|---|---|---|---|
| Weight Roots (g) | | | Roots (kg) | | |
| | | Percent | | | Percent |
| Control | Treated | Increase | Control | Treated | Increase |
| 4.03 | 14.16 | 162.3% | 0.03 | 0.2 | 363.6% |
| 5.21 | 38.14 | | 0.06 | 0.54 | |
| 6.18 | 44.43 | | 0.05 | 0.6 | |
| 12.98 | 11.56 | | 0.11 | 0.78 | |
| 19.35 | 28.49 | | 0.26 | 0.32 | |
| 22.61 | 16.79 | | 0.22 | 0.36 | |
| 27.45 | 31.36 | | 0.28 | 0.36 | |
| 50.64 | 45.93 | | 0.38 | 0.76 | |
| 60.76 | 26.18 | | 0.52 | 0.90 | |
| — | 56.64 | | — | 0.56 | |

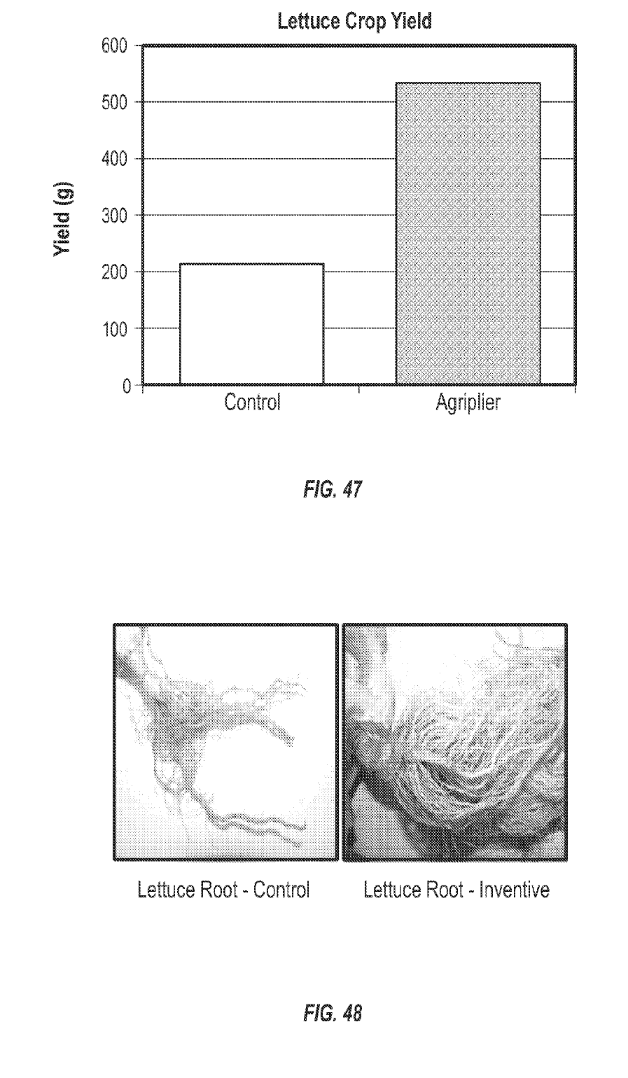

FIG. 47 is a chart showing Romaine lettuce yields in treated versus control plants. Significant increases in the yield per plant were noticed. A 363% improvement in the treated plants versus the control plants was noticed. All characteristics of the treated Romaine lettuce showed increase vigor and size when treated versus a control. FIG. 48 is a side-by-side comparison of lettuce roots produced according to the control and biopolymer treated lettuce roots. Increased fine structure in the Romaine lettuce roots were noticed that demonstrated the inventive materials propensity for increased desired plant characteristics.

### Experiment 12: Bermuda Grass Test

Testing was conducted on sloped plots of soil using Bermuda grass seed. Two plots were sited on a North-facing hillside with consistent full sun exposure. Sprinklers were timed to provide ten minutes of water every six hours at 0.106 cfm. Both plots were scarified to a depth of 1 inch. RTBP was then applied to the test plot at a rate of 1 kg/acre. RTBP can be applied in a range of from 0.25 to 2 kg/acre. Bermuda grass seed was broadcast onto the sloped plots at a rate of 2 lb/acre, covered with a quarter inch layer of fine-screened mulch, and given an initial watering. After ten days, the watering schedule was reduced to seven minutes every twelve hours. Qualitative photographic documentation was taken daily.

Quantitative biomass analysis was performed on samples taken after 20, 29, and 36 days of growth. Each plot of grass was divided into a five by five grid set one foot interior to the plot's perimeter. The 25 squares were labeled 1-25 starting from upper left and continuing in a standard reading fashion. Using a random integer generator, three numbers ranging 1-25 were randomly generated for each plot. Biomass samples were from the center of the randomly selected squares by driving a 2 inch diameter PVC core sampler six inches into the dirt and removing the contained soil and biomass. The biomass was rinsed of soil and allowed to dry for at least 16 hours at 80° C. Measurements for dry weight biomass were recorded (see Table 16).

TABLE 16

| | Control Weight of | Inventive Weight of | Increase in |
|---|---|---|---|
| | Core Sample Biomass | Core Sample Biomass | Inventive over |
| | (g) | (g) | Control |
| Day 20 | 0.07333 | 0.2433 | 331.81% |
| Day 29 | 0.39 | 0.8066 | 206.83% |
| Day 39 | 0.7133 | 1.21 | 169.62% |
| Day 57 | 0.95 | 1.63 | 171.57% |

### Experiment 12: Bermuda Grass Test Results

Core samples from Bermuda grass test plots of average Bermuda biomass from core samples. On day 20 of the growing cycle core samples were taken and the biomass recorded. On day 20 the average control biomass was 0.073 g while the average biopolymer treated biomass was 0.2433 g. Treating the Bermuda grass plots with the biopolymer resulted in a 332% increase. On day 29 the average control biomass was 0.39 g while the average biopolymer treated core samples had a biomass average of 0.81 g resulting in a 207% increase.

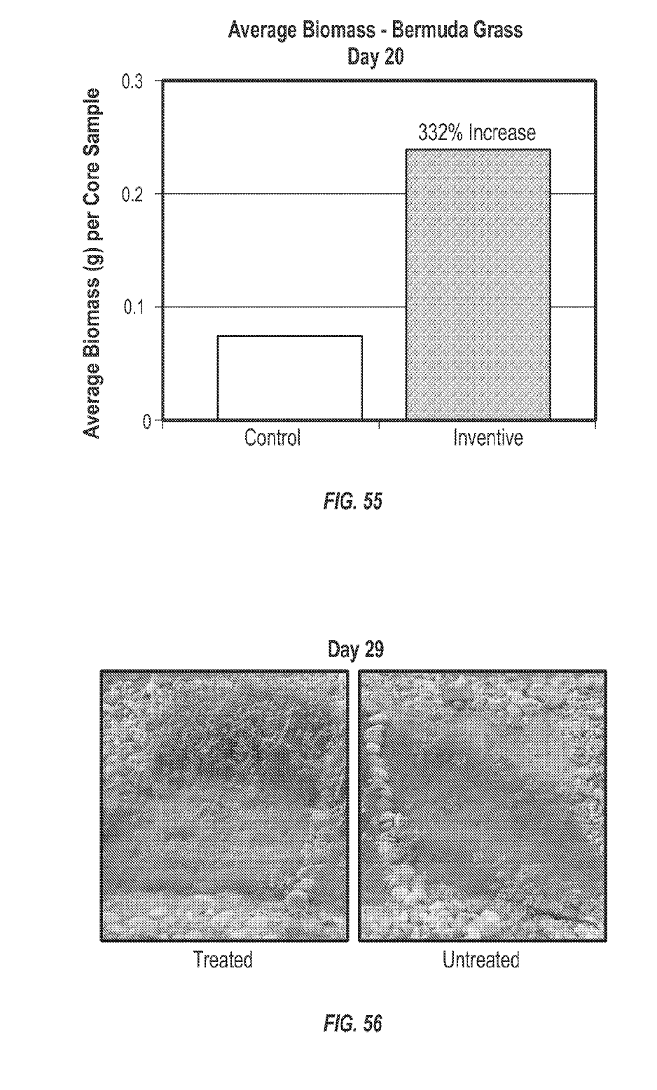

On day twenty, three core samples were taken from random areas of the test area (selected by a random number generator). As shown in FIG. 55, biomass weight was then calculated and showed a 332% increase in the biopolymer treated plots.

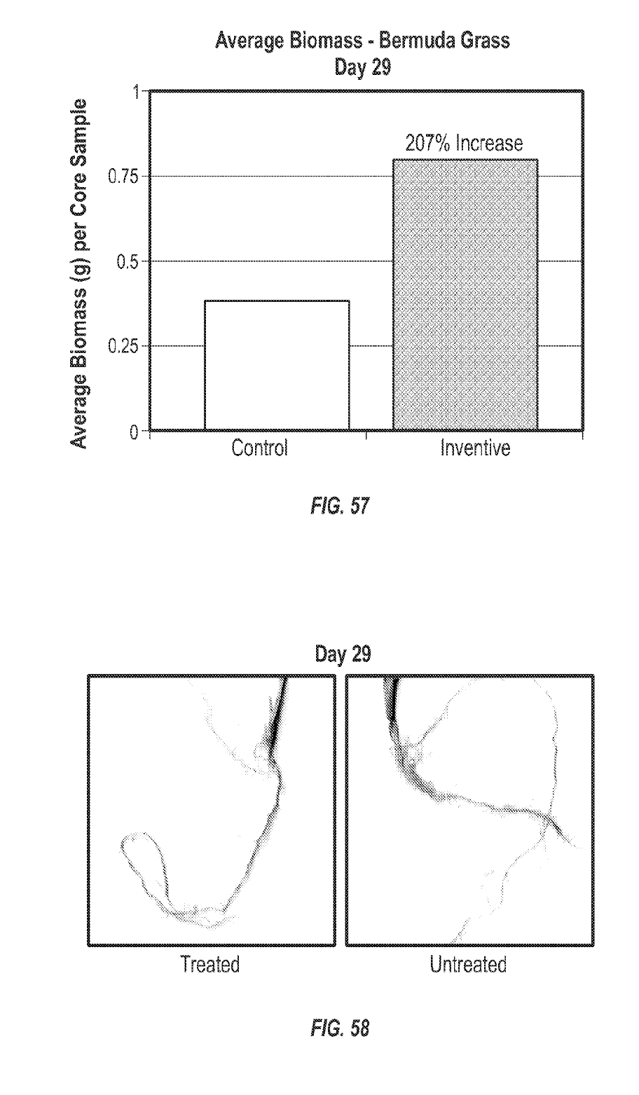

On Day 29 of the Bermuda grass test plots, core samples were taken from random areas of the test area (selected by a random number generator). As shown in FIG. 57, biomass weight was then calculated and resulted in a continued significant increase in biomass in the treated areas as compared to the control area.

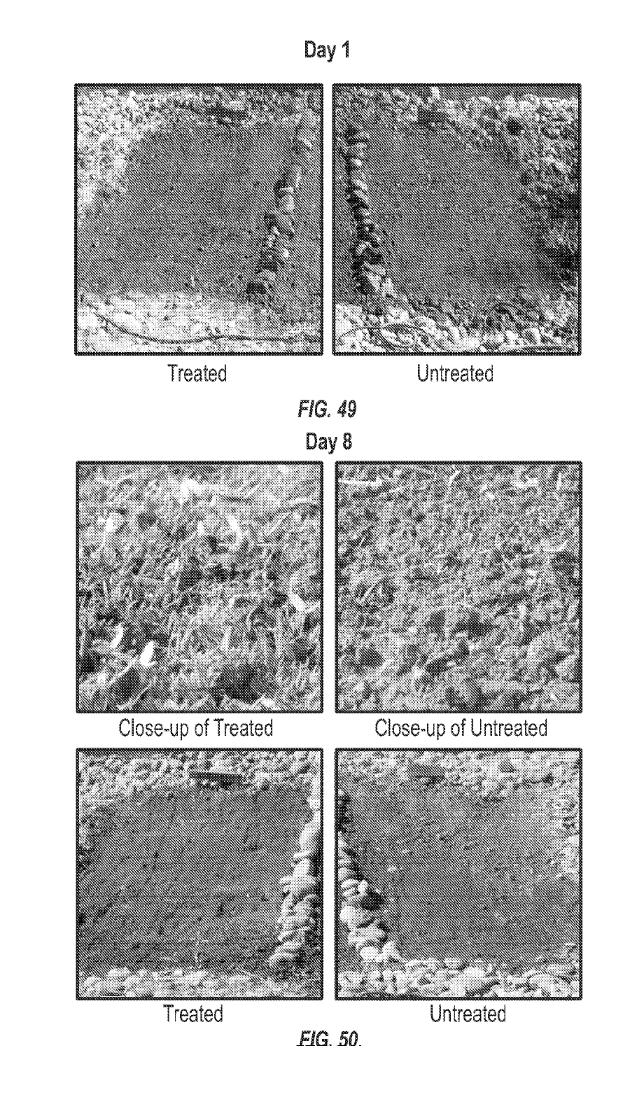

FIG. 49 shows two plots on day 1 of the Bermuda grass experiment; one inventive treated and one control. Conditions such as sun exposure, soil composition and degree of slope were made consistent across the plots. Regular watering schedules for seeding grass were maintained.

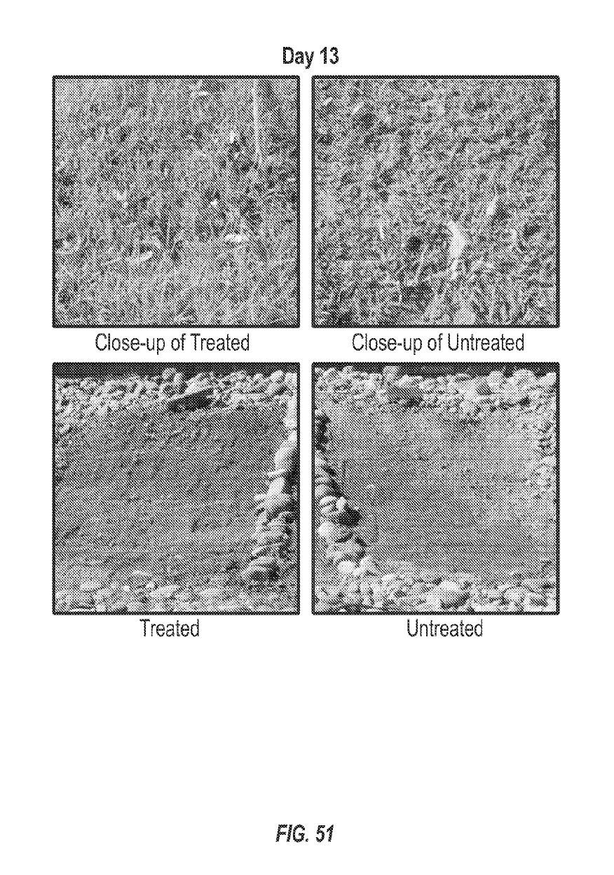

FIG. 50 shows photographs taken from two distances of the plots for the Bermuda grass experiment on Day 8. Establishment on the treated plot started whereas in the control little growth was noticed

FIG. 51 shows photographs taken from two distances of the plots for the Bermuda grass experiment on Day 13. Rapid establishment of the inventive treated plot resulted in a significantly more robust coverage as compared to the control. Establishment in the control was delayed as compared to the treated plot.

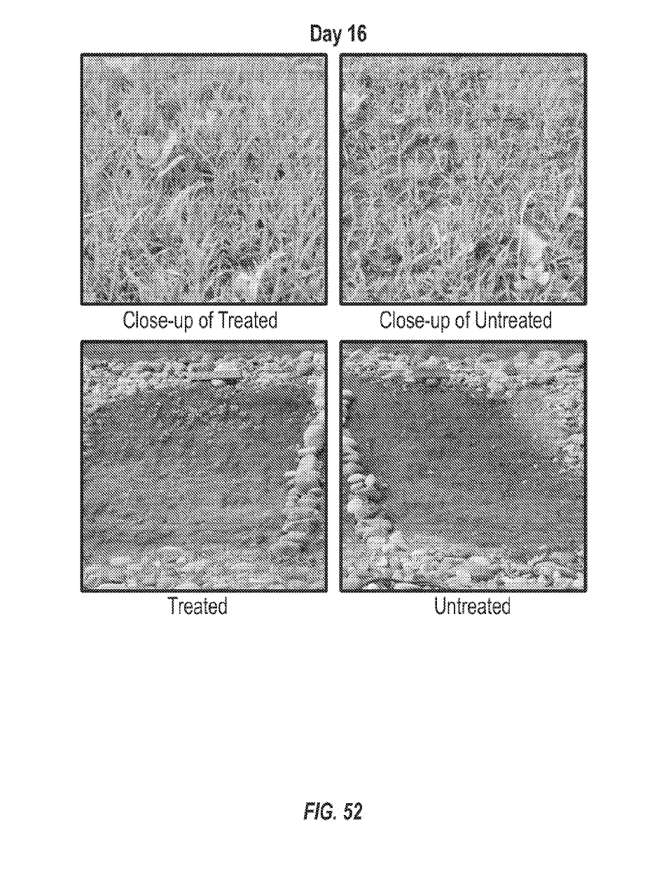

FIG. 52 shows photographs taken from two distances of the plots for the Bermuda grass experiment on Day 16. The establishment in the treated plot is significantly more and the length of the established blades of Bermuda grass was significantly longer than those of the control.

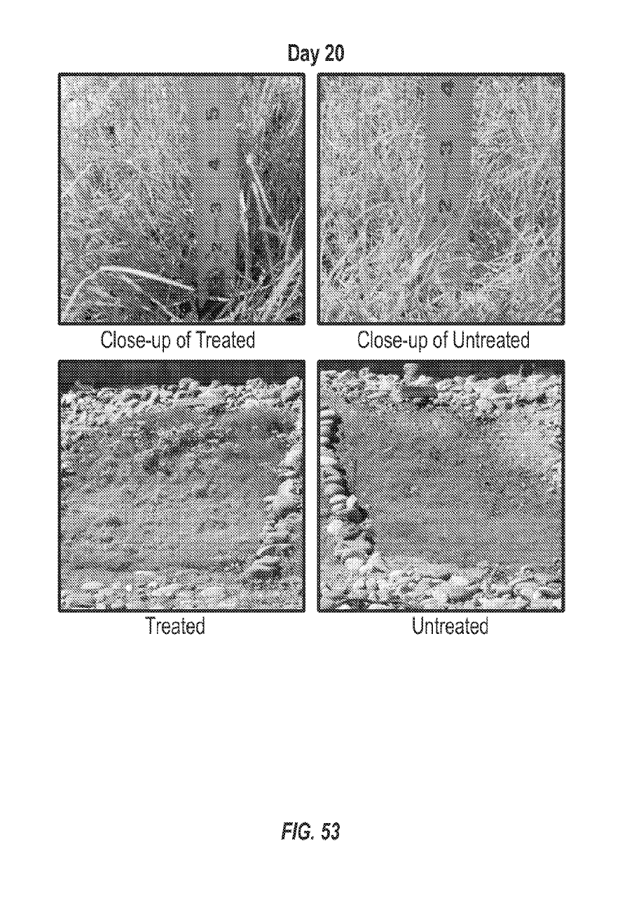

FIG. 53 shows photographs taken from two distances of the plots for the Bermuda grass experiment on Day 20.

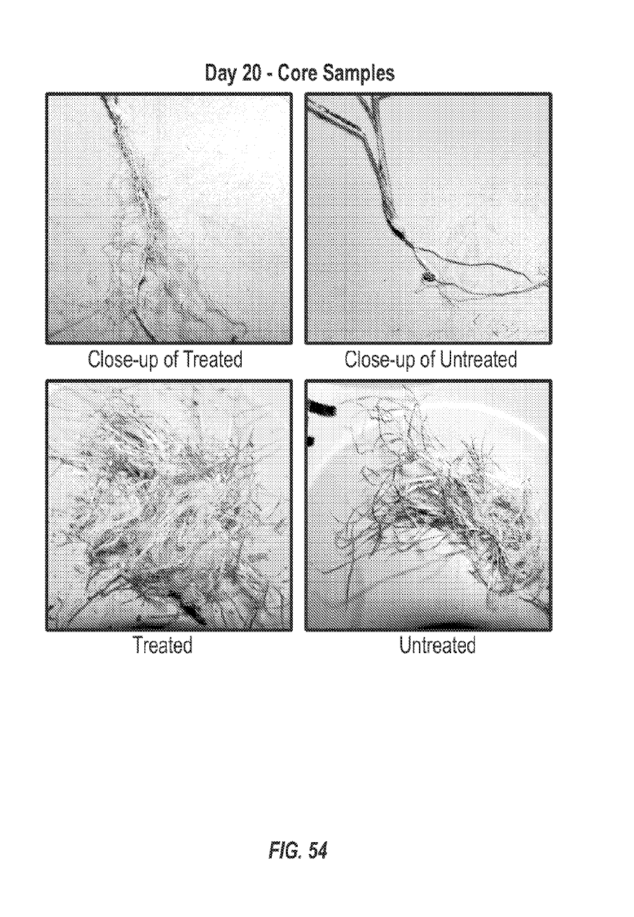

FIG. 54 shows photographs of core samples of the Bermuda grass experiment on day 20. Significant improvements in biomass concentrations were noticed in the treated plots.

FIG. 55 is a chart showing the average biomass per core sample of the Bermuda grass on day 20. The treated plots noticed a 332% increase in biomass over the control plots during day 20 indicating a much more rapid and extensive establishment of the plant system as compared to a control

FIG. 56 shows photographs of the plots for the Bermuda grass experiment on Day 29.

FIG. 57 is a chart showing the average biomass per core sample of the Bermuda grass on day 29. The inventive treated soil core samples show a much more extensive root system better suited to survive drought, uptake nutrients, and provide increased vigor and vitality as compared to a control.

FIG. 58 shows photographs of an untreated Bermuda grass root and a treated Bermuda grass root on Day 29. FIG. 58 shows a significant increase in fine root structure in the treated Bermuda grass root.

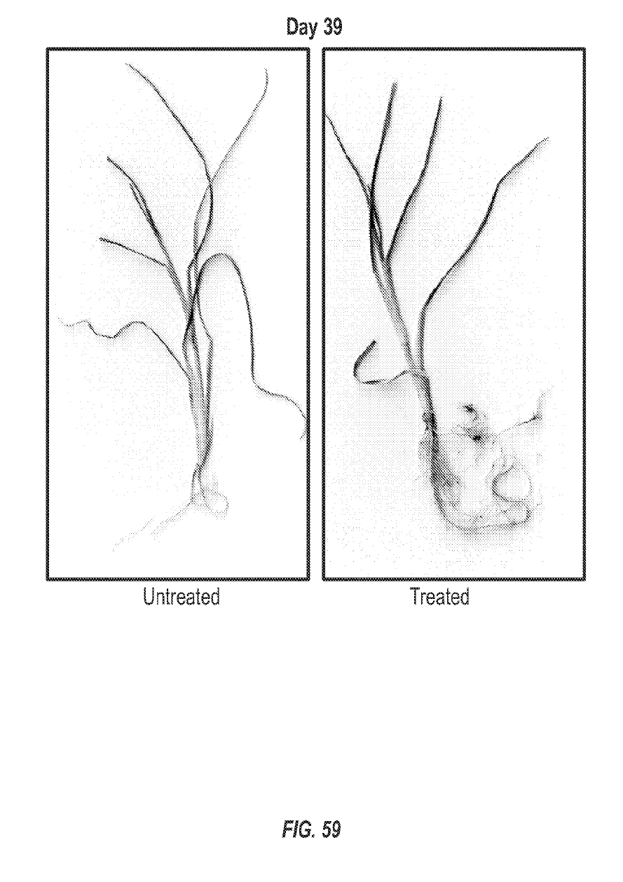

FIG. 59 shows photographs of an untreated Bermuda grass root and a treated Bermuda grass root on Day 39. A significantly improved fine structure corresponds to increased ability to uptake nutrients and resist environmentally stressed conditions.

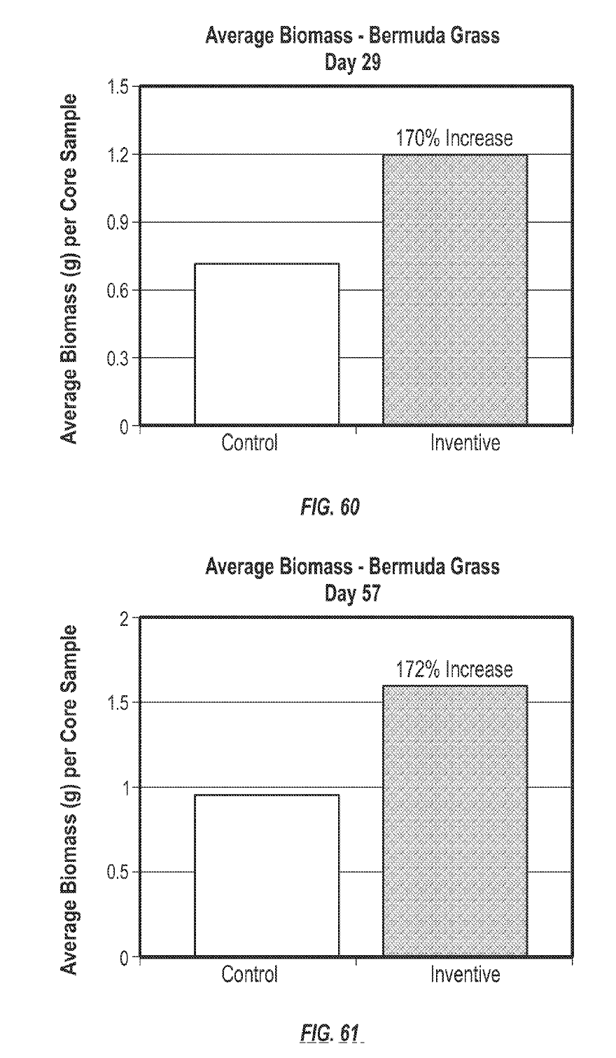

FIG. 60 is a chart showing the average biomass per core sample of the Bermuda grass on day 39.

FIG. 61 is a chart showing the average biomass per core sample of the Bermuda grass on day 57. The test was concluded after 57 days. A final sampling was performed, finding a significant increase in biomass in the treated plot over the control plot. The treated plots noticed a 170% increase over the control plots in total biomass indicating that the inventive material significantly increases growth characteristics when applied to grasses.

Establishment and initial germination in treated plots was significantly improved as compared to the controls. The initial time required to achieve coverage was improved by at least a week. Upon inspection of the root system, a much more established root system and fine structure likely allowed for increase nutrient uptake and growth characteristics that manifested in a more established vegetative cover. The treated plots and their more established root system are more resistant to drought and environmental stresses such as fluctuating temperatures, decreased nutrients without replenishment, and microtoxicity due to aluminum.

Utilizing the inventive material, rapid establishment of vegetative growth such as that associated with Bermuda grass can help mitigate soil erosion and maintain slopes in areas where typical weathering might cause rapid erosion. In addition to preventing soil erosion, the rapid establishment of vegetative growth as afforded by the use of the inventive material can prevent metal contamination from run-off of eroded soils. This can improve the localized environmental quality and prevent loading in to the local streams. As nutrient and sediment loading is the largest contribution to eutrophication in water systems, the inventive material can help prevent this problem by rapidly establishing vegetative cover and stabilizing the soil.

### Experiment 13: Seed Coating Application

Coating seeds with the biopolymer increases the germination rate and drought resistance of the seedlings improving vegetative cover of the soil.

The ease of establishing and maintaining a vegetative cover was measured by comparing germination rates of seeds treated with two concentrations of biopolymer to seeds with no biopolymer, placing the seedlings under drought conditions, and then observing recovery rates when watering was resumed. The seeds were coated with 0 mg, 10 mg, or 30 mg of biopolymer and allowed to air-dry. Seeds were grown in identical individual soil pots according to methods described in ASTM Method E-1963-09 for seed germination studies. The pots were each watered after the seed was planted using 20-ml water per day per plant. The germination rates were calculated for each test condition. After three weeks of watered growth, watering was curtailed for 6 days, producing simulated drought conditions. All plants were then watered and recovery (defined as water entry into stems and leaves producing a less desiccated appearance and lifting the stem and leaves from the soil surface) was recorded for all test subjects.

Maintaining vegetative cover during the construction process is one of the most effective erosion control practices (2). FIG. 30 compares the rate of germination of the biopolymer-coated and uncoated seeds as well as the degree of coating (10 mg vs. 30 mg biopolymer). Germination rate was increased with the thicker coating of biopolymer. Both the 10-mg and the 30-mg treated seeds showed significantly higher germination rates that the untreated seeds (43% untreated vs. 73% and 83% for treated seeds).

Drought recovery of seedlings from biopolymer-treated and untreated seeds is compared in FIG. 28. The presence of the biopolymer coating increased plant survivability by 42% however survivability was not affected by the amount of biopolymer coating.

Plants from both the 10 mg and the 30 mg-coated seeds were more resistant to the imposed drought conditions than the plants from untreated seeds. The biopolymer increases the water holding capacity of the seeds and soil, reducing water demands for planting and maintaining a vegetated surface. The ability to produce a vegetative cover to control surface water runoff using less water to establish and maintain the plants should produce cost savings on construction sites and other urban areas with disturbed soil.

Ragdoll seed germination testing was conducted on several varieties of seeds. Ragdoll seed germination testing procedures are well known. For a description of one ragdoll seed germination testing methodology see Newman, et al., Seed Germination Testing (“Rag-Doll” Test), SS-AGR-179, Florida Forage Handbook, 1999, which is hereby incorporated by reference in its entirety. The experiment consisted of germination tests using several different plant species: Kentucky beans, Swiss chard, cotton, cucumber, squash, and pumpkin. Rags were soaked a RTBP solution

Rows of seeds were wrapped in paper towels, which were then placed in separate trays and left to germinate in a hot green room. Every 24 hours the towels were wetted ensure regular, consistent moisture. The total germinated seeds for each group were recorded (Table 17).

Lettuce seeds were treated using RTBP as a primer. The seeds were primed with RTBP and dried. The treated seeds were then allowed to germinate by rag method for 24-48 hrs under elevated temperatures to test the thermal dormancy. Two varieties of seed were tested; one high germination rate (low dormancy) and one low germination (high dormancy). Both were tested at elevated temperatures.

### Experiment 13: Seed Coating Application Results

Table 17 shows the results of seed germination by rag method. The control show a lower percentage of germination compared to the RTBP treated.

TABLE 17

| Seed Type | Control | Treated |
|---|---|---|
| Swiss Chard | 66.66667 | 83.33333 |
| Kentucky Beans | 66.66667 | 100 |
| Cotton | 73.3333 | 85 |
| Squash | 88 | 92 |
| Pumpkin | 90 | 95 |
| Cucumber | 92 | 94 |

FIG. 67 and Table 17 show seed germination data on Kentucky beans, Swiss chard, cotton, cucumber, squash, and pumpkin. The data shows the percent germinated after ten days of testing. The RTBP treated seeds showed a greater percentage of germinated seeds than the controls.

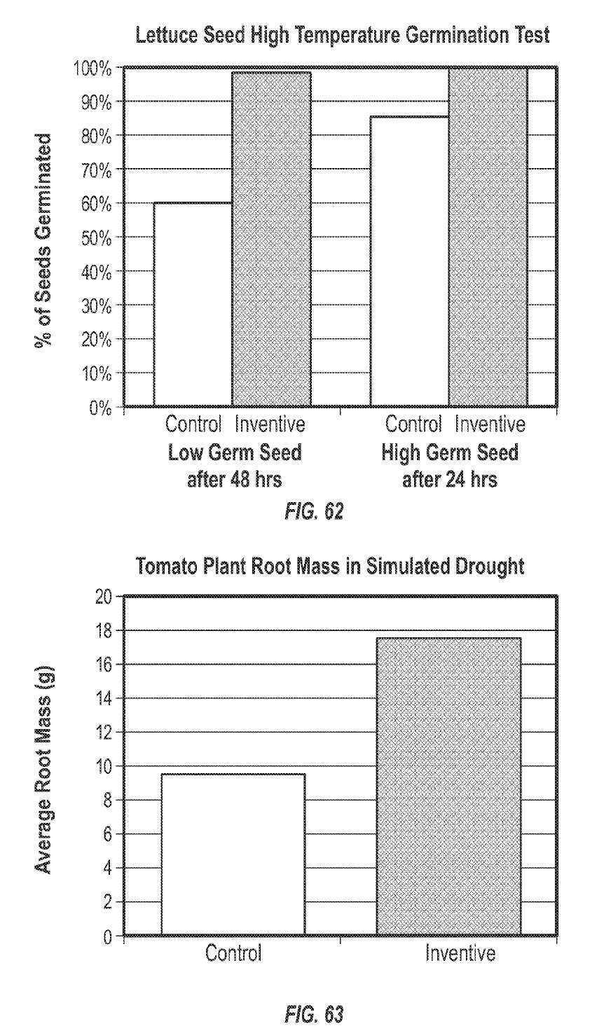

FIG. 62 is a chart showing the percentage of seeds germinated after 24 hours and after 48 hours for treated and untreated lettuce seed. Both the high and low dormancy seeds when treated with the inventive broke thermal dormancy and exhibited increased germination as compared to the control.

### Experiment 14: Simulated Drought Testing

Simulated drought conditions were tested on three vegetable species; Roma tomatoes, zucchini, and sweet jalapeno peppers.

In the tomato and zucchini drought testing, plants were started from seed in a hot house. Upon reaching sufficient size, they were transplanted into two separate garden beds containing soil consisting of a clay/silt mixture. Biopolymer was applied by surface side dressing (non-injected) at a rate of 3.5 g/plant to the treated garden bed. Regular watering was established for both garden beds involving drench irrigation every two days. At the first signs of fruit production, water was withheld to simulate a drought condition. After nine days, the watering program and regular fertilizer applications were reestablished for the remainder of the plants' production cycle. Biopolymer was then reapplied to the treated plants by side dressing at a rate of 4 g/plant after four weeks. Data were collected on mass yields for each plant species.

Hot house sweet jalapeno chili pepper plants were planted in two separate garden beds filled a potting soil consisting of composted organics. A 12-10-5 fertilizer was broadcast onto both sections and a minimal watering schedule was established using an oscillating fan sprinkler. Biopolymer was initially applied by side dressing to the newly transplanted pepper plants in the test garden at a rate of 3.5 g/plant (or 2.8 g/sq ft). After five weeks, a second fertilizer application was performed. After seven weeks, biopolymer was again applied at a rate of 4.0 g/plant (or 3.2 g/sq ft) to the previously side-dressed plants. Ripened fruit began appearing after ten weeks, and daily harvesting began after twelve. Data on crop yields, fruit mass, and number of fruit per plant were collected over a 5 week harvest period (see Table 18).

TABLE 18

| | Control | Inventive |
|---|---|---|
| Average Yield per Plant (g) | 1017.353 | 1576.784 |
| Average Weight per Fruit (g) | 43.18 | 46.46 |
| Average Fruit per Plant | 23.5 | 31.9 |

### Experiment 14: Simulated Drought Testing Results

Table 19 provides a comparison of control and biopolymer treated test plots in two plant species, tomatoes and zucchini, in simulated drought conditions. The biopolymer treated plants exhibited a significant improvement in the yield per plant, with tomatoes exhibiting a 328% increase per plant on average in the treated versus the control and a 757% increase in the treated zucchini plants versus the control.

TABLE 19

| | | Biopolymer | |
|---|---|---|---|
| | Control Plant | Treated Plant | |
| | Fruit Yield | Fruit Yield | Percent Increase |
| Plant | (average) (g) | (average) (g) | in Fruit Mass |
| Tomato | 289 | 1239 | 328% |
| Zucchini | 488 | 4190 | 757% |

FIG. 32 is a chart showing that increased fruit production was obtained by treatment with biopolymer in simulated drought conditions. As shown in FIG. 32, increased fruit yield of 328.4% for tomato and 757.0% for zucchini were noticed after treatment with the biopolymer.

FIG. 63 is a chart showing the average root mass of treated and untreated tomato plant roots in a simulated drought. Significant increases in the root mass structure likely allowed for increased nutrient and water uptake that increased the vigor of the plants during the simulated drought.

### Experiment 15: Metal Analysis

Inductively Coupled Plasma Optical Emission Spectrometry (ICP-OES) testing was performed on plant roots. Roots collected from field testing were digested in 1 N HCl and allowed to digest overnight while stirring. The samples were passed through a 0.2 μM filter, the then sampled with a Perkins Elmer Optima TM2100-DV ICP-OES for simultaneous multi-element detection. Parts per million data were taken for Aluminum and Calcium

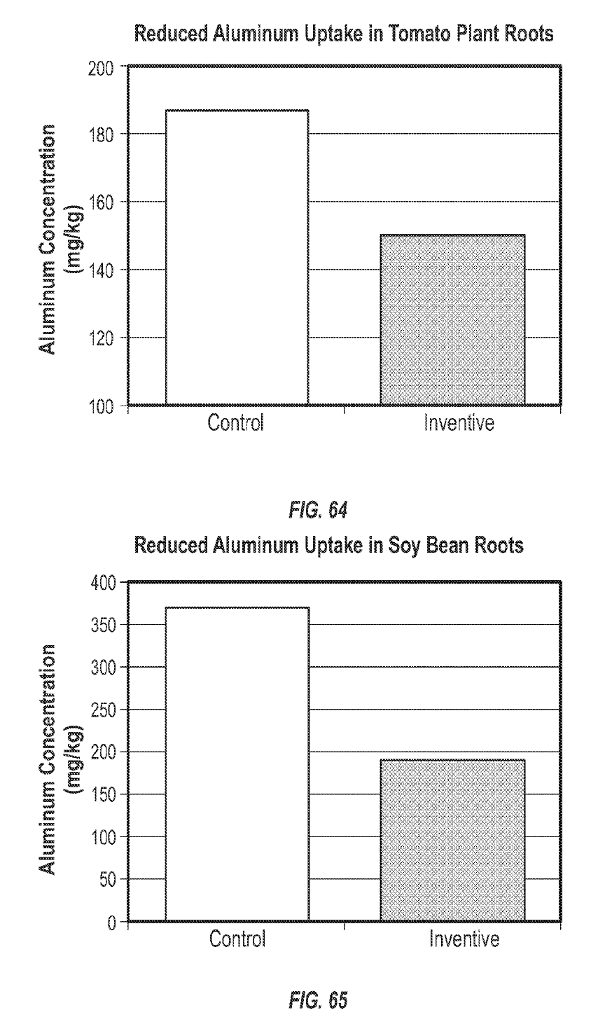

FIG. 64 is a chart showing the aluminum concentration in treated and untreated tomato plant roots showing a significant decrease in the amount of aluminum uptaken by the treated plants as compared to controls. This shows that the RTBP prevents uptake into the roots of the treated plants and may correspond to the increased growth characteristics noticed throughout the trials.

FIG. 65 is a chart showing the aluminum concentration in treated and untreated soy bean roots. Decreased concentrations of aluminum were noticed in the treated plants as compared to the control plants. Soy beans noticed a greater than 150% reduction in the treated plants as compared to the control.

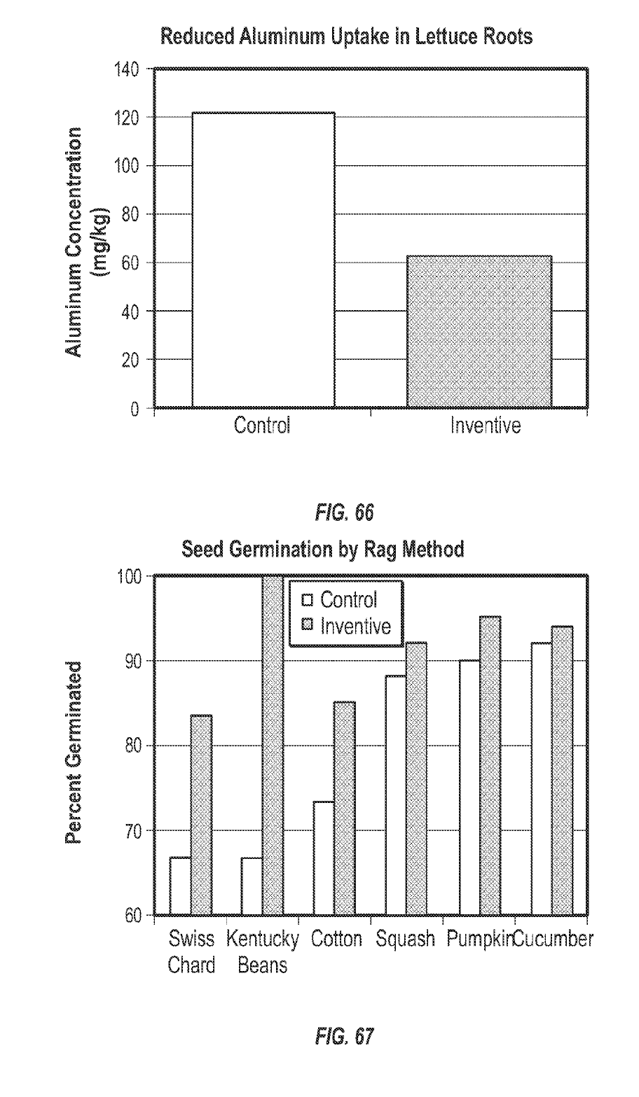

FIG. 66 is a chart showing the aluminum concentration in treated and untreated lettuce roots. Similarly to the soy bean analysis, the treated plants experienced a greater than 150% reduction in the aluminum concentration in the roots as compared to the controls.

### Experiment 16: Soy Bean Field Testing

Testing was conducted on soy beans in Mississippi. The soy beans were planted as seed. In the treated fields, when planting in furlough occurred, a drip of RTBP was applied at a rate of 2 kg/acre. The controls remained untreated. The plants were fertilized at initial planting. No irrigation system existed and the plants were subject to natural watering. At week 6, qualitative analysis indicated that the soy beans in the treated plots were approximately twice the height of those in the untreated plots. FIG. 69 is a photograph taken after 6 weeks of growth, showing an untreated soy bean plot on the left and a treated soy bean plot on the right to demonstrate the significant improvement and response in the early stages of the plant growth cycle; and

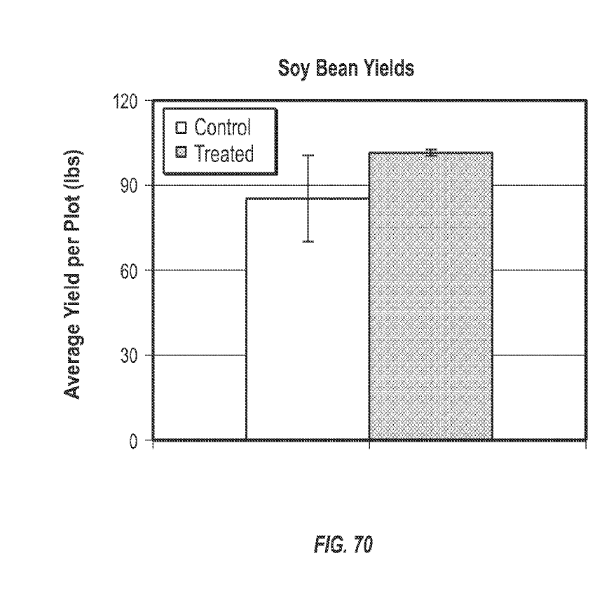

A final harvest of soy beans resulted in an average yield increase of 19% in the treated soy beans over the control (see Table 20 and FIG. 70).

TABLE 20

| Control/Treated | Average Yield Per Plot (kg) | Standard Deviation |
|---|---|---|
| Control | 84.66666667 | 15.011107 |
| Treated | 100.6666667 | 1.154700538 |

Table 20 shows data for results from the average of three plots each of treated and non-treated soy beans showing a significant increase in the treated soy beans versus the control. FIG. 70 is a chart showing the results of soy bean field testing showing the average yield per plot (averaged over three plots) of the treated and non-treated plots. The treated plots demonstrated a 19% increase in the yield over the control plots.

Much of the testing cycle occurred during a natural drought. Only in the later part of the growing cycle did natural rains occur that allowed for a harvest of the crop. It is believed that the results shown a difference less than would be expected during a normal watering cycle, but still show the ability of the inventive RTBP to assist soy beans in dry conditions. Additionally, the plots in the treated soy bean tests were more consistent than those in the non-treated test plots.

### Experiments 9-16: Discussion

The RTBP produces significant results in improved yields in a large range of application methods, crop types, and soil types. Application methods tested included seed coating, side dressing, seed trench, seed pot, root ball dip, and surface spray. Additionally, the RTBP was incorporated in conventional fertilizers that included ammonium and again achieved improved performance over control test. This indicates that the RTBP may be applicable in most if not all agricultural settings.

Incorporation of the RTBP into current agricultural practice was performed on several crops, including soy beans, watermelons, and sweet jalapeno chili peppers. The biopolymer was incorporated into one of the traditional fertilizer applications as to eliminate increased labor cost from application. Only one application was performed in each of these trials. This application occurred at the beginning of the planting season. Regular agricultural practice was continued for the duration of the crop cycle without preferential treatment towards the biopolymer treated areas. Soy beans experienced a 19% increase in yields in the treated biopolymer area versus the control test plots. Watermelons noticed an 813% increase when treated with the biopolymer versus control, and sweet jalapeno chili peppers had increases of 18.7% and 19.1% in the first and second harvest, respectively. This indicates that the biopolymer has usefulness as an additional tool in current agricultural practice without the need for an additional application or increased labor cost from application.

Improved plant condition and vitality was noticed throughout the lifecycle of the plants. In tomato plants, increased length of above ground stalks was noticed, as well as increased number of nodes, and foliage associated with each plant. Increases were noticed for the varying stages of tomato plant growth. In soy beans, biopolymer treated plants were nearly twice as large as their control counterparts. This indicates that the biopolymer interacts both early in the plant cycle and allows for more extensive root development in the plant.

Early increased performance was noticed in all crops. Some crops had increased performance early in the lifecycle which decreased but remained higher than the controls throughout the harvest period of the crop cycle. Increased physical characteristics were significant in early stages of plant growth. This suggest that treatment with the biopolymer multiple times throughout the plants growth cycle may result in further increased yields in the final stages of the plants lifespan.

One mechanism noticed throughout the course of all experiments was the extensive development of fine structure in the root zone by the biopolymer treated plants. In all crops analyzed for root development, increases in area and density of the root system were noticed. This increased root zone development allows for increased nutrient uptake and improves the ability of the plant to produce higher yields. More extensive fine structure allows for easy access to available nutrients in soils and strongly correlates to increased fruit production.

Metal uptake into the root system was monitored in several crops. A decreased aluminum uptake was noticed across the board for all crops that were treated with the biopolymer versus the control test plots. Several possible mechanisms exist for this. The biopolymer has known chelation properties that make it ideal for application for this explicit purpose. Although many of the concentrations observed in the soil background were not considered to be near the threshold for aluminum toxicity in plant growth, significant reductions in aluminum uptake were noticed. Trends with other metals that were detected were not noticed, suggesting some preferential binding of aluminum in soils by the biopolymer.

Drought condition testing experienced a significant increase over control crops. In several species of plants, biopolymer treated plants significantly outperformed control plants in fruit yield. Typically near the end of the simulated drought period, control plants vitality was greatly impacted. Biopolymer treated plants maintained a much healthier character during the drought period. Upon resuming a regular watering cycle, the control plants required longer to recover from the drought and never achieved the performance of the biopolymer treated plants after the drought conditions.

The biopolymer greatly improves the yield, vitality, and physical properties of all plants tested. Further work is needed in testing as a seed coating application but there might be large potential benefits from its use as an addition to the current tool-box of farmers. Decreasing yields continually plague farmers and the incorporation of the RTBP utilized in these test may help reverse these trends. The RTBP is a naturally occurring substance created by naturally occurring microbes and lends itself to ‘green’, environmentally friendly, and sustainable agriculture utilization. Additionally, the benefits from utilizing this material in an agriculture setting could find application in ornamental applications, revegetation efforts in impacted areas, and rapid establishment of growth in soils for slope stabilization and other applications. This makes the RTBP a robust soil additive for a variety of applications.

### Experiment 17

A 20 L nutrient broth reactor was prepared. The broth comprised: 20 L water; 20 g yeast; 50 g sugar; 190.2 g KH₂PO₄; 10 g K₂HPO₄; 2.0 g MgSO₄; and 3 g CaCl₂*H₂0.

R. tropici bacteria was added to a biological reactor containing approximately ½ of the broth. A culture was allowed to form. Once the culture began to produce a foam, more broth was added at a steady rate of 2.5 L every other day until the reactor achieved the full volume of 20 L (approximately 8 days).

Once the reactor reached full volume daily samples were taken. On the second day after achieving full volume, an additional 50 g of sugar was added along with 0.0013 g of Naringenin (5,7-dihydroxy-2-(4-hydroxyphenyl)chroman-4-one, which is a flavanoid). The reactor was maintained at a dissolved oxygen (D.O.) level of from about 1-2.5 mg/L. When the DO level achieved a 2-3 mg/L level [other appropriate levels include those above 3 mg/L all the way to the saturation limit of the water solution at that temperature of the reactor, where the preferred D.O. level was 2.5 mg/L], an additional 50 g of sugar was added. At points during which the D.O. level remained at less than 1 mg/L, air was added to the biological reactor via a fine air bubble diffusion (passed through a 0.45 μm inline filter) connected to a variable speed positive displacement blower to increase the D.O. level and maintain it at approximately 1-2.5 mg/L.

The reactor was maintained at 95° F. Similar results can be obtained by maintaining the reactor between 75° F. and 105° F., however, the preferred temperature is about 95° F. The reactor was cultured for a period of 6 weeks. Similar results can be obtained by culturing the reactor for a period of from 4-8 weeks, but the preferred time period is 6 weeks. During the course of daily sampling, measurements on the concentration of EPS in the bioreactor were measured. A fully cultured reactor included at least 6 g/L of EPS, where the preferred concentration was 8 mg/L, and the range of EPS concentrations went from 0 mg/L to 26 mg/L, where potentially the reactor could go as high as 60 mg/L.

Upon reaching the preferred concentration of EPS during the 6 week period, a portion of the reactor was removed. This removed portion was immediately lysed utilizing an alkali agent. The alkali agent can be selected from the group consisting of potassium hydroxide, sodium hydroxide, magnesium hydroxide, calcium hydroxide, lithium hydroxide, and combinations thereof. The particular alkali agent used in this example was the preferred alkali agent, i.e., sodium hydroxide. The lysed portion was raised to a pH of 11. The lysed portion can be raised to a pH of at least 9.5 and as high as 13, but the preferred pH is about 11. This required approximately 3% by weight of EPS in the reactor portion of an alkali agent. However, the percentage by weight of EPS in the reactor portion of an alkali could be as low as 0.5% and as high as 5% by weight of the EPS in the reactor volume.

The lysed portion was then passed to a concentration step where the material was dehydrated by one selected from the group consisting of flash evaporation, freeze drying, rotary evaporation, vacuum distillation, steam evaporation, contact drying, boiling, solvent precipitation, and combinations thereof. The specific method used was contact drying, which is the preferred method. This resulted in a reduction volume of the lysed material that was 85%. The reduction in volume of the lysed material can be controlled within a range of at least 5% less by volume and as high as 95% less by volume, however, the preferred reduction in volume is 85%.

Experiment 17 yielded a dry salt that contained at least 0.8% Rhizobium tropici extracellular polymeric substance (RTEPS)by weight to 8% by weight of the RTEPS where the preferred concentration was 6% by weight of the EPS.

### Experiment 18

The same procedure was employed as in Experiment 17, but the concentration step was carried out prior to lysing with an alkali agent.

More specifically, once the cultured material was sufficiently high in concentration in EPS, it was rapidly reduced in volume. The reduction in volume can be accomplished by flash evaporation, freeze drying, rotary evaporation, vacuum distillation, steam evaporation, contact drying, boiling, solvent precipitation, and combinations thereof. The specific method employed was the preferred method of contact drying. The reduction in volume of the lysed material was 85%. The reduction in volume of the lysed material can be controlled within a range of at least 5% less by volume and as high as 95% less by volume, however, the preferred reduction in volume is 85%.

This reduced portion was then lysed utilizing an alkali agent. The alkali agent can be selected from the group consisting of potassium hydroxide, sodium hydroxide, magnesium hydroxide, calcium hydroxide, lithium hydroxide, and combinations thereof. In this experiment, the specific alkali agent employed was the preferred alkali agent, sodium hydroxide. The lysed portion was raised to a pH of 11. The pH of lysed portion can be raised to at least 9.5 and as high as 13, but the preferred pH is about 11. Achieving this pH required approximately 3% by weight of EPS in the reactor portion of an alkai agent, where it could be as low as 0.5% and as high as 5% by weight of the EPS in the reactor volume.

Experiment 18 yielded a dry salt that contained at least 0.8% Rhizobium tropici extracellular polymeric substance (RTEPS) by weight to 8% by weight of the RTEPS where the preferred concentration was 6% by weight of the EPS.

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A salt comprising a biopolymer of at least an extracellular polymeric substance (EPS) biogenically produced by Rhizobium tropici, the salt produced by a process comprising:
cultivating a composition
wherein the composition comprises a culture of Rhizobium tropici, water, at least one yeast, at least one sugar, at least one potassium phosphate, and at least one calcium chloride,
wherein the cultivating is carried out at a temperature of from 65 to 105° F., wherein the cultivating is carried out in aerobic conditions, wherein the aerobic conditions comprise a dissolved oxygen level of at least 0.1 mg/L,
wherein the cultivating is carried out for a cultivation period of 4-8 weeks;
adding at least one additional part nutrients to the composition during the cultivation period, wherein the at least one additional part nutrients comprises at least a flavonoid and at least one sugar;
recovering a cultivated composition from the composition when the concentration of EPS in the composition is at least 4 g/L;
dehydrating the cultivated composition by one selected from the group consisting of flash evaporation, freeze drying, rotary evaporation, vacuum distillation, steam evaporation, contact drying, boiling, solvent precipitation, and combinations thereof;
adding an alkali agent to the cultivated composition to achieve a pH of about 9.5-13; and
recovering a salt from the cultivated composition.

2. The salt of claim 1, wherein after the dehydrating step, the cultivated composition is at least 10% by weight of the composition.

3. The salt of claim 1, wherein the flavonoid is selected from the group consisting of butin, eriodictyol, hesperetin, hesperidin, homoeriodictyol, isosakuranetin, naringenin, naringin, pinocembrin, poncirin, sakuranetin, sakuranin, sterubin, and combinations thereof.

4. The salt of claim 1, wherein the flavonoid is naringenin.

5. The salt of claim 1, wherein dehydrating the cultivated composition comprises contact drying.

6. The method of claim 1, wherein, during the cultivating step, EPS is generated at a rate of from 1 g/week to 10 g/week.

7. The method of claim 1, wherein the alkali agent is selected from the group consisting of potassium hydroxide, sodium hydroxide, magnesium hydroxide, calcium hydroxide, lithium hydroxide, and combinations thereof.

8. The salt of claim 1, wherein the alkali agent is added prior to the generating step.

9. The salt of claim 1, wherein from 0.05% to 5% by weight of the salt of the alkali agent are added.

10. The salt of claim 1, wherein the aerobic conditions comprise a dissolved oxygen level of at least 0.1 mg/L to a saturation level at which the water is saturated with oxygen.

11. The salt of claim 1, wherein the composition comprises:
from 94 to 99 percent by weight water;
from 0.05 to 0.2 percent by weight of the at least one yeast,
from 0.10 to 1 percent by weight of the at least one sugar,
from 0.5 to 3 percent by weight of the at least one potassium phosphate, and
from 0.001 to 0.01 percent by weight of the at least one calcium chloride.

12. The salt of claim 1, wherein the salt comprises from 0.8% to 8% by weight of the EPS.

13. A method of decreasing dormancy in one or more seeds by priming a seed with the salt of claim 1.

14. A method of decreasing dormancy in one or more seeds by incorporating the salt of claim 1 into the coating or pellet of one or more seeds.

15. A method of increasing seed germination comprising adding the salt of claim 1 to a soil to create a soil mixture comprising between about 0.2% salt by weight to about 10% salt by weight of soil.

16. A method of preventing soil erosion by adding the salt of claim 1 to a soil to create a soil mixture comprising between about 0.2% salt by weight to about 10% salt by weight of soil.

17. The method of claim 16, wherein preventing the erosion prevents heavy metal contamination.

18. A method of increasing agriculture production by adding the salt of claim 1 to a soil to create a soil mixture comprising between about 0.2% salt by weight to about 10% salt by weight of soil.

19. A method of increasing agriculture production by adding the salt of claim 1 to soils at 0.10 kg/acre to 20 kg/acre.

20. The method of claim 19, wherein the salt is a metal chelator.

21. The method of claim 20, wherein the metal is aluminum.

22. A method of increasing nodulation in leguminous plants by adding the salt of claim 1 to soils at 0.1 kg/acre to 20 kg/acre.

23. A method of mitigating drought conditions in agricultural crops and revegetation efforts by adding the salt of claim 1 to soils at 2 kg/acre to 110 kg/acre.

24. A method of mitigating drought conditions in agricultural crops and revegetation efforts by adding the salt of claim 1 to soils at 0.1% by weight of soil to 3% by weight of soil.

25. A method of improving metal impacted soils to reestablish vegetative growth by adding the salt of claim 1 to soils at 0.1% by weight of soil to 3% by weight of soil.

26. A method of establishing grasses to prevent soil erosion by adding the salt of claim 1 to soils at 0.1 kg/acre to 2 kg/acre.

27. A method of claim 26, wherein preventing the erosion prevents nutrient and sediment loading into water bodies

28. A method of increasing seed germination comprising coating a seed with the salt of claim 1.

29. A method of manufacturing a salt comprising a biopolymer of at least an extracellular polymeric substance (EPS) biogenically produced by Rhizobium tropici, the method comprising:
placing a culture of Rhizobium tropici in a container comprising water and a first set of nutrients, the first set of nutrients comprising at least one yeast, at least one sugar, at least one potassium phosphate, and at least one calcium chloride;
maintaining said culture in a homogenous mixed reactor at a temperature of from 65° F. to 105° F. in aerobic conditions, wherein the aerobic conditions comprise a dissolved oxygen level of at least 0.1 mg/L;
cultivating the water-nutrient mixture for a cultivation period of 4-8 weeks and adding at least one additional part nutrients comprising at least a flavanoid and a sugar during the cultivation period;
ensuring that the concentration of the EPS in the cultivated material is at least 4 g/L before removal from the container;
generating a dehydrated mixture by one selected from the group consisting of flash evaporation, freeze drying, rotary evaporation, vacuum distillation, steam evaporation, contact drying, boiling, solvent precipitation, and combinations thereof;
adding an alkai agent to the mixture until said mixture reaches a pH of about 9.5-13 to recover a dry salt.

30. A method comprising
cultivating a composition
wherein the composition comprises a culture of Rhizobium tropici, water, at least one yeast, at least one sugar, at least one potassium phosphate, and at least one calcium chloride,
wherein the cultivating is carried out at a temperature of from 65 to 105° F.,
wherein the cultivating is carried out in aerobic conditions, wherein the aerobic conditions comprise a dissolved oxygen level of at least 0.1 mg/L,
wherein the cultivating is carried out for a cultivation period of 4-8 weeks;
adding at least one additional part nutrients to the composition during the cultivation period, wherein the at least one additional part nutrients comprises at least a flavonoid and a sugar;
recovering a cultivated composition from the composition when the concentration of EPS in the composition is at least 4 g/L;
dehydrating the cultivated composition by one selected from the group consisting of flash evaporation, freeze drying, rotary evaporation, vacuum distillation, steam evaporation, contact drying, boiling, solvent precipitation, and combinations thereof;
adding an alkali agent to the cultivated composition to achieve a pH of about 9.5-13; and
recovering a salt from the cultivated composition.
